(19) United States
(12) Patent Application Publication
(10) Pub. No.: US 2026/0320217 A1
(43) Pub. Date: Oct. 15, 2026

(54) ELECTRONIC DEVICE, METHOD, AND RECORDING MEDIUM FOR PROVIDING ARTIFICIAL INTELLIGENCE-BASED RECOMMENDATION INFORMATION

(71) Applicant: Samsung Electronics Co., Ltd., Suwon-si (KR)

(72) Inventors: Eunjung HUH, Suwon-si (KR); Younghak OH, Suwon-si (KR); Jeeyeun WANG, Suwon-si (KR); Yujin PARK, Suwon-si (KR)

(21) Appl. No.: 19/683,023

(22) Filed: May 20, 2026

Related U.S. Application Data
(63) Continuation of application No. PCT/KR2024/018367, filed on Nov. 20, 2024.

(30) Foreign Application Priority Data
Nov. 20, 2023 (KR) 10-2023-0161183
Dec. 29, 2023 (KR) 10-2023-0197407

(51) Int. Cl. G06F 21/62; G06F 3/0482; G06F 3/0484; G06F 16/9535; G06F 40/40

(52) U.S. Cl. CPC G06F 21/6218; G06F 16/9535; G06F 40/40; G06F 3/0482; G06F 3/0484

(57) ABSTRACT

An electronic device, a method, and a recording medium for providing recommendation information based on artificial intelligence (AI) are provided. The method includes displaying an execution screen of an interactive service, detecting a feature point from content inputted while performing the interactive service, determining relationship information with at least one counterpart user participating in the interactive service, determining an access level for user information based on the relationship information, acquiring at least a part of user information and/or general information, based on the access level, generating recommendation information related to the feature point based on the acquired information, and providing the recommendation information.

### CROSS-REFERENCE TO RELATED APPLICATION(S)

This application is a continuation application, claiming priority under 35 U.S.C. § 365(c), of an International application No. PCT/KR2024/018367, filed on Nov. 20, 2024, which is based on and claims the benefit of a Korean patent application number 10-2023-0161183, filed on Nov. 20, 2023, in the Ministry of Intellectual Property (MOIP), and of a Korean patent application number 10-2023-0197407, filed on Dec. 29, 2023, in the Ministry of Intellectual Property (MOIP), the disclosure of each of which is incorporated by reference herein in its entirety.

### BACKGROUND

### 1. Field

The disclosure relates to an electronic device, a method, and a recording medium for providing recommendation information based on artificial intelligence (AI).

### 2. Description of Related Art

With the advancement of digital technology, various types of electronic devices, such as smartphones, digital cameras, and/or wearable devices, are becoming widely used. The hardware and/or software components of these electronic devices are continuously being developed to support and enhance their functionality.

For example, portable electronic devices (hereinafter referred to as “electronic devices”), such as smartphones, may now be equipped with a variety of functions. Electronic devices may include touchscreen-based displays that allow users to easily access various functions, and may provide screens for various applications through these displays.

Recently, with the rapid development of big data and deep learning technologies, artificial intelligence (AI) is being implemented in electronic devices. AI technologies may include the analysis of specific data and intelligent personal services that integrate and utilize information from various fields tailored to the user's needs. For example, users may control electronic devices through voice conversations, and a deep learning-based knowledge base allows them to search for, query, and respond to specific information. Currently, AI-user interactions may take the form of conversations.

The above information is presented as background information only to assist with an understanding the of disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for providing a recommended answer based on conversation data between a user and a counterpart user while executing an interactive service, an electronic device supporting the method, and a recording medium.

Another aspect of the disclosure is to provide a method for recommending and providing an appropriate answer to conversation data through artificial intelligence based on conversation data between a user and a counterpart user, an electronic device supporting the method, and a recording medium.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, and includes at least one processor including processing circuitry and communicatively connected to the display and the memory, wherein the instructions when executed by the at least one processor individually or collectively, cause the electronic device to display an execution screen of an interactive service, detect a feature point from content inputted while performing the interactive service, determine relationship information with at least one counterpart user participating in the interactive service, determine an access level for user information based on the relationship information, acquire at least a part of user information and/or general information based on the access level, generate recommendation information related to the feature point based on the acquired information and, provide the recommendation information.

In accordance with another aspect of the disclosure, a method of an electronic device is provided. The method includes displaying an execution screen of an interactive service, detecting a feature point from content inputted while performing the interactive service, determining relationship information with at least one counterpart user participating in the interactive service, determining an access level for user information based on the relationship information, acquiring at least a part of user information and/or general information based on the access level, generating recommendation information related to the feature point based on the acquired information, and providing the recommendation information.

In order to solve the above-described problem, various embodiments of the disclosure includes a computer-readable recording medium having recorded thereon a program for executing the method on a processor.

In accordance with another aspect of the disclosure, one or more non-transitory computer-readable recording media storing one or more computer programs including computer-executable instructions that, when executed by one or more processors of an electronic device individually or collectively, cause the electronic device to perform operations are provided. The operations include displaying an execution screen of an interactive service, detecting a feature point from content inputted while performing the interactive service, determining relationship information with at least one counterpart user participating in the interactive service, determining an access level for user information based on the relationship information, acquiring at least a part of user information and/or general information based on the access level, generating recommendation information related to the feature point based on the acquired information, and providing the recommendation information.

According to an electronic device, a method of operation thereof, and a recording medium in accordance with one embodiment of the disclosure, a recommended answer is generated and provided to a user in response to conversation data between a user and a counterpart user while providing an interactive service. According to an embodiment, based on the conversation data between the user and the counterpart user, an appropriate answer to the conversation data is recommended and provided to the user through artificial intelligence, thereby improving the convenience of the user's conversation writing. According to an embodiment, the user's needs for using an interactive service using an electronic device is satisfied, and a new user experience (UX) is provided to the user in accordance with the use of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a block diagram illustrating an integrated intelligence system according to an embodiment of the disclosure;

FIG. 3 is a diagram illustrating the form in which relationship information between concepts and actions is stored in a database according to an embodiment of the disclosure;

FIG. 4 is a diagram schematically illustrating the configuration of an electronic device according to an embodiment of the disclosure;

FIG. 5 is a flowchart illustrating an operation method of an electronic device according to an embodiment of the disclosure;

FIGS. 6A, 6B, and 6C are diagrams illustrating examples of providing interactive services in an electronic device according to various embodiments of the disclosure;

FIGS. 7A, 7B, and 7C are diagrams illustrating various examples of a user interface for supporting an interactive service in an electronic device according to various embodiments of the disclosure;

FIGS. 8A, 8B, and 8C are diagrams illustrating various examples of a user interface for supporting an interactive service in an electronic device according to various embodiments of the disclosure;

FIGS. 9A and 9B are diagrams illustrating examples of providing interactive services in an electronic device according to various embodiments of the disclosure;

FIG. 10 is a flowchart illustrating an operation method of an electronic device according to an embodiment of the disclosure;

FIG. 11 is a flowchart illustrating an operation method of an electronic device according to an embodiment of the disclosure;

FIGS. 12A, 12B, and 12C are diagrams illustrating various examples of providing recommendation information in an electronic device according to various embodiments of the disclosure;

FIGS. 13A, 13B, and 13C are diagrams illustrating various examples of providing recommendation information in an electronic device according to various embodiments of the disclosure;

FIGS. 14A and 14B are diagrams illustrating various examples of providing recommendation information in an electronic device according to various embodiments of the disclosure;

FIGS. 15A, 15B, and 15C are diagrams illustrating various examples of providing recommendation information in an electronic device according to various embodiments of the disclosure;

FIGS. 16A and 16B are diagrams illustrating various examples of providing recommendation information in an electronic device according to various embodiments of the disclosure;

FIG. 17 is a diagram illustrating an example of an adjustment object that supports adjustment of an information disclosure level in an electronic device according to an embodiment of the disclosure;

FIGS. 18A, 18B, 18C, and 18D are diagrams illustrating examples of providing recommendation information in an electronic device according to various embodiments of the disclosure;

FIGS. 19A and 19B are diagrams illustrating examples of providing recommendation information in an electronic device according to various embodiments of the disclosure;

FIGS. 20A and 20B are diagrams illustrating examples of providing recommendation information in an electronic device according to various embodiments of the disclosure;

FIGS. 21A and 21B are diagrams illustrating examples of providing recommendation information in an electronic device according to various embodiments of the disclosure;

FIGS. 22A and 22B are diagrams illustrating examples of providing recommendation information in an electronic device according to various embodiments of the disclosure; and

FIGS. 23A, 23B, and 23C are diagrams illustrating examples of providing recommendation information in an electronic device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

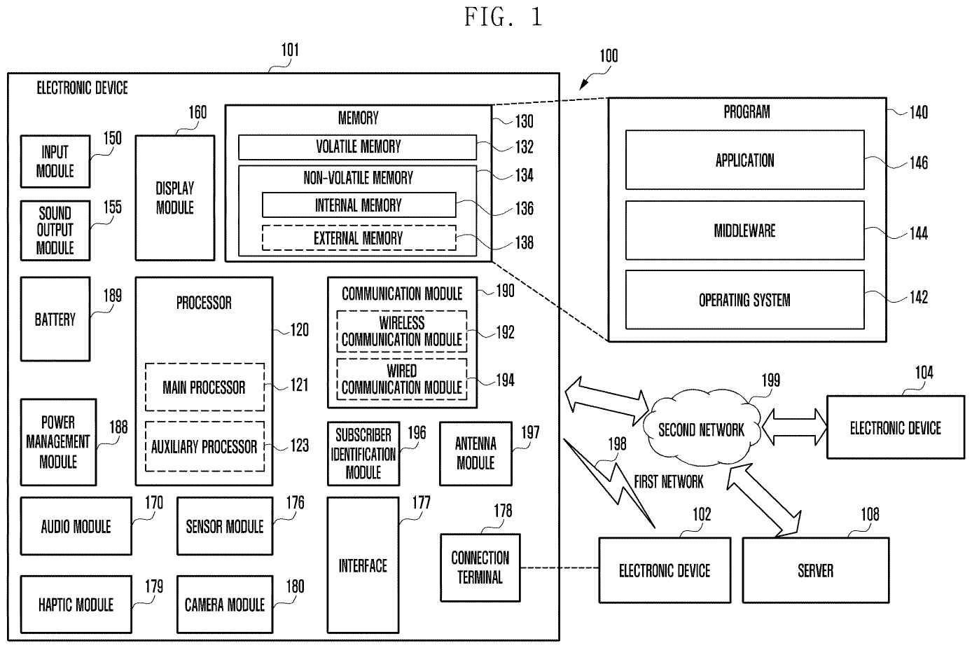

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user-plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

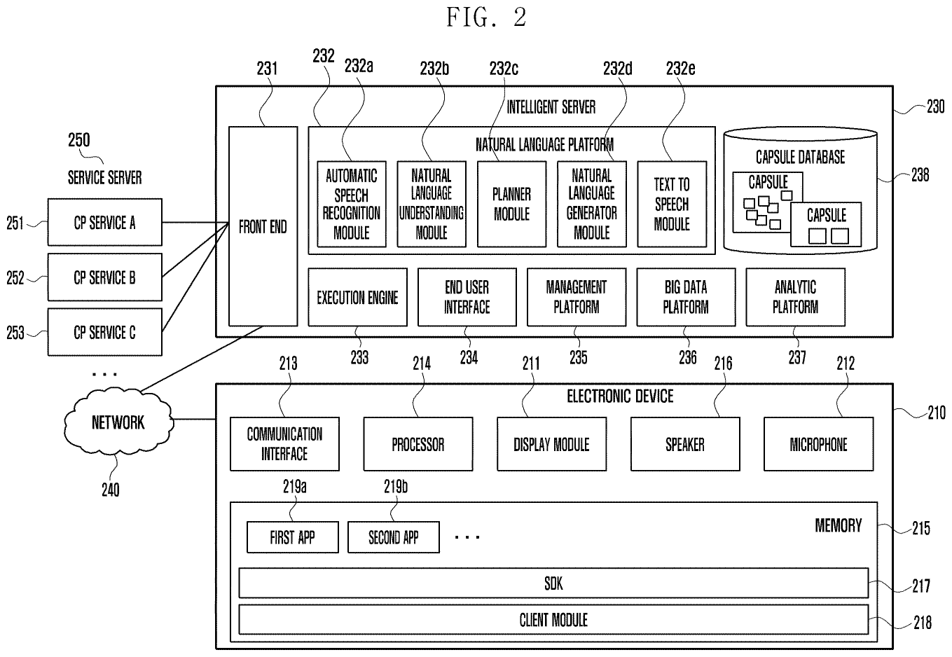

FIG. 2 is a block diagram illustrating an integrated intelligence system according to an embodiment of the disclosure.

Referring to FIG. 2, an integrated intelligence system according to one embodiment may include an electronic device 210 (e.g., the electronic device 101 of FIG. 1), an intelligent server 230 (e.g., the server 108 of FIG. 1), and a service server 250 (e.g., the server 108 of FIG. 1).

According to one embodiment, the electronic device 210 may be a terminal device (or electronic device) that may connect to the Internet, such as a mobile phone, a smart phone, a personal digital assistant (PDA), a laptop computer, a television (TV), white goods, a wearable device, a head mounted display (HMD), or a smart speaker.

According to the illustrated embodiment, the electronic device 210 may include a communication interface 213 (e.g., the interface 177 of FIG. 1), a microphone 212 (e.g., the input module 150 of FIG. 1), a speaker 216 (e.g., the audio output module 155 of FIG. 1), a display module 211 (e.g., the display module 160 of FIG. 1), memory 215 (e.g., the memory 130 of FIG. 1), or a processor 214 (e.g., the processor 120 of FIG. 1). The components listed above may be operatively or electrically connected to each other. The electronic device 210 may include at least some of the configurations and/or functions of the electronic device 101 of FIG. 1.

According to one embodiment, the communication interface 213 may be configured to connect to an external device and transmit and receive data. In one embodiment, the microphone 212 may receive sound (e.g., user utterance) and convert it into an electrical signal. According to one embodiment, the speaker 216 may output the electrical signal as sound (e.g., voice).

According to one embodiment, the display module 211 may be configured to display an image or video. According to one embodiment, the display module 211 may also display a graphical user interface (GUI) of a running app (or application program). The display module 211 of one embodiment may receive a touch input through a touch sensor. For example, the display module 211 may receive a text input through a touch sensor in an on-screen keyboard area displayed within the display module 211.

According to one embodiment, the memory 215 may store a client module 218, a software development kit (SDK) 217, and a plurality of apps (e.g., a first app 219a, a second app 219b). The client module 218 and the SDK 217 may form a framework (or solution program) for performing general functions. In addition, the client module 218 or the SDK 217 may form a framework for processing user input (e.g., voice input, text input, touch input).

According to one embodiment, the plurality of apps 219a and 219b stored in the memory 215 may be programs for performing a specified function. According to one embodiment, the plurality of apps may include a first app 219a and a second app 219b. According to one embodiment, each of the plurality of apps 219a and 219b may include a plurality of operations for performing a specified function. For example, the apps 219a and 219b may include an alarm app, a message app, and/or a schedule app. According to one embodiment, the plurality of apps 219a and 219b may be executed by the processor 214 to sequentially execute at least some of the plurality of operations.

According to one embodiment, the processor 214 may control the overall operation of the electronic device 210. For example, the processor 214 may be electrically connected to a communication interface 213, a microphone 212, a speaker 216, and a display module 211 to perform specified operations.

According to one embodiment, the processor 214 may also execute a program stored in the memory 215 to perform a specified function. For example, the processor 214 may execute at least one of the client module 218 or the SDK 217 to perform the following operations for processing user input. The processor 214 may control the operations of a plurality of apps 219a and 219b, for example, through the SDK 217. The following operations described as operations of the client module 218 or the SDK 217 may be operations executed by the processor 214.

According to one embodiment, the client module 218 may receive user input. For example, the client module 218 may receive a voice signal corresponding to a user utterance detected through the microphone 212. Alternatively, the client module 218 may receive a touch input detected through the display module 211. Alternatively, the client module 218 may receive a text input detected through a keyboard or a visual keyboard. In addition, the client module 218 may receive various forms of user input detected through an input module included in the electronic device 210 or an input module connected to the electronic device 210. The client module 218 may transmit the received user input to the intelligent server 230. The client module 218 may transmit status information of the electronic device 210 together with the received user input to the intelligent server 230. The status information may be, for example, execution status information of an app.

According to one embodiment, the client module 218 may receive a result corresponding to the received user input. For example, the client module 218 may receive a result corresponding to the received user input if the intelligent server 230 can produce a result corresponding to the received user input. The client module 218 may display the received result on the display module 211. Additionally, the client module 218 may output the received result as audio through the speaker 216.

According to one embodiment, the client module 218 may receive a plan corresponding to the received user input. The client module 218 may display the results of executing multiple operations of the app according to the plan on the display module 211. For example, the client module 218 may sequentially display the results of executing multiple operations on the display module 211 and output audio through the speaker 216. The electronic device 210 may, for another example, display only some results of executing multiple operations (e.g., the result of the last operation) on the display module 211 and output audio through the speaker 216.

According to one embodiment, the client module 218 may receive a request from the intelligent server 230 to acquire information necessary to produce a result corresponding to the voice input. According to one embodiment, the client module 218 may transmit the necessary information to the intelligent server 230 in response to the request.

According to one embodiment, the client module 218 may transmit result information of executing multiple operations according to a plan to the intelligent server 230. The intelligent server 230 may use the result information to confirm that the received user input has been processed correctly.

According to one embodiment, the client module 218 may include a voice recognition module. According to one embodiment, the client module 218 may recognize voice inputs that perform limited functions through the voice recognition module. For example, the client module 218 may execute an intelligent app that processes voice inputs to perform organic operations based on a specified input (e.g., “Wake up!”).

According to one embodiment, the intelligent server 230 may receive information related to a user voice input from an electronic device 210 through a communication network. According to one embodiment, the intelligent server 230 may convert data related to the received voice input into text data. According to one embodiment, the intelligent server 230 may generate a plan for performing a task corresponding to the user voice input based on the text data.

According to one embodiment, the plan may be generated by an artificial intelligence (AI) system. The AI system may be a rule-based system, a neural network-based system (NNS) (e.g., a feedforward neural network (FNN), a recurrent neural network (RNN)), or a combination of the aforementioned or another AI system. According to one embodiment, the plan may be selected from a set of predefined plans or generated in real time in response to a user request. For example, the AI system may select at least one plan from a plurality of predefined plans.

According to one embodiment, the intelligent server 230 may transmit the results according to the generated plan to the electronic device 210, or transmit the generated plan to the electronic device 210. According to one embodiment, the electronic device 210 may display the results according to the plan on the display module 211. According to one embodiment, the electronic device 210 may display the results of executing an operation according to the plan on the display module 211.

According to one embodiment, the intelligent server 230 may include a front end 231, a natural language platform 232, a capsule database 238, an execution engine 233, an end user interface 234, a management platform 235, a big data platform 236, and/or an analytic platform 237.

According to one embodiment, the front end 231 may receive user input from the electronic device 210. The front end 231 may transmit a response corresponding to the user input.

According to one embodiment, the natural language platform 232 may include an automatic speech recognition module (ASR module) 232a, a natural language understanding module (NLU module) 232b, a planner module 232c, a natural language generator module (NLG module) 232d, and/or a text to speech module (TTS module) 232e.

According to one embodiment, the automatic speech recognition module 232a may convert voice input received from the electronic device 210 into text data. According to one embodiment, the natural language understanding module 232b may use the text data of the voice input to determine the user's intent. For example, the natural language understanding module 232b may perform syntactic analysis and/or semantic analysis on user input in the form of text data to determine the user's intent. According to one embodiment, the natural language understanding module 232b may use linguistic features (e.g., grammatical elements) of morphemes or phrases to determine the meaning of words extracted from the voice input, and may match the meaning of the determined words to the intent to determine the user's intent. The natural language understanding module 223b may acquire intent information corresponding to the user utterance. The intent information may be information indicating the user's intent determined by interpreting text data. The intent information may include information indicating an operation or function that the user intends to execute using the device.

According to one embodiment, the planner module 232c may generate a plan using the intent and parameters determined by the natural language understanding module 232b. According to one embodiment, the planner module 232c may determine a plurality of domains necessary to perform a task based on the determined intent. The planner module 232c may determine a plurality of operations included in each of the plurality of domains determined based on the intent. According to one embodiment, the planner module 232c may determine parameters necessary to execute the plurality of determined operations or result values outputted by the execution of the plurality of operations. The parameters and the result values may be defined as concepts of a specified format (or class). Accordingly, the plan may include a plurality of operations and a plurality of concepts determined by the user's intent.

According to one embodiment, the planner module 232c may determine the relationship between the plurality of operations and the plurality of concepts in a stepwise (or hierarchical) manner. For example, the planner module 232c may determine the execution order of the plurality of operations determined based on the user's intention based on the plurality of concepts. In other words, the planner module 232c may determine the execution order of the plurality of operations based on the parameters required for the execution of the plurality of operations and the results outputted by the execution of the plurality of operations. Accordingly, the planner module 232c may generate a plan including association information (e.g., ontology) between the plurality of operations and the plurality of concepts. The planner module 232c may generate the plan using information stored in a capsule database 238 in which a set of relationships between concepts and operations is stored.

According to one embodiment, the natural language generator module 232d may convert specified information into text format. The information converted into text format may be in the form of natural language utterance. According to one embodiment, the text-to-speech module 232e may convert text-to-speech information into speech information.

According to one embodiment, some or all of the functions of the natural language platform 232 may also be implemented in the electronic device 210.

The capsule database 238 may store information on the relationships between multiple concepts and operations corresponding to multiple domains. According to one embodiment, a capsule may include multiple operation objects (or operation information) and concept objects (or concept information) included in a plan. According to one embodiment, the capsule database 238 may store multiple capsules in the form of a concept action network (CAN). According to one embodiment, the multiple capsules may be stored in a function registry included in the capsule database 238.

The capsule database 238 may include a strategy registry that stores strategy information necessary for determining a plan corresponding to a user input. The strategy information may include reference information for determining a single plan when there are multiple plans corresponding to a user input. According to one embodiment, the capsule database 238 may include a follow-up registry that stores information on follow-up operations for suggesting follow-up operations to a user in a given situation. The follow-up operations may include, for example, follow-up utterances. According to one embodiment, the capsule database 238 may include a layout registry that stores layout information of information outputted through the electronic device 210. According to one embodiment, the capsule database 238 may include a vocabulary registry that stores vocabulary information included in capsule information. According to one embodiment, the capsule database 238 may include a dialog registry that stores information on a conversation (or interaction) with a user. The capsule database 238 may update stored objects through a developer tool. The developer tool may include, for example, a function editor for updating operation objects or concept objects. The developer tool may include a vocabulary editor for updating vocabulary. The developer tool may include a strategy editor for creating and registering strategies that determine plans. The developer tool may include a dialog editor for creating a conversation with the user. The developer tool may include a follow-up editor for activating follow-up goals and editing follow-up utterances that provide hints. The follow-up goals may be determined based on currently set goals, user preferences, or environmental conditions. In one embodiment, the capsule database 238 may also be implemented within the electronic device 210.

According to one embodiment, the execution engine 233 may use the generated plan to produce a result. The end user interface 234 may transmit the produced result to the electronic device 210. Accordingly, the electronic device 210 may receive the result and provide the received result to the user. According to one embodiment, the management platform 235 may manage information used in the intelligent server 230. According to one embodiment, the big data platform 236 may collect user data. According to one embodiment, the analysis platform 237 may manage the quality of service (QoS) of the intelligent server 230. For example, the analysis platform 237 may manage the components and processing speed (or efficiency) of the intelligent server 230.

According to one embodiment, the service server 250 may provide a service (e.g., food ordering or hotel reservation) specified to the electronic device 210. According to one embodiment, the service server 250 may be a server operated by a third party. According to one embodiment, the service server 250 may provide information for generating a plan corresponding to the received voice input to the intelligent server 230. The provided information may be stored in the capsule database 238. In addition, the service server 250 may provide result information according to the plan to the intelligent server 230. The service server 250 may include a plurality of service providers (e.g., CP service A 251, CP service B 252, CP service C 253), and each of the service providers 251, 252, and 253 may provide a function for a domain associated with each capsule stored in the capsule database 238 of the intelligent server 230.

In the integrated intelligence system described above, the electronic device 210 may provide various intelligent services to the user in response to user input. The user input may include, for example, input through a physical button, touch input, or voice input.

According to one embodiment, the electronic device 210 may provide a voice recognition service through an intelligent app (or voice recognition app) stored within the device. In this case, for example, the electronic device 210 may recognize a user utterance or voice input received through the microphone 212 and provide the user with a service corresponding to the recognized voice input.

According to one embodiment, the electronic device 210 may perform a specified operation based on the received voice input, either alone or together with the intelligent server 230 and/or the service server 250. For example, the electronic device 210 may execute an app corresponding to the received voice input and perform a specified operation through the executed app.

According to one embodiment, when an electronic device 210 provides a service together with an intelligent server 230 and/or a service server 250, the electronic device 210 may detect a user utterance using the microphone 212 and generate a signal (or voice data) corresponding to the detected user utterance. The electronic device 210 may transmit the voice data to the intelligent server 230 through a network (240) using a communication interface 213.

An intelligent server 230 according to one embodiment may generate a plan for performing a task corresponding to a voice input received from an electronic device 210, or a result of performing an operation according to the plan, in response to the voice input. The plan may include, for example, a plurality of operations for performing a task corresponding to a user's voice input, and a plurality of concepts related to the plurality of operations. The concept may define parameters inputted to the execution of the plurality of operations, or result values outputted by the execution of the plurality of operations. The plan may include association information between the plurality of operations and the plurality of concepts.

According to one embodiment, the electronic device 210 may receive the response using the communication interface 213. The electronic device 210 may output a voice signal generated within the electronic device 210 to the outside using the speaker 216, or may output an image generated within the electronic device 210 to the outside using the display module 211.

Although FIG. 2 illustrates an example in which voice recognition, natural language understanding and generation, and plan-based production operations of user input received from an electronic device 210 are performed on an intelligent server 230, the various embodiments of the present document are not limited thereto. For example, at least some components of the intelligent server 230 (e.g., natural language platform 232, execution engine 233, capsule database 238) may be embedded in the electronic device 210 (or the electronic device 101 of FIG. 1), such that the operations may be performed by the electronic device 210.

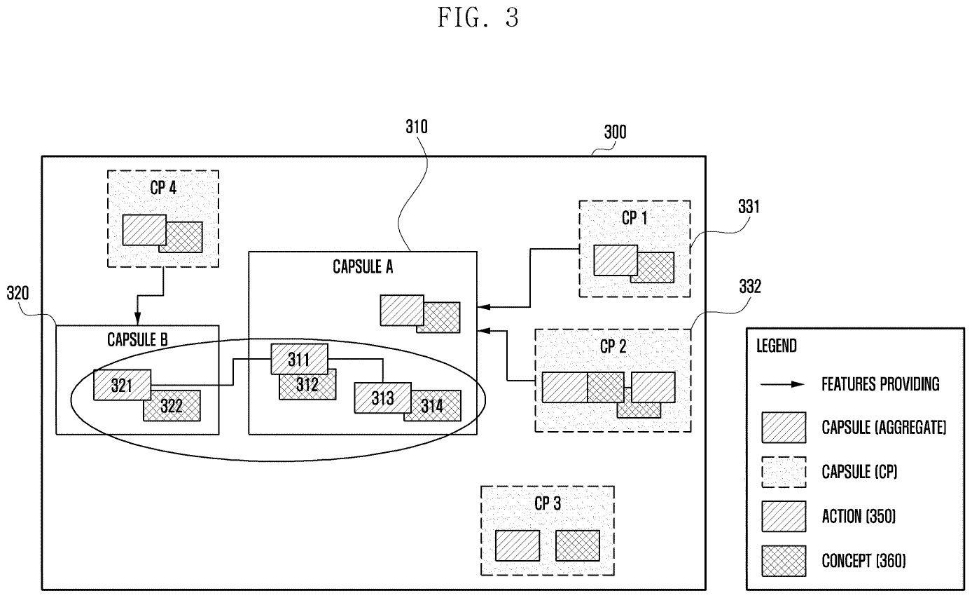

FIG. 3 is a diagram illustrating the form in which relationship information between concepts and operations is stored in a database according to an embodiment of the disclosure.

According to one embodiment, a capsule database (e.g., the capsule database 238 of FIG. 2) of an intelligent server (e.g., the intelligent server 230 of FIG. 2) may store capsules in the form of a concept action network (CAN) 300. The capsule database may store operations for processing tasks corresponding to a user's voice input and parameters necessary for the operations in the form of a concept action network (CAN).

According to one embodiment, the capsule database may store a plurality of capsules (capsule A 310, capsule B 320) corresponding to each of a plurality of domains (e.g., applications). According to one embodiment, one capsule (e.g., capsule A 310) may correspond to one domain (e.g., location (geo), application). In addition, one capsule may correspond to at least one service provider (e.g., CP 1 331 or CP 2 332) for performing a function for a domain related to the capsule. According to one embodiment, one capsule may include at least one action 350 and at least one concept 360 for performing a specified function.

According to one embodiment, a natural language platform (e.g., the natural language platform 232 of FIG. 2) may generate a plan for performing a task corresponding to a received speech input using capsules stored in a capsule database. For example, a planner module of the natural language platform (e.g., the planner module 232c of FIG. 2) may generate a plan using capsules stored in a capsule database. For example, a plan may be generated using actions 311 and 313 and concepts 312 and 314 of capsule A 310 and actions 321 and concepts 322 of capsule B 320.

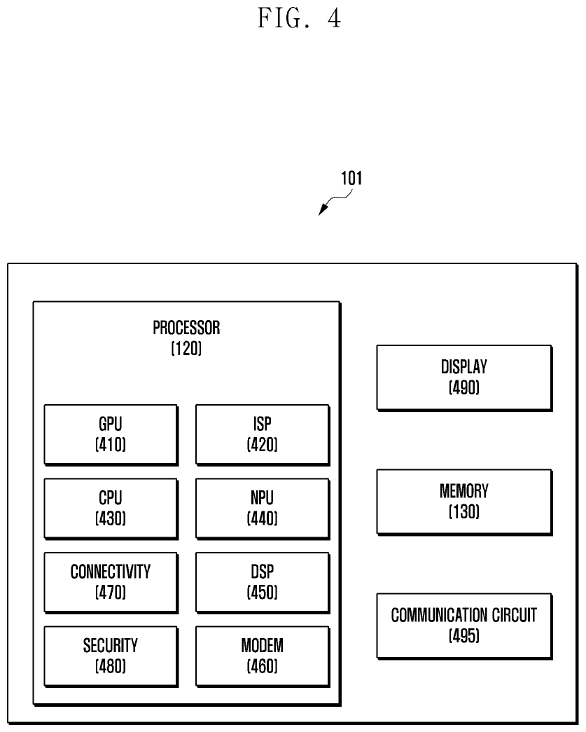

FIG. 4 is a diagram schematically illustrating the configuration of an electronic device according to an embodiment of the disclosure.

Referring to FIG. 4, an electronic device 101 according to one embodiment of the disclosure may include a display 490 (e.g., the display module 160 and 211 of FIGS. 1 or 2), memory 130 (e.g., the memory 130 of FIG. 1), a communication circuit 495 (e.g., the communication module 190 or the communication interface 213 of FIG. 1), and/or a processor 120 (e.g., the processor 120 and 214 of FIGS. 1 or 2). According to one embodiment, the electronic device 101 may include all or at least a part of the components of the electronic device 101 and 210 described in the description with reference to FIGS. 1 or 2. For example, in various embodiments of the present document, some of the illustrated components may be omitted or replaced. The electronic device 101 may include at least some of the configurations and/or functions of the electronic device 101 of FIG. 1 and/or the electronic device 210 of FIG. 2. At least some of the respective configurations of the illustrated (or not illustrated) electronic device 101 may be operatively, functionally, and/or electrically connected to each other.

According to one embodiment, the display 490 may include a configuration identical or similar to the display module 160 and 211 of FIGS. 1 or 2. According to one embodiment, the display 490 may display various images provided from the processor 120. According to one embodiment, the display 490 may visually provide, under the control of the processor 120, an application being executed (e.g., the application 146 of FIG. 1) and various screens related to its use (e.g., a contents screen, an application execution screen, a menu screen, and/or a function execution screen).

According to one embodiment, the display 490 may be combined with a touch sensor, a pressure sensor capable of measuring the intensity of a touch, and/or a touch panel (e.g., a digitizer) that detects a magnetic stylus pen. According to one embodiment, the display 490 may detect a touch input, an air gesture input, and/or a hovering input (or a proximity input) by measuring a change in a signal (e.g., voltage, light intensity, resistance, electromagnetic signal, and/or charge) for a specific location of the display 490 based on the touch sensor, the pressure sensor, and/or the touch panel. For example, the display 490 may include a touchscreen that detects a touch and/or a proximity touch (or a hovering) input using a part of a user's body (e.g., a finger) or an input device (e.g., a stylus pen). The display 490 may include at least some of the configuration and/or functions of the display module 160 of FIG. 1 and/or the display module 211 of FIG. 2.

According to one embodiment, the display 490 may include, but is not limited to, a liquid crystal display (LCD), a light-emitting diode (LED), an organic light-emitting diode (OLED) display, and/or an active matrix OLED (AMOLED) display, a micro electro mechanical systems (MEMS) display, or an electronic paper display. According to one embodiment, the display 490 may include a flexible display.

According to one embodiment, the memory 130 may include at least a part of the configuration and/or function of the memory 130 of FIG. 1 and/or the memory 215 of FIG. 2, and may store software (e.g., the program 140 of FIG. 1). The memory 130 may store various applications (e.g., the application 146 of FIG. 1 or the plurality of apps 219a and 219b of FIG. 2), and program modules supporting intelligent services (e.g., the client module 218 of FIG. 2).

According to one embodiment, the memory 130 may store various data used by at least one component (e.g., processor 120) of the electronic device 101. In one embodiment, the data may include, for example, software (e.g., the program 140 of FIG. 1), and input data or output data for commands related to the software.

According to one embodiment, the memory 130 may include volatile memory (e.g., volatile memory 132 of FIG. 1) or non-volatile memory 134 (e.g., non-volatile memory 134 of FIG. 1). According to one embodiment, the memory 130 may store commands or data received from the processor 120 in the volatile memory 132, and may store result data, obtained by processing the commands or data stored in the volatile memory 132 by the processor 120, in the non-volatile memory 134.

In one embodiment, the data stored in the memory 130 may include data related to user information, data related to general information, learning data, data related to user context, and/or conversation data between users. In one embodiment, the data may include information related to various configurations to support controlling an operation of providing recommendation information (e.g., recommended answers) through artificial intelligence while the electronic device 101 is executing an interactive service.

In one embodiment, the data stored in the memory 130 may include various learning data and/or parameters acquired based on the user's learning through interaction with the user. In one embodiment, the data may include various schemas (or algorithms, models, networks, or functions) for supporting operations related to providing recommendation information (e.g., recommended answers) through artificial intelligence while executing an interactive service.

In one embodiment, the fields in which artificial intelligence technology is applied may be diverse. For example, it may consist of technologies in the fields of linguistic understanding, visual understanding, inference/prediction, knowledge representation, and/or motion control. Linguistic understanding refers to technologies that recognize and apply/process human language/characters, and may include natural language processing, machine translation, conversational systems, question answering, and/or speech recognition/synthesis. Visual understanding refers to technologies that recognize and process objects similar to human vision, and may include object recognition, object tracking, image search, person recognition, scene understanding, spatial understanding, and/or image enhancement. Inference/prediction refers to technologies that logically infer and predict by judging information, and may include knowledge/probability-based inference, optimized prediction, preference-based planning, and/or recommendation. Knowledge representation refers to technologies that automatically process human experience information into knowledge data, and may include knowledge construction (e.g., data generation/classification) and/or knowledge management (e.g., data utilization). Motion control is a technology for controlling the movement of an electronic device 101, and may include motion control and/or manipulation control (e.g., operation control).

In one embodiment, a schema for supporting operations related to the operation of an interactive service in an electronic device 101 may include a neural network. In one embodiment, the neural network may include a neural network model based on at least one of an artificial neural network (ANN), a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a long short-term memory (LSTM) network, a classification network, a plain residual network, a dense network, a hierarchical pyramid network, and/or a fully convolutional network. According to one embodiment, the type of the neural network model is not limited to the examples described above.

According to one embodiment, the memory 130 may store instructions that, when executed individually and/or collectively by the processor 120, cause the electronic device 101 to perform operations.

According to one embodiment, the memory 130 may store instructions that, when individually and/or collectively executed by the processor 120, cause the electronic device 101 to display an execution screen of an interactive service, detect a feature point from content inputted while performing the interactive service, determine relationship information with at least one counterpart user participating in the interactive service, determine an access level for user information based on the relationship information, acquire at least a part of the user information and/or general information based on the access level, generate recommendation information related to the feature point based on the acquired information, and provide the recommendation information.

According to one embodiment, the instructions may be stored as software (e.g., program 140 of FIG. 1) on the memory 130 and executable by the processor 120. For example, the instructions may include control commands, such as arithmetic and logical operations, data movement, and/or input/output that may be recognized by the processor 120. According to one embodiment, the software may include various applications (e.g., the application 146 of FIG. 1) that may provide various functions (or services) (e.g., interactive service function, call function, message function, messenger function, e-mail function, social network service (SNS) function, search function, media playback function, game function, and/or wireless communication function) in the electronic device 101.

According to one embodiment, the communication circuit 495 may support wireless communication with an external device using cellular wireless communication (e.g., 4G LTE, 5G NR) and/or short-range wireless communication (e.g., Wi-Fi). For example, the electronic device 101 may use the communication circuit 495 to communicate with an external server providing a voice assistant function over a network. According to one embodiment, the communication circuit 495 may include at least a part of the configuration and/or functions of the communication module 190 of FIG. 1 and/or the communication interface 213 of FIG. 2.

According to one embodiment, the processor 120 may perform an application layer processing function requested by a user of the electronic device 101. According to one embodiment, the processor 120 may provide control and commands of functions for various blocks of the electronic device 101. According to one embodiment, the processor 120 may perform operations or data processing related to control and/or communication of each component of the electronic device 101. For example, the processor 120 may include at least some of the configurations and/or functions of the processor 120 of FIG. 1. According to one embodiment, the processor 120 may be operatively connected to the components of the electronic device 101. According to one embodiment, the processor 120 may load commands or data received from other components of the electronic device 101 into the memory 130, process the commands or data stored in the memory 130, and store result data.

According to one embodiment, the processor 120 may include one or more processors including processing circuitry and/or executable program elements. According to one embodiment, the processor 120 may control (or process) the overall operation related to supporting the function of the electronic device 101 (e.g., the function of providing recommendation information based on artificial intelligence (AI) when providing an interactive service) based on the processing circuitry and/or executable program elements.

According to one embodiment, the processor 120 may perform an operation of displaying an execution screen of an interactive service. According to one embodiment, the processor 120 may perform an operation of detecting a feature point from content inputted while performing the interactive service. According to one embodiment, the processor 120 may perform an operation of determining relationship information with at least one counterpart user participating in the interactive service based on the feature point detection. According to one embodiment, the processor 120 may perform an operation of determining an access level for user information based on the relationship information. According to one embodiment, the processor 120 may perform an operation of acquiring at least a part of the user information and/or general information based on the access level. According to one embodiment, the processor 120 may perform an operation of generating recommendation information related to the feature point based on the acquired information. According to one embodiment, the processor 120 may perform an operation of providing recommendation information.

According to one embodiment, the detailed operation of the processor 120 of the electronic device 101 is described with reference to the drawings described below.

According to one embodiment, the processor 120 may include an application processor (AP). For example, the processor 120 may be a system semiconductor that is responsible for various functions (e.g., calculation and multimedia driving functions) of the electronic device 101. According to one embodiment, the processor 120 may be configured in the form of a system-on-chip (SoC), and may include a technology-intensive semiconductor chip (e.g., an application processor) that integrates multiple semiconductor technologies into one and implements components (e.g., system blocks) into one chip.

According to one embodiment, components (e.g., system blocks) of the processor 120 may include components, such as a graphics processing unit (GPU) 410, an image signal processor (ISP) 420, a central processing unit (CPU) 430, a neural processing unit (NPU) 440, a digital signal processor (DSP) 450, a modem 460, connectivity 470, and/or security 480, as illustrated in FIG. 4. According to one embodiment, the processor 120 may operate individually and/or collectively.

According to one embodiment, the GPU 410 may be responsible for graphics processing. In one embodiment, the GPU 410 may receive commands from the CPU 430 and perform graphics processing to express the shape, position, color, shading, movement, and/or texture of objects (or items) on the display.

According to one embodiment, the ISP 420 may be responsible for image processing and correction of images and videos. According to one embodiment, the ISP 420 may correct unprocessed data (e.g., raw data) transmitted from an image sensor of a camera (e.g., the camera module 180 of FIG. 1) to generate an image in a form more preferred by the user. In one embodiment, the ISP 420 may perform post-processing, such as adjusting partial brightness of an image and emphasizing detailed parts. For example, the ISP 420 may independently perform a process of tuning and correcting the image quality of an image acquired through a camera to generate a result preferred by the user.

According to one embodiment, the ISP 420 may support artificial intelligence (AI)-based image processing technology. According to one embodiment, the ISP 420 may support scene segmentation (e.g., image segmentation) technology that recognizes and/or classifies parts of a scene being captured in conjunction with the NPU 440. For example, the ISP 420 may include a function that applies different parameters to objects, such as the sky, bushes, and/or skin and processes them. According to one embodiment, the ISP 420 may detect and display a human face when capturing an image through the AI function, or adjust the brightness, focus, and/or color of the image using the coordinates and information of the face.

According to one embodiment, the CPU 430 may perform a role corresponding to the processor 120. According to one embodiment, the CPU 430 may decode a user's command, perform arithmetic and logical operations, and/or data processing. For example, the CPU 430 may be responsible for functions, such as memory, interpretation, calculation, and control. According to one embodiment, the CPU 430 may control the overall function of the electronic device 101. For example, the CPU 430 may execute all software of the electronic device 101 (e.g., the application 146 of FIG. 1 and/or the plurality of apps 219a and 219b of FIG. 2) on an operating system (OS) and control the hardware device. According to one embodiment, the CPU 430 may execute an application and control the overall operation of the processor 120 to perform neural network-based tasks required according to the execution of the application.

According to one embodiment, the CPU 430 may store commands or data in volatile memory (e.g., the volatile memory 132 of FIG. 1) of the memory 130, process the commands or data stored in the volatile memory, and store result data in nonvolatile memory (e.g., the nonvolatile memory 134 of FIG. 1) of the memory 130 as at least part of data processing or calculation.

According to one embodiment, the CPU 430 may include a single processor core or multiple processor cores (multi-core). According to one embodiment, the CPU 430 may be a programmable processor that stores executable instructions (e.g., instructions capable of performing operations of the CPU 430) and executes the instructions.

According to one embodiment, the CPU 430 may operate in a multi-domain environment. According to one embodiment, the CPU 430 may operate in a multi-domain environment of a normal world (e.g., a non-secure world, a framework, or a non-secure environment) and a secure world (e.g., a secure framework or a secure environment). In one embodiment, the domain of the secure world may include one or more domains (e.g., a trusted OS, a trust zone, and/or a virtualization framework). According to one embodiment, the CPU 430 may be shared between the multiple domains.

According to one embodiment, the NPU 440 may be responsible for processing optimized for artificial intelligence deep-learning algorithms. According to one embodiment, the NPU 440 is a processor optimized for deep-learning algorithm operations (e.g., artificial intelligence operations) and may process big data quickly and efficiently like a human neural network. For example, the NPU 440 may be mainly used for artificial intelligence operations. According to one embodiment, the NPU 440 may recognize objects, environments, and/or people in the background when taking a video through a camera and automatically adjust the focus, automatically switch the shooting mode of the camera module 180 to food mode when taking a picture of food, and/or be responsible for processing only the deletion of unnecessary subjects from the captured results.

According to one embodiment, the electronic device 101 may support integrated machine learning processing by interacting with all processors, such as a GPU 410, an ISP 420, a CPU 430, and an NPU 440.

According to one embodiment, the DSP 450 may represent an integrated circuit that facilitates rapid processing of digital signals. According to one embodiment, the DSP 450 may perform the function of converting analog signals into digital signals and performing high-speed processing.

According to one embodiment, the modem 460 may perform a role that enables the use of various communication functions in the electronic device 101. For example, the modem 460 may support communications such as phone calls and data transmission and reception by exchanging signals with a base station. According to one embodiment, the modem 460 may include an integrated modem (e.g., a cellular modem, an LTE modem, a 5G modem, a 5G-Advanced modem, and a 6G modem) that supports communication technologies such as long term evolution (LTE) and 2G to 5G. According to one embodiment, the modem 460 may include an artificial intelligence modem that applies an artificial intelligence algorithm.

According to one embodiment, the connectivity 470 may support wireless data transmission based on IEEE 802.11. According to one embodiment, the connectivity 470 may support communication services based on IEEE 802.11 (e.g., Wi-Fi) and/or 802.15 (e.g., Bluetooth, ZigBee, UWB). For example, the connectivity 470 may support communication services targeting an unspecified number of people in a localized area, such as indoors, by using an unlicensed band.

According to one embodiment, the security 480 may provide an independent security execution environment between data or services stored in the electronic device 101. According to one embodiment, the security 480 may play a role in preventing external hacking through software and hardware security during the process of user authentication when providing services such as biometrics, mobile identification, and/or payment of the electronic device 101. For example, the security 480 may provide an independent security execution environment for device security for reinforcing the security of the electronic device 101 itself and for security services based on user information, such as mobile identification, payment, and car keys in the electronic device 101.

According to one embodiment, the operations performed by the processor 120 may be implemented by executing instructions stored in a recording medium (or a computer program product or storage medium). For example, the recording medium may include a non-transitory computer-readable recording medium having recorded thereon a program for executing various operations performed by the processor 120.

The embodiments described in the disclosure may be implemented in a computer-readable recording medium using software, hardware, or a combination thereof. In a hardware implementation, the operations described in one embodiment may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or other electrical units for performing functions.

In one embodiment, a computer-readable recording medium (or computer program product) is provided, which records a program for causing an electronic device 101 to perform (or execute) various operations.

The operations may include an operation of displaying an execution screen of an interactive service, an operation of detecting a feature point from content inputted while performing the interactive service, an operation of determining relationship information with at least one counterpart user participating in the interactive service based on the feature point detection, an operation of determining an access level for user information based on the relationship information, an operation of acquiring at least a part of user information and/or general information based on the access level, an operation of generating recommendation information related to the feature point based on the acquired information, and an operation of providing recommendation information.

An electronic device 101 according to one embodiment of the disclosure may include a display (e.g., the display module 160 and 211 of FIGS. 1 or 2, or the display 490 of FIG. 4), memory (e.g., the memory 130 and 215 of FIGS. 1, 2, or 4) for storing instructions (hereinafter, referred to as memory 130), and processing circuitry, and may include at least one processor (e.g., the processor 120 and 214 of FIGS. 1, 2, or 4) (hereinafter, referred to as processor 120) operatively connected to the display and the memory.

According to one embodiment, the memory 130 may store one or more computer programs (or instructions) that, when individually and/or collectively executed by at least one processor 120, cause the electronic device 101 to perform operations. In one embodiment, the one or more computer programs may include computer-executable instructions that, when individually or collectively executed by one or more processors, cause the electronic device 101 to perform the following.

According to one embodiment, the instructions, when individually and/or collectively executed by the at least one processor, may cause the electronic device to display an execution screen of an interactive service. The instructions, when individually and/or collectively executed by the at least one processor, may cause the electronic device to detect a feature point from content inputted while performing the interactive service. The instructions, when individually and/or collectively executed by the at least one processor, may cause the electronic device to determine relationship information with at least one counterpart user participating in the interactive service. The instructions, when individually and/or collectively executed by the at least one processor, may cause the electronic device to determine an access level for user information based on the relationship information. The instructions, when individually and/or collectively executed by the at least one processor, may cause the electronic device to acquire at least a part of the user information and/or general information based on the access level. The instructions, when individually and/or collectively executed by the at least one processor, may cause the electronic device to generate recommendation information related to the feature point based on the acquired information. The instructions, when individually and/or collectively executed by the at least one processor, may cause the electronic device to provide the recommendation information.

According to one embodiment, the interactive service may include a service that supports communication between users through an application for conversation between two or more remote parties (e.g., a messaging service, a chat service, a SNS, an e-mail service).

According to one embodiment, the content may include a text or an image provided through the conversation field of the interactive service.

According to one embodiment, the feature points may include a meaningful words and/or a meaningful image object that may be extracted from the content.

According to one embodiment, the instructions, when individually and/or collectively executed by the at least one processor, may cause the electronic device to display the content in the conversation field while performing the interactive service. According to one embodiment, the instructions, when individually and/or collectively executed by the at least one processor, may cause the electronic device to detect the feature point from the content displayed in the conversation field. According to one embodiment, the instructions, when individually and/or collectively executed by the at least one processor, may cause the electronic device to execute an AI-based answer function based on detecting the feature point. According to one embodiment, the instructions, when individually and/or collectively executed by the at least one processor, may cause the electronic device to generate the recommendation information at least based on the user information and the general information in the AI-based answer function.

According to one embodiment, the instructions, when individually and/or collectively executed by the at least one processor, may cause the electronic device to provide a notification object related to the artificial intelligence-based answer function in association with the input field of the interactive service based on executing the artificial intelligence-based answer function.

According to one embodiment, the notification object may include an object that indicates a status of whether the artificial intelligence-based answer function is operating and supports a toggle for activating or deactivating the artificial intelligence-based answer function.

According to one embodiment, the instructions, when individually and/or collectively executed by the at least one processor, may cause the electronic device to provide the recommendation information to the input field of the interactive service. According to one embodiment, the instructions, when individually and/or collectively executed by the at least one processor, may cause the electronic device to edit or transmit the recommendation information based on a user input while the recommendation information is provided through the input field.

According to one embodiment, the instructions, when executed individually and/or collectively by the at least one processor, may cause the electronic device to edit the recommendation information at least based on a direct input by the user, a change in an amount of information according to adjustment of an information disclosure level based on an adjustment object, or selection of sub-information from a list of sub-information that may replace the main information.

According to one embodiment, the instructions, when individually and/or collectively executed by the at least one processor, may cause the electronic device to transmit the recommendation information to the electronic device of the counterpart user based on the user input while the recommendation information is provided through the input field, and to provide the recommendation information through a conversation field of the interactive service.

According to one embodiment, the interactive service may be provided including an adjustment object for information adjustment.

According to one embodiment, the instructions, when individually and/or collectively executed by the at least one processor, may cause the electronic device to provide the recommendation information by changing it according to a step corresponding to the adjustment object based on a user input using the adjustment object.

According to one embodiment, the instructions, when individually and/or collectively executed by the at least one processor, may cause the electronic device to provide a part of the recommendation information that is edited by the user and a part of the recommendation information that is automatically generated by artificial intelligence separately.

According to one embodiment, the instructions, when executed individually and/or collectively by the at least one processor, may cause the electronic device to provide a list of at least one sub-information that may replace the main information related to the feature point while the recommendation information is provided through an input field.

According to one embodiment, the instructions, when individually and/or collectively executed by the at least one processor, may cause the electronic device to detect a user input for selecting sub-information from the list. According to one embodiment, the instructions, when individually and/or collectively executed by the at least one processor, may cause the electronic device to provide the main information by replacing it with the selected sub-information based on the user input.

According to one embodiment, the instructions, when individually and/or collectively executed by the at least one processor, may cause the electronic device to provide the list between the input field and the keyboard area, or to provide the list in place of the keyboard area.

Hereinafter, the operation method of the electronic device 101 of various embodiments will be described in detail. Operations performed in the electronic device 101 according to various embodiments may be executed by a processor 120 including various processing circuitry and/or executable program elements of the electronic device 101. According to one embodiment, the operations performed in the electronic device 101 may be stored as instructions in memory 130 and individually and/or collectively performed (or executed) by one or more processors (e.g., the processor 120 of FIG. 1).

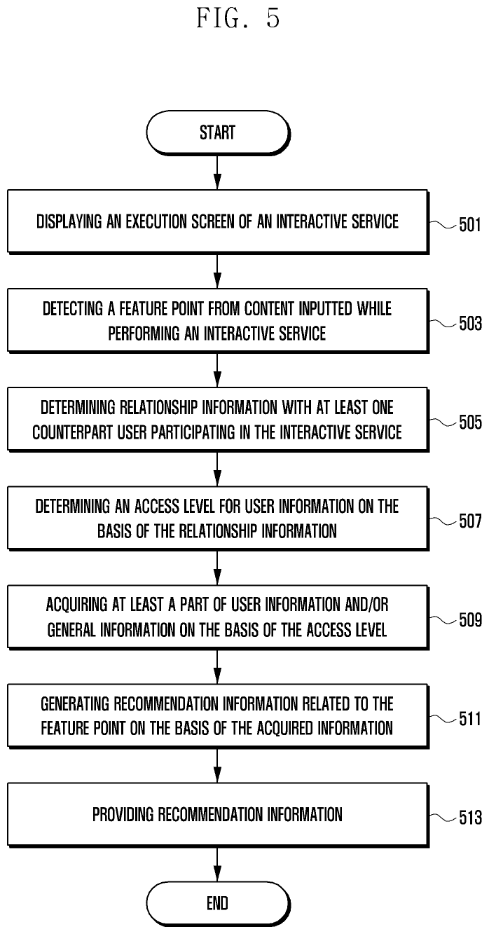

FIG. 5 is a flowchart illustrating an operation method of an electronic device according to an embodiment of the disclosure.

According to one embodiment, FIG. 5 may illustrate an example of an operation of providing recommendation information (e.g., recommended answers) through artificial intelligence (AI) while executing an interactive service in an electronic device 101 according to one embodiment.

An operation method supported by an electronic device 101 according to one embodiment of the disclosure may be performed, for example, according to a flowchart illustrated in FIG. 5. The flowchart illustrated in FIG. 5 is an example according to one embodiment of an operation of the electronic device 101, and the order of at least some operations may be changed, performed in parallel, performed as independent operations, or at least some other operations may be performed complementarily to at least some operations. According to one embodiment of the disclosure, operations 501 to 513 may be performed by at least one processor 120 of the electronic device 101 (e.g., the processor 120 and 214 of FIGS. 1, 2, or 4).

Referring to FIG. 5, an operation method performed by an electronic device 101 according to one embodiment may include an operation of displaying an execution screen of an interactive service (operation 501), an operation of detecting a feature point from content inputted while performing an interactive service (operation 503), an operation of determining relationship information with at least one counterpart user participating in the interactive service based on the feature point detection (operation 505), an operation of determining an access level for user information based on the relationship information (operation 507), an operation of acquiring at least a part of user information and/or general information based on the access level (operation 509), an operation of generating recommendation information related to the feature point based on the acquired information (operation 511), and an operation of providing recommendation information (operation 513).

Referring to FIG. 5, in operation 501, the processor 120 of the electronic device 101 may perform an operation of displaying an execution screen of an interactive service. According to one embodiment, the interactive service may include a service that supports communication between users through an application for conversation between two or more remote parties (e.g., an application that supports a service such as a message service, a chat service, an SNS, or an e-mail service). According to one embodiment, the processor 120 may execute an application based on a user input requesting execution of an application for the interactive service. According to one embodiment, the processor 120 may execute the application and provide an interactive service related to the application to the user. For example, the processor 120 may display an execution screen including a conversation field (or conversation window) (e.g., an execution screen of an interactive service (e.g., a chat screen, a mail screen, an SNS screen)) through a display (e.g., a display module 160 of FIG. 1).

In operation 503, the processor 120 may perform an operation of detecting a feature point from content inputted while performing an interactive service. According to one embodiment, the content may include text and/or images provided through a conversation field of the interactive service. For example, the content may represent text and/or images inputted (or written or attached) by a user through an input field of the interactive service, inputted into the conversation field of the interactive service (e.g., transmitted externally through a specified communication from an electronic device), and shared with at least one counterpart user participating in the interactive service. According to one embodiment, the feature point may include meaningful words and/or meaningful image objects that may be extracted from the content. For example, the feature point may be divided into a feature word and a feature part. In one embodiment, the feature word may include a meaningful word and/or a user-specified word of interest determined based on word or context analysis within the content (e.g., a sentence). In one embodiment, the feature part may include various image objects (or image areas) (e.g., people, faces, animals, places, things) that may be extracted based on content analysis (e.g., image analysis, object recognition) within the content (e.g., image).

According to one embodiment, the processor 120 may detect features (e.g., feature words or feature parts) from the content of a conversation field. For example, the processor 120 may detect feature words based on linguistic context analysis from the content of the conversation field (e.g., text (e.g., sentences) or images of a user's previous utterance) upon activation of an input field (or selection of an input field by a user) while performing an interactive service, and/or may detect feature parts based on image analysis.

In operation 505, the processor 120 may perform an operation of determining relationship information with at least one counterpart user participating in the interactive service based on detecting a feature point. According to one embodiment, when a feature point is detected from content, the processor 120 may identify at least one counterpart user participating in the interactive service. For example, the processor 120 may identify an identifier (e.g., a name, a nickname, an ID, an email address, and/or a phone number) used by the counterpart user of the interactive service in the interactive service. According to one embodiment, the processor 120 may search for information (e.g., a name, a nickname, an ID, an email address, and/or a phone number) corresponding to (or mapped to) the identifier from information (e.g., contact information) stored (or registered) in the electronic device 101 (e.g., the memory 130 of FIG. 1) and/or a server (e.g., a user account-based cloud server).

According to one embodiment, the processor 120 may identify a first relationship (e.g., a family relationship, a friend relationship, a romantic relationship, a colleague relationship, a neighbor relationship, an SNS relationship, or a business relationship) and/or a second relationship (e.g., a dependent relationship such as a parent, sibling, grandparent, or relative among family relationships, or a dependent relationship such as a company, school, or club among colleague relationships) with the counterpart user participating in the interactive service based on the retrieved information. In one embodiment, the processor 120 may identify a relationship with the counterpart user as having no relationship (e.g., no relationship) if no information related to the counterpart user is retrieved from the pre-stored information. In one embodiment, the pre-stored information may include information stored in the memory 130 of the electronic device 101 and/or stored externally (e.g., a cloud server, an account server, a social network service) of the electronic device 101. For example, the pre-stored information may include phone book information, account information, and/or SNS information acquirable from the electronic device 101 and/or externally.

According to one embodiment, when a relationship with a counterpart user is identified, the processor 120 may determine intimacy based on the identified relationship. In one embodiment, intimacy may be classified as, for example, high, medium, or low depending on the relationship with the user. In one embodiment, the classification of relationships is and is not limited thereto, and may be configured in various ways, such as more detailed levels (e.g., four or more levels) or expanded levels (e.g., two levels). In one embodiment, the processor 120 may not perform an intimacy determination operation. According to one embodiment, when a relationship with a counterpart user is identified, the processor 120 may operate to immediately determine an access level based on the identified relationship (e.g., relationship information). For example, if the relationship with the counterpart user is family, the processor 120 may allow access to all personal information. For example, if the relationship with the counterpart user is coworker, the processor 120 may block (or not allow) access to specified information (e.g., gallery information).

According to one embodiment, the processor 120 may determine whether the intimacy with the counterpart user is high, medium, or low based on the identified relationship. According to one embodiment, the processor 120 may determine relationship information with the counterpart user based on the relationship and intimacy. In one embodiment, the relationship information may be classified into high, medium, and low. In one embodiment, the classification of the relationship information is and is not limited thereto, and may be configured in various ways such as more detailed levels (e.g., very high, high, medium, low, very low, none). For example, the processor 120 may determine the relationship information as ‘high’ if the relationship is a first family (e.g., parent or sibling) and the intimacy is ‘high’. For example, the processor 120 may determine the relationship information as ‘medium’ if the relationship is a second family (e.g., relative) and the intimacy is ‘medium’. For example, the processor 120 may determine the relationship information as ‘medium’ if the relationship is a coworker relationship and the intimacy is ‘high’. For example, the processor 120 may determine the relationship information as ‘low’ if it is a peer relationship and the intimacy is ‘medium’ or lower.

In operation 507, the processor 120 may perform an operation of determining an access level for user information based on relationship information. In one embodiment, an operation of determining the access level may include an operation of distinguishing an access level in the processor 120. The disclosure is not limited thereto, and an operation of determining the access level may include, for example, determining the degree of access to user information based on a relationship with the user (e.g., family, relatives, friends, or colleagues). In one embodiment, the access level may include the degree of authority (or permission) to access user information for composing recommendation information, and may be distinguished as, for example, high (e.g., access level=1), medium (e.g., access level=2), and low (e.g., access level=3). In one embodiment, the distinction of the access level is and is not limited thereto, and may be configured in various ways such as in more detailed steps.

According to one embodiment, the processor 120 may determine the access level for user information as “high” when the relationship information is “high”. In one embodiment, even when the relationship information is “high,” access to user-specified excluded user information (e.g., categories of user information) may not be permitted. According to one embodiment, the processor 120 may determine the access level for user information as “medium” when the relationship information is “medium”. According to one embodiment, the processor 120 may determine the access level for user information as “low” when the relationship information is “low”.

According to one embodiment, even if the processor 120 has the same relationship information, if the user has configured the provision of user information (e.g., personal information) differently, the processor 120 may determine different access levels based on the user configurations. For example, the user may change the configurations to provide different personal information even for the same relationship. For example, for a first user, a second user, and a third user in the same friendship relationship, the first user may be configured to have access to all photos in the gallery, the second user may be configured to have access only to a specified folder in the gallery, and the third user may be configured to have no access to the gallery. According to one embodiment, the configurations for relationship information may be added, modified (or changed), or deleted by the user.

In operation 509, the processor 120 may perform an operation to acquire at least a part of the user information and/or general information based on the access level.

In one embodiment, the user information may include various information associated with the feature point and stored in the electronic device 101 and/or an external server (e.g., a cloud server) that is related to (or associated with) the user of the electronic device 101. For example, the processor 120 may extract user information associated with the feature point from among related information directly used by the user (e.g., information directly related to the user) such as various operations (or actions) performed by the user through the electronic device 101 (e.g., payment, location movement, media playback, media download, recording, web surfing, SNS use, messenger use, taking pictures, visiting places, writing notes, taking pictures/videos, and/or writing messages) and/or configurations made by the user (e.g., account configurations, mobile ID configurations). In one embodiment, the user information may include sensitive information and personal information. The sensitive information may be stored, for example, in the electronic device 101 and/or externally (e.g., a cloud server). Sensitive information may include, for example, content information about content (e.g., photos/videos taken by a camera application, memo content created by a document application, and/or recording content recorded by a recording application), financial information related to the user's financial use, and/or payment information related to the user's payment use. Personal information may be stored, for example, in the electronic device 101 and/or externally (e.g., a cloud server). Personal information may include, for example, account information, mobile ID information, financial information, location information, health information, SNS information, conversation history information, Internet usage history information, music application-related information (e.g., downloaded music, recently played music, user-customized (e.g., frequently played by the user) music), geographic location information, movement path information based on location movement during a specified period (e.g., a day, a week, or a month), and visit information (e.g., information acquired based on a specified location tagged in a map application).

According to one embodiment, sensitive information and personal information may be classified for convenience of explanation, and may be managed as user information without classification into sensitive information and personal information. In one embodiment, user information, sensitive information, and/or personal information may be classified in advance by the electronic device 101 and/or an external source (e.g., a cloud server) and stored in the electronic device 101 and/or externally. In one embodiment, user information, sensitive information, and/or personal information may be classified by the user of the electronic device 101 and stored in the electronic device 101 and/or externally.

In one embodiment, the general information may include information (e.g., generally available information) that is associated with the feature point and may be retrieved externally (e.g., through a web server (or internet server), a social network service, and/or a broadcast service). For example, assuming that the feature point is a feature word related to “place” (e.g., Seoul, the United States, department store A, train station B), the personal information may include information that is accessible based on the access level, and may include data searched (e.g., Seoul search), visited (e.g., Seoul visit history, location, and/or date), photographed (e.g., photographed in Seoul), used (e.g., payment), and/or written (e.g., Seoul entered in a chat room) in association with the place (e.g., Seoul) from user information of the electronic device 101 and/or an external server (e.g., a cloud server). For example, assuming that the feature point is a feature word related to “place,” the general information may include a search result for the place (e.g., Seoul) externally (e.g., a web server, a social network service, and/or a broadcast service). For example, general information may be publicly available for external search and may include common information associated with a location (e.g., Seoul) that all users may access and search (or recognize).

According to one embodiment, the processor 120 may access most of the user information to collect (or extract) data for recommendation information based on determining the access level to the user information as ‘high’. In one embodiment, even when the access level is ‘high’, access to user-specified excluded user information (e.g., categories of user information) may not be permitted. According to one embodiment, the processor 120 may access a part of the user information (e.g., categories of specified user information) to collect (or extract) data for recommendation information based on determining the access level to the user information as ‘medium’. According to one embodiment, the processor 120 may restrict (or not permit) access to the user information based on determining the access level to the user information as ‘low’.

According to one embodiment, the processor 120 may collect general information along with user information collection based on access level. According to one embodiment, the processor 120 may operate to search for information related to the feature point through the electronic device 101 and/or an external server (e.g., a cloud server, an internet server). For example, the processor 120 may collect data related to the feature point (e.g., location data, time data, dictionary data) from various data stored in the electronic device 101. For example, the processor 120 may provide the feature point (or information related to the feature point) to an external server, request the external server to search for data related to the feature point, and receive the search data searched by the external server. According to one embodiment, the processor 120 may also operate to acquire the general information through AI. For example, the general information may be searched, extracted, and/or collected by the AI and provided to the processor 120.

According to one embodiment, the order of operations 503 to 509 is not limited to the order shown, and the order of operations 503 to 509 may be changed. For example, operations 503 to 509 may be performed sequentially, in parallel, in reverse sequence, iteratively, or heuristically, or one or more of operations 503 to 509 may be performed in a different order, omitted, or one or more other operations may be added.

In operation 511, the processor 120 may perform an operation of generating (e.g., inferring) recommendation information related to a feature point based on acquired information (e.g., user information and/or general information). According to one embodiment, the processor 120 may generate recommendation information having a linguistic context based on data collected from at least a part of the user information (e.g., first data) and/or data collected from the general information (e.g., second data) through AI. According to one embodiment, the processor 120 (or AI) may generate recommendation information through linguistic context analysis from the given data. In one embodiment, the linguistic context analysis may include, for example, an analysis that takes into account the communication situation and the content of preceding and following utterances surrounding a certain utterance (e.g., feature point).

In operation 513, the processor 120 may perform an operation of providing recommendation information. According to one embodiment, the processor 120 may display the recommendation information through an input field of an interactive service. According to one embodiment, the user may input the recommendation information provided through the input field by transmitting (or sharing) the recommendation information, or may input the recommendation information provided through the input field by editing (or processing) the recommendation information and then transmitting the edited recommendation information.

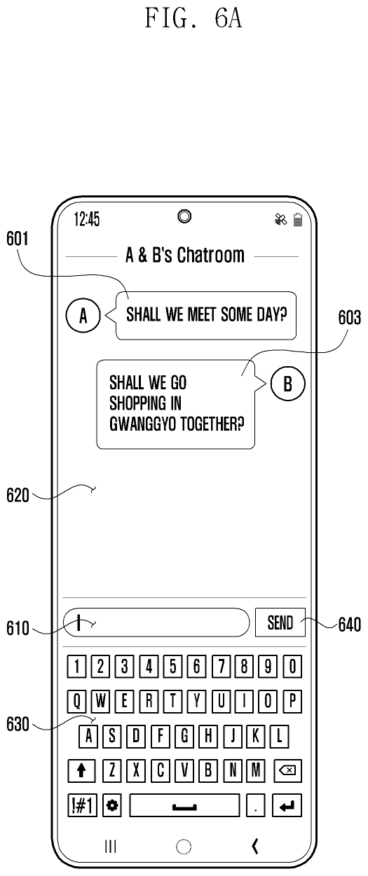

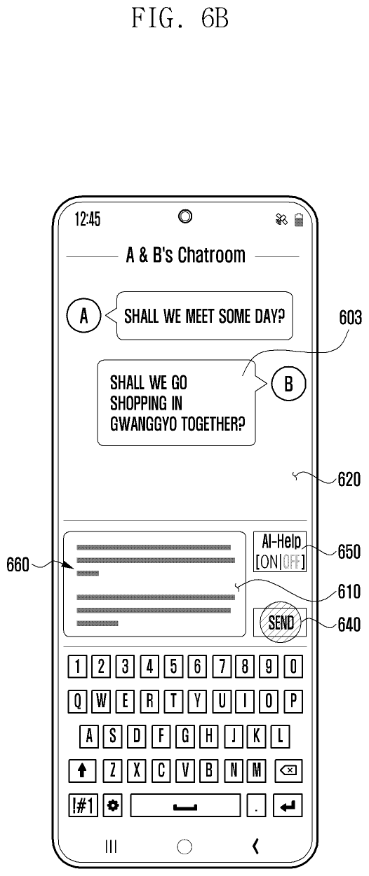

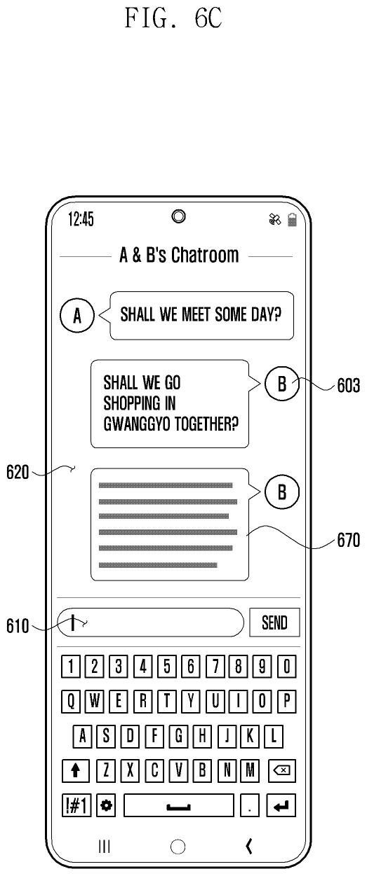

FIGS. 6A, 6B, and 6C are diagrams illustrating examples of providing interactive services in an electronic device according to various embodiments of the disclosure.

According to one embodiment, FIGS. 6A, 6B, and 6C may illustrate examples of conversation screens in which an interactive service is performed between a user (e.g., user B) and a counterpart user (e.g., user A).

Referring to FIG. 6A, FIG. 6A may illustrate an example of an execution screen (e.g., a user interface) of an interactive service. As illustrated in FIG. 6A, the execution screen may include a first area for an input field 610, a second area for a conversation field 620, and a third area for a keyboard 630 (or keypad). According to one embodiment, the first area may include a send button 640 for sharing content (e.g., text and/or images) inputted through the input field 610 (e.g., transmitting it to an electronic device of the counterpart user) with a counterpart user and displaying it in the conversation field 620. According to one embodiment, the third area for the keyboard 630 may be provided by being activated (e.g., sliding in from a lower area) based on a first user input (e.g., a touch) based on the input field 610. According to one embodiment, in FIG. 6A, first content 601 (e.g., text in a conversation bubble) shared by a counterpart user (e.g., user A) and second content 603 (e.g., text in a conversation bubble) shared by a user (e.g., user B) may be displayed through a conversation field 620.

Referring to FIG. 6B, FIG. 6B may illustrate an example of providing recommendation information 660 generated based on AI based on content (e.g., second content 603). According to one embodiment, the content may include text and/or images provided through a conversation field 620 of an interactive service. For example, the content may indicate text and/or images inputted (or written or attached) by a user through an input field 610 of the interactive service into the conversation field 620 of the interactive service (e.g., transmitted externally through a specified communication from an electronic device 101) and shared with at least one counterpart user participating in the interactive service.

According to one embodiment, the electronic device 101 may generate recommendation information 660 through AI based on content (e.g., second content 603) entered in the conversation field 620, and provide the generated recommendation information 660 through the input field 610.

According to one embodiment, the electronic device 101 may detect features from the second content 603 through AI. In one embodiment, the features in FIG. 6B may include features (e.g., meaningful words and/or user-defined words of interest) analyzed based on word or context analysis within the second content 603. For example, in FIG. 6B, the features may be ‘Gwanggyo’ indicating a place and ‘shopping’ indicating an activity. In one embodiment, if the second content 603 includes words indicating a date and/or time, the features may further include the date and/or time.

According to one embodiment, the electronic device 101 may detect feature words (e.g., ‘Gwanggyo’ and ‘shopping’) based on linguistic context analysis from content (e.g., second content 603) inputted by a user (e.g., a user of the electronic device 101) in a conversation field 620 upon activation of the input field 610 (or selection of the input field 610 by the user) while performing an interactive service (e.g., text (or sentence) of the user's previous utterance (e.g., ‘Shall we go shopping in Gwanggyo together?’).

According to one embodiment, when the electronic device 101 detects a feature word in the second content 603 of the conversation field 620, it may determine to enter (or execute) the AI-based answer mode (or AI-based answer function). According to one embodiment, the electronic device 101 may provide a notification object 650 related to the AI-based answer mode based on the execution (or entry) of the AI-based answer mode. In one embodiment, the notification object 650 may be an object indicating a status regarding whether the AI-based answer mode is operating (or executing). In one embodiment, the notification object 650 may support a toggle for activating or deactivating the AI-based answer mode. In one embodiment, the notification object 650 may be provided in association with the input field 610. For example, the electronic device 101 may provide the notification object 650 in association with the input field 610 of the interactive service based on the execution of the AI-based answer mode. Various examples of notification objects 650 being provided are described below with reference to the drawings.

According to one embodiment, the electronic device 101 may perform an operation related to generating AI-based recommendation information 660 at least based on user information and/or general information through AI in an AI-based answer mode. According to one embodiment, when the electronic device 101 detects a feature word in the second content 603 of the conversation field 620, the electronic device 101 may determine relationship information between the user and the counterpart user participating in the interactive service (e.g., user A). According to one embodiment, the electronic device 101 may determine relationship information based on the relationship and intimacy between the user and the counterpart user.

According to one embodiment, the electronic device 101 may determine an access level for user information based on relationship information. In one embodiment, the access level may include the degree of authority (or permission) to access user information for composing recommendation information 660.

According to one embodiment, the electronic device 101 may collect data related to the feature word (e.g., data for composing the recommendation information 660) from accessible user information (e.g., source information, e.g., conversation history with the counterpart user, other applications used in conversation with the counterpart user, photos taken with the counterpart user, places visited with the counterpart user, and/or personal information of the user, for composing the recommendation information in association with the feature word and the counterpart user in conversation) and general information inside or outside the electronic device 101. For example, the electronic device 101 may collect first data related to feature words (e.g., ‘Gwanggyo’ and ‘shopping’) from user information through AI (e.g., data related to actions the user took in Gwanggyo (e.g., shopping, eating, visiting places (e.g., A Shopping Mall), taking pictures, and/or making payments)), and second data related to feature words (e.g., ‘Gwanggyo’ and ‘shopping’) from general information (e.g., data related to hot places located in Gwanggyo (e.g., restaurants, B Shopping Mall)).

According to one embodiment, the electronic device 101 may generate (e.g., infer) recommendation information 660 related to feature words (e.g., ‘Gwanggyo’ and ‘shopping’) based on a combination of collected data (e.g., first data and second data) through AI. According to one embodiment, the electronic device 101 may generate recommendation information 660 having a linguistic context based on the first data and the second data through AI. According to one embodiment, the electronic device 101 (or AI) may generate recommendation information 660 through linguistic context analysis from given data. In one embodiment, the linguistic context analysis may include, for example, an analysis that takes into account the communication situation and the content of the preceding and following utterances surrounding a certain utterance (e.g., feature word). For example, the electronic device 101 may generate recommendation information 660 having linguistic context by constructing preceding and following utterances around feature words (e.g., “Gwanggyo” and “shopping”), such as “I recently went to Gwanggyo A Shopping Mall, and it was great for shopping because there were many clothing stores. I heard that the newly opened B Shopping Mall in Gwanggyo is also nice because it has many dessert spots and popular restaurants”.

According to one embodiment, the electronic device 101 may provide (e.g., display) recommendation information 660 generated through AI through an input field 610. According to one embodiment, the user may input the recommendation information 660 provided through the input field 610 into the conversation field 620 by transmitting (or sharing) it through a send button 640. According to one embodiment, the user may edit (or process) the recommendation information 660 provided through the input field 610 through user input and then input it into the conversation field 620 by transmitting it through a send button 640. Various examples of editing the recommendation information 660 will be described with reference to the drawings described below.

Referring to FIG. 6C, FIG. 6C may illustrate an example of providing recommendation information 670 through a conversation field 620 of an interactive service. According to one embodiment, when a transmission request (e.g., selection of a send button 640) is made by a user for recommendation information 660 provided through an input field 610 as in FIG. 6B, the electronic device 101 may transmit the recommendation information 660 to an external device (e.g., an electronic device of a counterpart user) through a specified communication, and provide the transmitted recommendation information 670 through the conversation field 620. According to one embodiment, based on transmitting the recommendation information 660 of the input field 610, the electronic device 101 may remove (or not display) the recommendation information 660 of the input field 610 and display the transmitted recommendation information 670 through the conversation field 620. According to one embodiment, when the electronic device 101 removes the recommendation information 660 upon transmission of the recommendation information 660, the electronic device 101 may remove and not display the notification object 650 provided in association with the input field 610.

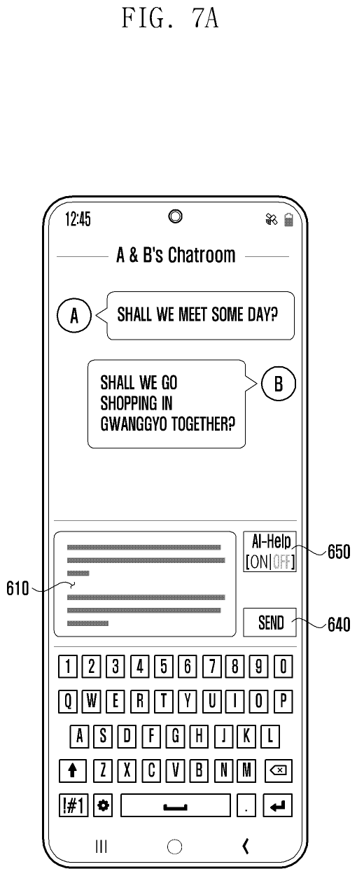

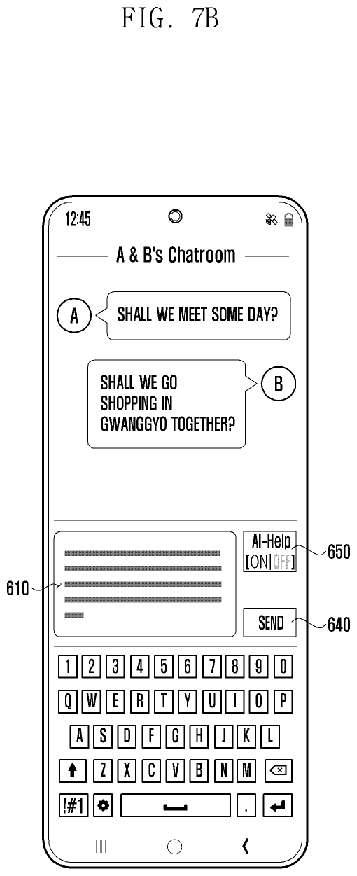

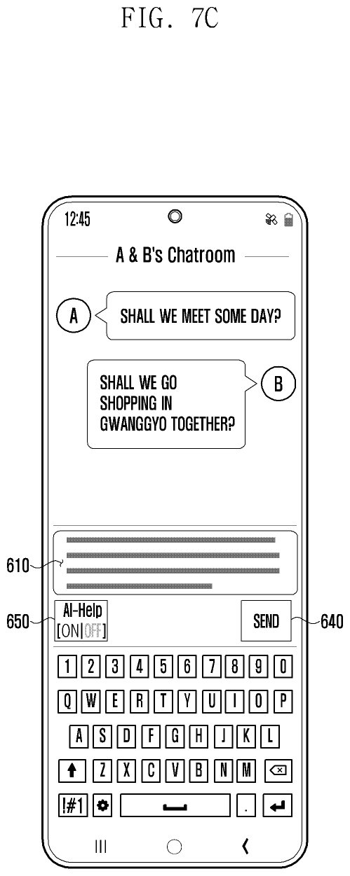

FIGS. 7A, 7B, and 7C are diagrams illustrating various examples of a user interface for supporting an interactive service in an electronic device according to various embodiments of the disclosure.

According to one embodiment, FIGS. 7A, 7B and 7C may illustrate various examples of an interface that provides an input field 610, a send button 640 and a notification object 650 in an area for the input field 610.

Referring to FIG. 7A, FIG. 7A may illustrate an example in which a send button 640 and a notification object 650 are positioned outside an input field 610. For example, in an area for an input field 610, the input field 610 may be positioned offset to the left, and the send button 640 and the notification object 650 may be positioned adjacent to the right side of the input field 610. According to one embodiment, the transmission object 640 may be fixedly positioned at the lower right side of the input field 610, and the notification object 650 may be fixedly positioned at the upper right side of the input field 610. According to one embodiment, the size (e.g., height) of the input field 650 may be variable (e.g., the size of the area of the conversation field 620 may be reduced while the size of the area of the input field 610 may be increased) depending on the amount of information of the recommendation information. According to one embodiment, the position of the notification object 650 may vary (e.g., the position may move up and down depending on the increase or decrease in the size of the input field 610) depending on the change in the size of the input field 610.

Referring to FIG. 7B, FIG. 7B may illustrate an example in which a send button 640 and a notification object 650 are positioned within an input field 610. For example, the input field 610 may be positioned to occupy the entire area in the area for the input field 610, and the send button 640 and the notification object 650 may be positioned offset to the right side of the inside of the input field 610. According to one embodiment, the transmission object 640 may be fixedly positioned at the lower right within the input field 610, and the notification object 650 may be fixedly positioned at the upper right within the input field 610. According to one embodiment, the position of the notification object 650 may vary (e.g., the position may move up and down depending on the increase or decrease in the size of the input field 610) depending on the change in the size of the input field 610.

Referring to FIG. 7C, FIG. 7C may illustrate an example in which a send button 640 and a notification object 650 are positioned outside of an input field 610. For example, in an area for an input field 610, the input field 610 may be positioned offset to the upper side, and the send button 640 and the notification object 650 may be positioned adjacent to the lower side of the input field 610. According to one embodiment, the transmission object 640 may be fixedly positioned offset to the lower right side of the input field 610, and the notification object 650 may be fixedly positioned offset to the lower left side of the input field 610. According to one embodiment, the size (e.g., height) of the input field 610 may be variable (e.g., the size of the area of the conversation field 620 may be increased while the size of the area of the input field 610 is decreased) depending on the amount of information of the recommendation information. According to one embodiment, the transmission object 640 and the notification object 650 may have fixed positions regardless of the size variation of the input field 610.

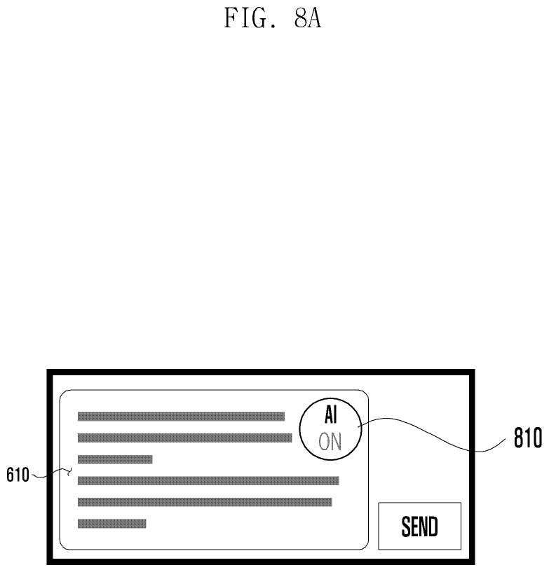

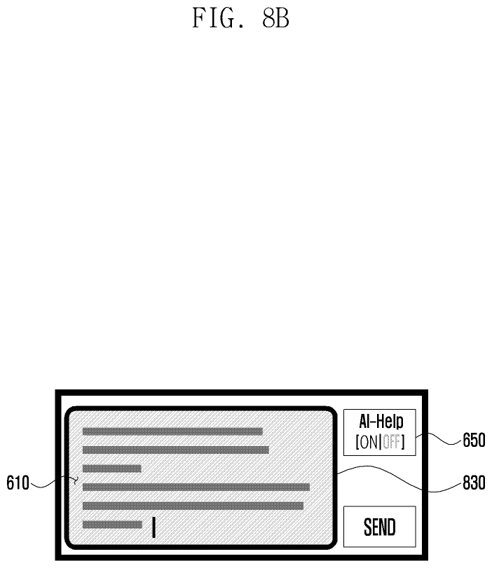

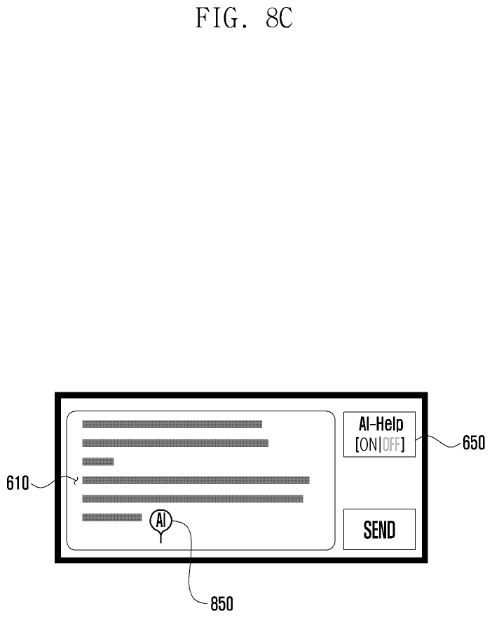

FIGS. 8A, 8B, and 8C are diagrams illustrating various examples of a user interface for supporting an interactive service in an electronic device according to various embodiments of the disclosure.

According to one embodiment, FIGS. 8A, 8B, and 8C may illustrate various examples of interfaces for indicating the status of an AI-based answer mode (or AI-based answer function).

Referring to FIG. 8A, FIG. 8A may illustrate an example of providing a notification object 810 as a floating icon, indicating that AI is assisting with a response (e.g., recommendation information). For example, the notification object 810 may be provided in a floating form over an input field 610.

Referring to FIG. 8B, FIG. 8B may illustrate an example of providing status notifications through color changes of letters and/or backgrounds of an input field 610, in addition to a notification object 810 capable of indicating that AI is assisting with an answer (e.g., recommendation information). For example, the background of the input field 610 may be changed from a specified first color (e.g., white background) to a specified second color (e.g., green background, yellow background, or sky blue background), thereby providing the operational status of the AI-based recommendation mode with a visual effect according to the color change.

Referring to FIG. 8C, FIG. 8Cc may illustrate an example of providing status notification through a cursor 850 within an input field 610, in addition to a notification object 650 capable of indicating that AI is assisting with an answer (e.g., recommendation information). For example, the shape of the cursor provided within the input field 610 may be changed from a specified first cursor (e.g., a bar-shaped cursor) to a specified second cursor (e.g., a lollipop-shaped cursor including an AI logo), thereby providing an operational status of an AI-based recommendation mode as a visual effect according to the cursor change.

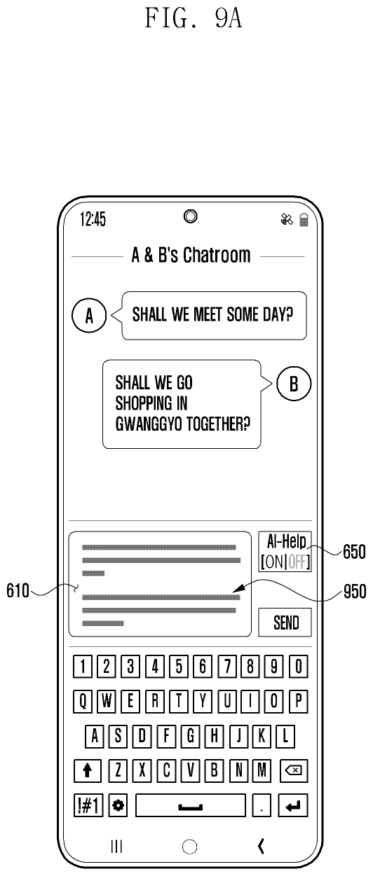

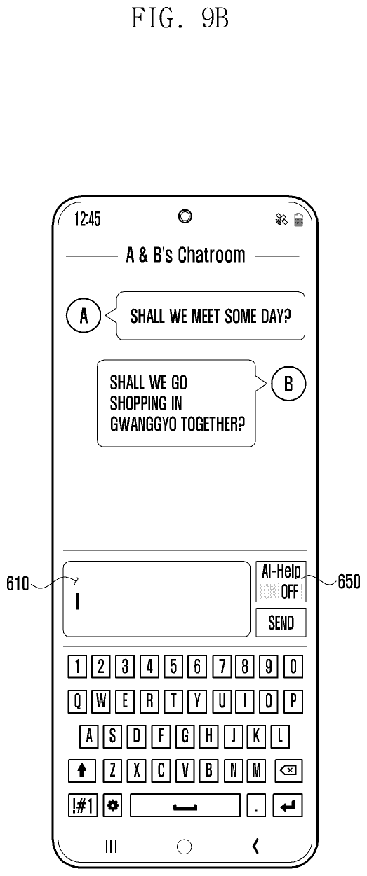

FIGS. 9A and 9B are diagrams illustrating examples of providing interactive services in an electronic device according to various embodiments of the disclosure.

According to one embodiment, FIGS. 9A and 9B may illustrate examples of supporting activation/deactivation (or on/off) of a recommendation function in an AI-based recommendation mode.

Referring to FIG. 9A, FIG. 9A may illustrate an example of a state in which a function is activated (or turned on) to display recommendation information generated in an AI-based recommendation mode. For example, FIG. 9A may illustrate an example of a state in which recommendation information 950 is displayed in an input field 610 according to a state in which a function is activated (e.g., an “ON” button of a notification object 650 is activated) to display recommendation information 950 in an AI-based recommendation mode.

Referring to FIG. 9B, FIG. 9B may illustrate an example of a state in which a function is disabled (or turned off) so as not to display recommendation information generated in an AI-based recommendation mode. For example, FIG. 9B may illustrate an example in which recommendation information is not displayed in an input field 610 according to a state in which a function is disabled (e.g., an “OFF” button of a notification object 650 is activated) so as not to display recommendation information 950 in an AI-based recommendation mode.

According to one embodiment, a user may display or not display recommendation information 950 by toggling the display function based on the notification object 650 in the AI-based recommendation mode. According to one embodiment, the disabled state of the display function is for toggling whether to display the recommendation information, and the running state of the AI-based recommendation mode may be maintained. According to one embodiment, the AI-based recommendation mode may be disabled (or turned off) using the notification object 650, and when the AI-based recommendation mode is disabled, the notification object 650 may be removed (e.g., not displayed).

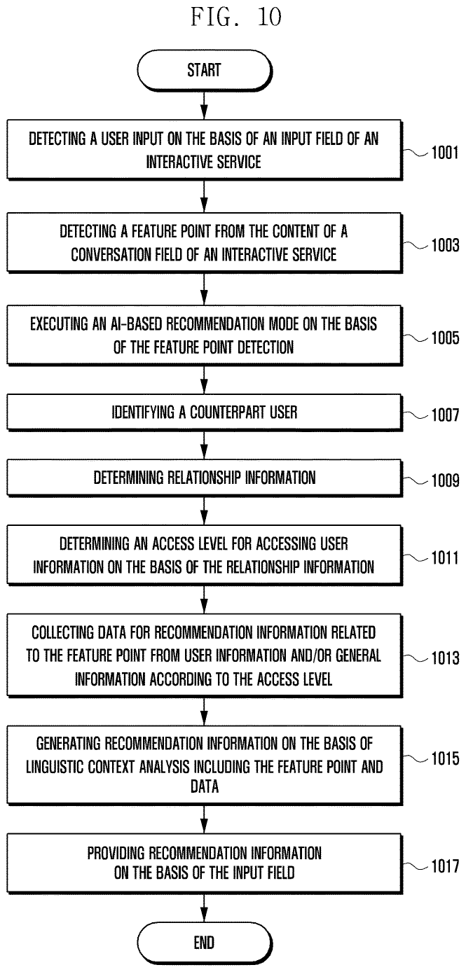

FIG. 10 is a flowchart illustrating an operation method of an electronic device according to an embodiment of the disclosure.

According to one embodiment, FIG. 10 may illustrate an example of an operation of providing recommendation information (e.g., recommended answers) through artificial intelligence while executing an interactive service in an electronic device 101 according to one embodiment.

An operation method supported by an electronic device 101 according to one embodiment of the disclosure may be performed, for example, according to a flowchart illustrated in FIG. 10. The flowchart illustrated in FIG. 10 is an example according to one embodiment of an operation of the electronic device 101, and the order of at least some operations may be changed, performed in parallel, performed as independent operations, or at least some other operations may be performed complementarily to at least some operations. According to one embodiment of the disclosure, operations 1001 to 1017 may be performed by at least one processor of the electronic device 101 (e.g., the processor 120 and 214 of FIGS. 1, 2, or 4).

According to one embodiment, the operations described in FIG. 10 may be heuristically performed in combination with the operations described in FIGS. 5, 6A to 6C, 7A to 7C, 8A to 8C, 9A, and 9B, for example, or heuristically performed as a replacement for at least some of the operations described and combined with at least some other operations, or heuristically performed as a detailed operation of at least some of the operations described.

Referring to FIG. 10, an operation method performed by an electronic device 101 according to one embodiment may include an operation of detecting a user input based on an input field of an interactive service (operation 1001), an operation of detecting a feature point from the content of a conversation field of an interactive service (operation 1003), an operation of executing an AI-based recommendation mode based on the feature point detection (operation 1005), an operation of identifying a counterpart user (operation 1007), an operation of determining relationship information (operation 1009), an operation of determining an access level for accessing user information based on the relationship information (operation 1011), an operation of collecting data for recommendation information related to the feature point from user information and/or general information according to the access level (operation 1013), an operation of generating recommendation information based on linguistic context analysis including the feature point and data (operation 1015), and an operation of providing recommendation information based on the input field (operation 1017).

Referring to FIG. 10, in operation 1001, the processor 120 of the electronic device 101 may perform an operation of detecting a user input based on an input field of an interactive service. According to one embodiment, the processor 120 may detect a user input of selecting (or touching) an input field while performing the interactive service. According to one embodiment, the processor 120 may call up a keyboard based on detecting a user input based on the input field and provide the keyboard by placing it at the bottom of the input field. According to one embodiment, when the input means for user utterance in the interactive service is voice input-based rather than keyboard input-based, the keyboard may not be provided and an operation may be performed to turn on a microphone to receive a voice input according to the user utterance.

In operation 1003, the processor 120 may perform an operation of detecting a feature point from the content of a conversation field of an interactive service. According to one embodiment, the processor 120 may detect a feature point (e.g., a feature word or a feature part) from the content of the conversation field. For example, the processor 120 may detect a feature word based on linguistic context analysis from the content of the conversation field (e.g., a text (e.g., a sentence) or an image of a user's previous utterance) when an input field is activated (or an input field is selected by a user) while performing an interactive service, and/or may detect a feature part based on image analysis.

In operation 1005, the processor 120 may perform an operation of executing an AI-based recommendation mode based on feature point detection. According to one embodiment, if at least one feature point is detected from the content of the conversation field, the processor 120 may determine to execute an AI-based recommendation mode that assists (e.g., automatically generates and recommends) an answer through AI, and may enter the AI-based recommendation mode. According to one embodiment, when entering the AI-based recommendation mode, the processor 120 may provide a notification object associated with the input field. According to one embodiment, if at least one feature point is not detected from the content of the conversation field, the processor 120 may not execute the AI-based recommendation mode.

In operation 1007, the processor 120 may perform an operation of identifying a counterpart user. According to one embodiment, in an AI-based recommendation mode, the processor 120 may identify at least one counterpart user participating in the interactive service through AI. For example, the processor 120 may identify an identifier (e.g., name, nickname, ID, email address, and/or phone number) used by the counterpart user of the interactive service in the interactive service.

In operation 1009, the processor 120 may perform an operation of determining relationship information. According to one embodiment, the processor 120 may search for information (e.g., name, nickname, ID, email address, and/or phone number) corresponding to (or mapped to) the identifier from information (e.g., contact information) stored (or registered) in the electronic device 101 (e.g., the memory 130 of FIG. 1) and/or a server (e.g., a user account-based cloud server) based on the identification of the counterpart user.

According to one embodiment, the processor 120 may identify a first relationship with a counterpart user participating in an interactive service based on the retrieved information. In one embodiment, if information related to the counterpart user is not retrieved from the pre-stored information, the processor 120 may identify the relationship with the counterpart user as having no relationship (e.g., relationship ‘no’). According to one embodiment, the processor 120 may determine the degree of intimacy related to the counterpart user based on the identified relationship. In one embodiment, the pre-stored information may include information stored in the memory 130 of the electronic device 101 and/or stored in an external server (e.g., a cloud server, an account server, a social network service) of the electronic device 101. For example, the pre-stored information may include phonebook information, account information, and/or SNS information acquirable from the electronic device 101 and/or externally.

According to one embodiment, the processor 120 may determine relationship information with the counterpart user based on the relationship and intimacy. In one embodiment, the relationship information may be classified as high, medium, and low. In one embodiment, the classification of the relationship information is and is not limited thereto, and may be configured in various ways, such as more detailed levels (e.g., very high, high, medium, low, very low, none). For example, the processor 120 may determine the relationship information as “high” if the relationship is between a first family member (e.g., parents or siblings) and the intimacy is “high”. For example, the processor 120 may determine the relationship information as “medium” if the relationship is between a second family member (e.g., relatives) and the intimacy is “medium”. For example, the processor 120 may determine the relationship information as “medium” if the relationship is between colleagues and the intimacy is “high”. For example, the processor 120 may determine the relationship information as “low” if the relationship is between colleagues and the intimacy is “medium” or lower. In one embodiment, the processor 120 may not perform an intimacy determination operation. In another embodiment, once a relationship with a user is identified, the processor 120 may operate to immediately determine the level of access based on the identified relationship (e.g., relationship information). For example, if the relationship with the user is family, the processor 120 may allow access to all personal information. For example, if the relationship with the user is a colleague, the processor 120 may prevent (or not allow) access to specified information (e.g., gallery information).

According to one embodiment, the order of operations 1003 to 1009 is not limited to the order shown, and the order of operations 1003 to 1009 may be changed. For example, operations 1003 to 1009 may be executed sequentially, in parallel, in reverse sequence, iteratively, or heuristically, or one or more of operations 1003 to 1009 may be executed in a different order, omitted, or one or more other operations may be added.

In operation 1011, the processor 120 may perform an operation of determining an access level for accessing user information based on relationship information. In one embodiment, the operation of determining the access level may include an operation of distinguishing an access level in the processor 120. The disclosure is not limited thereto, and the operation of determining the access level may include, for example, determining the degree of access to user information based on a relationship with the user (e.g., family, relatives, friends, or colleagues). In one embodiment, the access level may include the degree of authority (or permission) to access user information for composing recommendation information. According to one embodiment, the processor 120 may determine the access level for user information as ‘high’ when the relationship information is ‘high’. In one embodiment, even when the relationship information is ‘high’, access to user-specified excluded user information (e.g., a category of user information) may not be permitted. According to one embodiment, the processor 120 may determine the access level for user information as ‘medium’ when the relationship information is ‘medium’. According to one embodiment, the processor 120 may determine the access level for user information as ‘low’ when the relationship information is ‘low’.

According to one embodiment, even if the processor 120 has the same relationship information, if the user has configured the provision of user information (e.g., personal information) differently, the processor 120 may determine different access levels based on the user configurations. For example, the user may change the configurations to provide different personal information even for the same relationship. For example, for a first user, a second user, and a third user in the same friendship relationship, the first user may be configured to have access to all photos in the gallery, the second user may be configured to have access only to a specified folder in the gallery, and the third user may be configured to have no access to the gallery. According to one embodiment, the configurations for relationship information may be added, modified (or changed), or deleted by the user.

In operation 1013, the processor 120 may perform an operation of collecting data for recommendation information related to feature points from user information and/or general information according to an access level.

In one embodiment, the user information may include various information stored in the electronic device 101 and/or the external server (e.g., a cloud server) that is associated with the feature point and is related to (or associated with) the user of the electronic device 101. For example, the processor 120 may extract user information associated with the feature point from among related information directly used by the user (e.g., information directly related to the user) such as various operations (or actions) performed by the user through the electronic device 101 (e.g., payment, location movement, media playback, media download, recording, web surfing, SNS use, messenger use, taking pictures, visiting places, writing notes, taking pictures/videos, and/or writing messages) and/or configurations made by the user (e.g., account configurations, mobile ID configurations). In one embodiment, the user information may include sensitive information and personal information. The sensitive information may be stored, for example, in the electronic device 101 and/or externally (e.g., a cloud server). Sensitive information may include, for example, content information about content (e.g., photos/videos taken by a camera application, memo content created by a document application, and/or recording content recorded by a recording application), financial information related to the user's financial use, and/or payment information related to the user's payment use. Personal information may be stored, for example, in the electronic device 101 and/or externally (e.g., a cloud server). Personal information may include, for example, account information, mobile ID information, financial information, location information, health information, SNS information, conversation history information, Internet usage history information, music application-related information (e.g., downloaded music, recently played music, user-customized (e.g., frequently played by the user) music), geographic location information, movement path information based on location movement during a specified period (e.g., a day, a week, or a month), and visit information (e.g., information acquired based on a specified location tagged in a map application).

In one embodiment, sensitive information and personal information may be classified for convenience of explanation, and may be managed as user information without classification into sensitive information and personal information. In one embodiment, user information, sensitive information, and/or personal information may be classified in advance by the electronic device 101 and/or an external source (e.g., a cloud server) and stored in the electronic device 101 and/or externally. According to one embodiment, user information, sensitive information, and/or personal information may be classified by the user of the electronic device 101 and stored in the electronic device 101 and/or externally.

In one embodiment, the general information may include information (e.g., generally available information) that is associated with the feature point and may be retrieved externally (e.g., through a web server (or internet server), a social network service, and/or a broadcast service). For example, assuming that the feature point is a feature word related to “place” (e.g., Seoul, the United States, department store A, train station B), the personal information may include information that is accessible based on the access level, and may include data searched (e.g., Seoul search), visited (e.g., Seoul visit history, location, and/or date), photographed (e.g., photographed in Seoul), used (e.g., payment), and/or written (e.g., Seoul entered in a chat room) in association with the place (e.g., Seoul) from user information of the electronic device 101 and/or an external server (e.g., a cloud server). For example, assuming that the feature point is a feature word related to “place,” the general information may include a search result for the place (e.g., Seoul) externally (e.g., a web server, a social network service, and/or a broadcast service). For example, general information may be publicly available for external search and may include common information associated with a location (e.g., Seoul) that all users may access and search (or recognize).

According to one embodiment, the processor 120 may access most of the user information to collect (or extract) data for recommendation information based on determining the access level to the user information as ‘high’. In one embodiment, even when the access level is ‘high’, access to user-specified excluded user information (e.g., categories of user information) may not be permitted. According to one embodiment, the processor 120 may access a part of the user information (e.g., categories of specified user information) to collect (or extract) data for recommendation information based on determining the access level to the user information as ‘medium’. In one embodiment, the processor 120 may restrict (or not permit) access to the user information based on determining the access level to the user information as ‘low’.

According to one embodiment, the processor 120 may collect general information along with user information collection based on an access level. According to one embodiment, the processor 120 may operate to search for information related to a feature point through the electronic device 101 and/or an external server (e.g., a cloud server, an Internet server). For example, the processor 120 may collect data related to a feature point (e.g., location data, time data, dictionary data) from various data stored in the electronic device 101. For example, the processor 120 may provide a feature point (or information related to a feature point) to an external server, request the external server to search for data related to the feature point, and receive search data searched by the external server.

In operation 1015, the processor 120 may perform an operation of generating recommendation information based on linguistic context analysis including feature points and data. In one embodiment, the processor 120 may generate recommendation information having linguistic context (e.g., meaningful to the user) based on data collected from at least a part of user information (e.g., first data) and/or data collected from general information (e.g., second data) through AI. In one embodiment, the processor 120 (or AI) may generate meaningful recommendation information through linguistic context analysis from given data. In one embodiment, the linguistic context analysis may include, for example, an analysis that takes into account the communication situation and the content of preceding and following utterances surrounding a certain utterance (e.g., feature points).

In operation 1017, the processor 120 may perform an operation of providing recommendation information based on an input field. According to one embodiment, the processor 120 may display the recommendation information through an input field of an interactive service. According to one embodiment, the user may input the recommendation information provided through the input field by transmitting (or sharing) the recommendation information into the conversation field, or may input the recommendation information provided by editing (or processing) the recommendation information through user input and then transmitting the edited recommendation information into the conversation field.

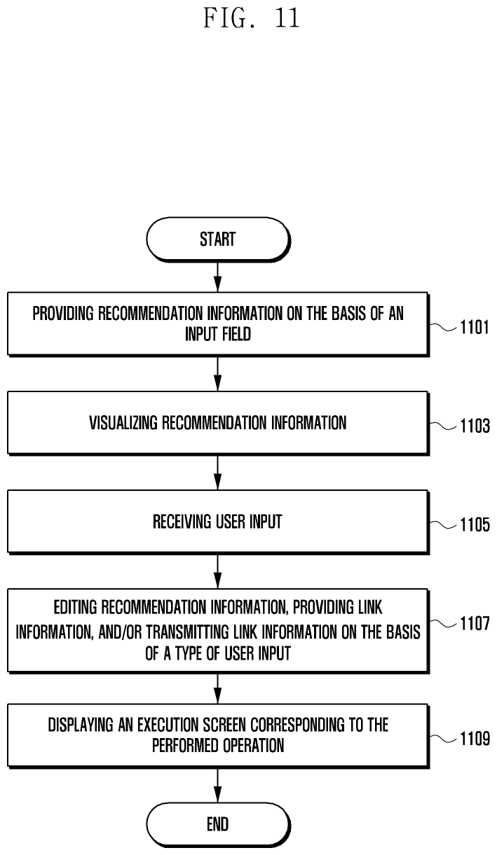

FIG. 11 is a flowchart illustrating an operation method of an electronic device according to an embodiment of the disclosure.

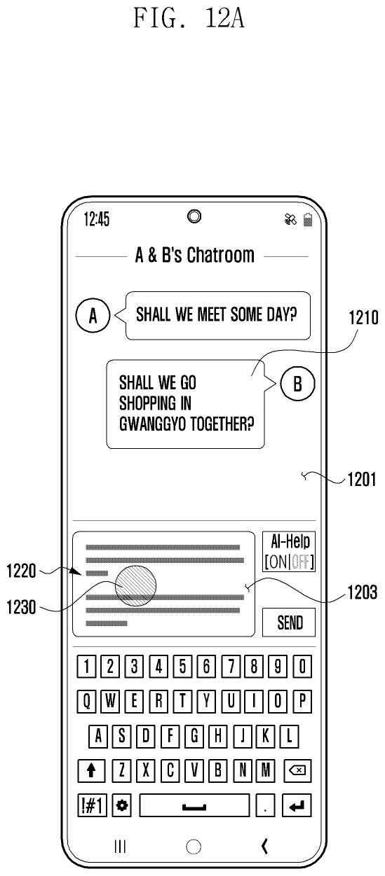

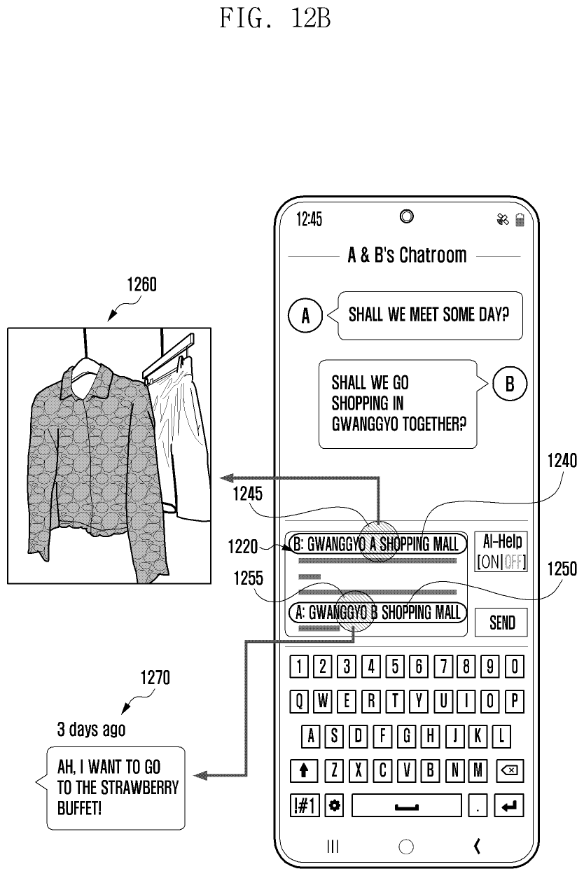

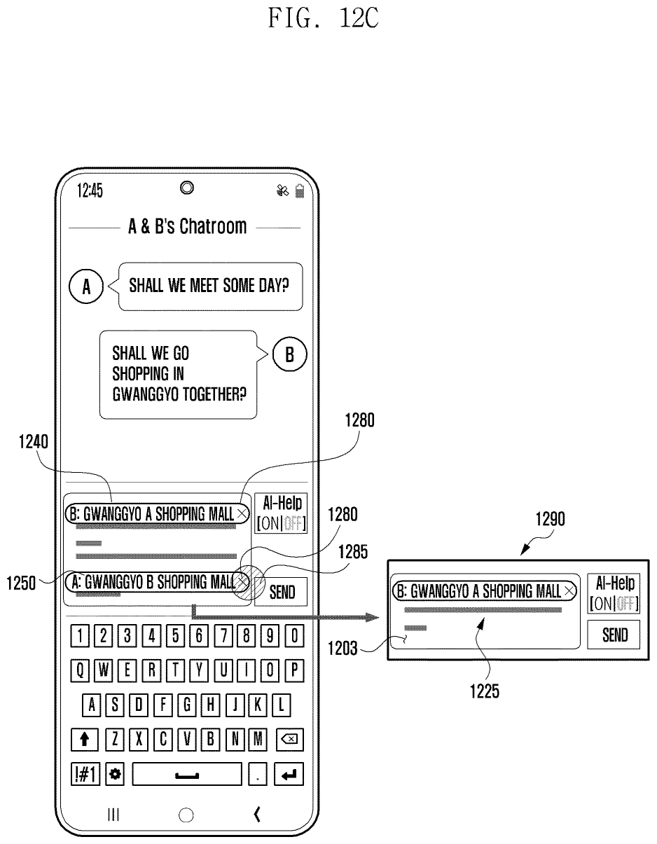

FIGS. 12A, 12B, and 12C are diagrams illustrating various examples of providing recommendation information in an electronic device according to various embodiments of the disclosure.

According to one embodiment, FIG. 11 may illustrate an example of an operation of providing recommendation information (e.g., a recommended answer) through artificial intelligence while executing an interactive service on an electronic device 101. According to one embodiment, FIGS. 12A, 12B, and 12C may illustrate examples of a conversation screen in which an interactive service is performed between a user (e.g., user B) and a counterpart user (e.g., user A).

An operation method supported by an electronic device 101 according to one embodiment of the disclosure may be performed, for example, according to a flowchart illustrated in FIG. 11. The flowchart illustrated in FIG. 11 is an example according to one embodiment of an operation of the electronic device 101, and the order of at least some operations may be changed or performed in parallel, performed as independent operations, or at least some other operations may be performed complementarily to at least some operations. According to one embodiment of the disclosure, operations 1101 to 1109 may be performed by at least one processor of the electronic device 101 (e.g., the processor 120 and 214 of FIGS. 1, 2, or 4).

According to one embodiment, the operations described in FIG. 11 may be heuristically performed in combination with the operations described in FIG. 5 6A to 6C, 7A to 7C, 8A to 8C, 9A, 9B, and 10, for example, or heuristically performed as a replacement for at least some of the operations described and combined with at least some other operations, or heuristically performed as a detailed operation of at least some of the operations described.

Referring to FIG. 11, an operation method performed by an electronic device 101 according to one embodiment may include an operation of providing recommendation information based on an input field (operation 1101), an operation of visualizing recommendation information (operation 1103), an operation of receiving user input (operation 1105), an operation of performing at least one of editing recommendation information, providing link information, and/or transmitting link information based on a type of user input (operation 1107), and an operation of displaying an execution screen corresponding to the performed operation (operation 1109).

Referring to FIGS. 11, 12A, 12B, and 12C, in operation 1101, the processor 120 of the electronic device 101 may perform an operation of providing recommendation information based on an input field. According to one embodiment, as illustrated in FIG. 12A, the processor 120 may provide recommendation information 1220 generated based on AI based on content 1210 provided through a conversation field 1201 of an interactive service through an input field 1203 of the interactive service.

In operation 1103, the processor 120 may perform an operation of visualizing the recommendation information. According to one embodiment, the processor 120 may detect the receipt of a specified user input (e.g., a specified first user input for entering an edit mode) for editing the recommendation information 1220 based on the input field 1203. According to one embodiment, as illustrated in FIG. 12A, the user may input a command for visualizing the recommendation information 1220 (e.g., switching to an edit mode for editing the recommendation information 1220) through a user input 1230 (e.g., a specified touch gesture such as a touch, long touch, double tap, swipe, or flick) for selecting the recommendation information 1220 provided through the input field 1203. According to one embodiment, the processor 120 may determine that the specified user input 1230 is a trigger for editing the recommendation information 1220. For example, the processor 120 may determine that the user has entered an edit mode for visualizing recommendation information 1220 based on a specified user input 1230, and may switch the input mode of the interactive service to the edit mode.

In one embodiment, the edit mode may represent a mode in which the recommendation information 1220 of the input field 1203 may be edited (or processed) based on a user input 1230 (e.g., a second user input related to editing). According to one embodiment, the processor 120 may perform a context analysis of the recommendation information 1220 of the input field 1203 when entering the edit mode. For example, the processor 120 may provide a visualization (e.g., a conversion into specified visual information) of a portion related to a feature point (e.g., a feature word such as a meaningful word and/or a user-specified word of interest) in the recommendation information 1220 based on the context analysis based on the recommendation information 1220. For example, the visualization may include presenting a feature point by transforming the feature point (e.g., highlighting the feature point with a bubble associated with the feature word) by applying (or implementing) various visual elements such as images, diagrams, animations, infographics, word clouds, colors, and/or links based on at least a part of the feature point to convey information about the feature point to the user. For example, the visualization may be provided based on at least one visual element (e.g., a visual image). An example of this is illustrated in FIG. 12B or 12C.

Referring to FIGS. 12Bb or 12C, the processor 120 may detect features (e.g., features such as “Gwanggyo a shopping mall”, “Gwanggyo b shopping mall”) related to a user and/or a counterpart user from the recommendation information 1220 through AI. In one embodiment, the features in FIG. 12B or 12C may include features (e.g., meaningful words and/or user-specified words of interest) analyzed according to word or context analysis within the recommendation information 1220. For example, in the examples of FIGS. 12B or 12C, the features may be “Gwanggyo” indicating a place and “shopping” indicating an action. In one embodiment, if the recommendation information 1220 includes words indicating a date and/or time, the features may further include the date and/or time.

According to one embodiment, the processor 120 may detect a feature point from the recommendation information 1220 of the input field 1203, visualize a portion corresponding to the feature point, and provide corresponding visual information (e.g., first visual information 1240 (or first bubble), second visual information 1250 (or second bubble)) according to the visualization. According to one embodiment, the processor 120 may provide visual information 1240 and 1250 by distinguishing a portion for a user (e.g., a user of the electronic device 101) and a portion for a counterpart user. For example, as illustrated in FIGS. 12B or 12C, in association with a first feature point related to a user, an identifier (e.g., “B”) indicating that the first feature point is based on the user's content may be displayed together with the first visual information 1240, such as in the form “B: Gwanggyo a Shopping Mall”. For example, as illustrated in FIGS. 12B or 12C, in association with a second feature point related to a counterpart user, an identifier (e.g., “A”) indicating that the second feature point is based on the counterpart user's content may be displayed together with the second visual information 1250, such as in the form “A: Gwanggyo b Shopping Mall”.

In operation 1105, the processor 120 may perform an operation of receiving a user input. According to one embodiment, the processor 120 may detect the receipt of a user input (e.g., a second user input related to editing) based on visual information 1240 and 1250. According to one embodiment, as illustrated in FIG. 12B, the user may perform a user input 1245 and 1255 (e.g., a specified touch gesture such as a touch) to select the first visual information 1240 or the second visual information 1250 from the recommendation information 1220. According to one embodiment, as illustrated in FIG. 12C, the user may perform a user input 1285 (e.g., a specified touch gesture such as a touch) to select a removal item 1280 included in the first visual information 1240 or the second visual information 1250 from the recommendation information 1220. According to one embodiment, the user input may include various inputs each corresponding to editing of the recommendation information 1220 as described above. According to one embodiment, the user input may include, in addition to inputs related to editing, an input for transmitting the recommendation information 1220 (or edited (or processed) recommendation information 1225) (e.g., a ‘send button’ selection input).

In operation 1107, the processor 120 may perform at least one of editing recommendation information, providing link information, and/or transmitting recommendation information based on the type of user input. According to one embodiment, the processor 120 may perform an operation of editing (e.g., removing) a feature point based on visual information 1240 and 1250 of recommendation information 1220, providing (e.g., displaying) link information linked to visual information 1240 and 1250, or removing visual information 1240 and 1250 from recommendation information 1220 and transmitting original recommendation information 1220 or edited recommendation information 1225, based on the user input.

According to one embodiment, the visual information 1240 and 1250 may include a link related to the corresponding feature point. According to one embodiment, referring to FIGS. 12B or 12C, the first visual information 1240 may include first link information related to the feature point (e.g., information such as a photo taken by user “B” at a location related to the feature word, or an SNS on which the photo was posted). According to one embodiment, the second visual information 1250 may include second link information related to the feature point (e.g., information such as a previous conversation history of user “A” that includes data (e.g., content) related to the feature word, or an SNS on which user “A” recently posted related to the feature word). According to one embodiment, the processor 120 may determine (e.g., extract) a link included in the visual information 1240 and 1250 based on a user input selecting the visual information 1240 and 1250. According to one embodiment, the processor 120 may perform an operation of calling and providing link information related to the link based on the determined link.

According to one embodiment, the visual information 1240 and 1250 may include a removal item 1280. According to one embodiment, referring to FIG. 12C, the first visual information 1240 and the second visual information 1250 may include a removal item 1280 that may remove (e.g., exclude from the recommendation information 1220) data of the corresponding visual information (e.g., data of a feature word related to a target of the visual information (e.g., a user or a counterpart user)) and associated data (or remaining data (or content)) of the corresponding visual information (e.g., recommendation information generated from content of the target of the visual information). According to one embodiment, the processor 120 may determine (e.g., extract) a removal target (e.g., data related to a feature point and associated data) based on the visual information 1240 and 1250 based on a user input selecting a removal item 1280 of the visual information 1240 and 1250. According to one embodiment, the processor 120 may perform an operation of editing (or reorganizing) the recommendation information 1220 (e.g., removing (or deleting) the removal target from the recommendation information 1220) based on the determined removal target.

In operation 1109, the processor 120 may perform an operation of displaying an execution screen corresponding to the operation performed. According to one embodiment, the processor 120 may control the display to display an execution screen corresponding to the operation performed based on user input (e.g., editing recommendation information, providing and/or transmitting link information). According to one embodiment, the processor 120 may provide a result corresponding to the operation performed on an execution screen of an interactive service (e.g., a conversation screen). An example of this is illustrated in FIGS. 12B or 12C.

Referring to FIG. 12B, in response to a user input 1245 selecting the first visual information 1240, the processor 120 may provide first link information 1260 linked to the first visual information 1240 as a pop-up window on the conversation screen. For example, based on the user input 1245, the processor 120 may provide corresponding link information, such as a photo taken by user “B” at a location related to the feature word (e.g., “Gwanggyo a Shopping Mall”) or an SNS post in which the photo was uploaded, through a pop-up window on an area of the conversation screen.

Referring to FIG. 12B, in response to a user input 1255 selecting second visual information 1250, second link information 1270 linked to the second visual information 1250 may be provided as a pop-up window on the conversation screen. For example, the processor 120 may provide corresponding link information, such as a previous conversation history of user “A” related to the feature word and/or a recent SNS post by user “A,” in an area of the conversation screen through a pop-up window based on the user input 1255. For example, the second link information 1270 may be a conversation history related to an action performed by user “A” at a place related to the feature word (e.g., “Gwanggyo”) three days ago.

Referring to FIG. 12C, in response to a user input 1285 selecting a removal item 1280 of the second visual information 1250, data of the second visual information 1250 (e.g., data of a feature word related to user “A”) and associated data (or remaining data) of the second visual information 1250 may be removed (e.g., excluded from the recommendation information 1220) from the recommendation information 1220. For example, the processor 120 may perform an operation of removing the second visual information 1250 and associated data, and editing (or processing or reconstructing) the recommendation information 1220, based on a user input 1285 selecting a removal item 1280 of the second visual information 1250. According to one embodiment, the processor 120 may replace the original recommendation information 1220 with edited (or processed) recommendation information 1225 and provide it to the input field 1203, as illustrated in element 1290. For example, the edited recommendation information 1225 may exclude content related to user “A” and include only content related to user “B”.

According to one embodiment, while one embodiment is described with respect to editing of recommendation information in FIGS. 12A, 12B, and 12C, the disclosure is not limited thereto. For example, the electronic device 101 may support various editing operations, such as adjusting the amount of information in recommendation information based on user input, adding objects (e.g., text, icons, images, and/or videos) to the recommendation information according to user input, or deleting or modifying objects (e.g., phrases) specified in the recommendation information.

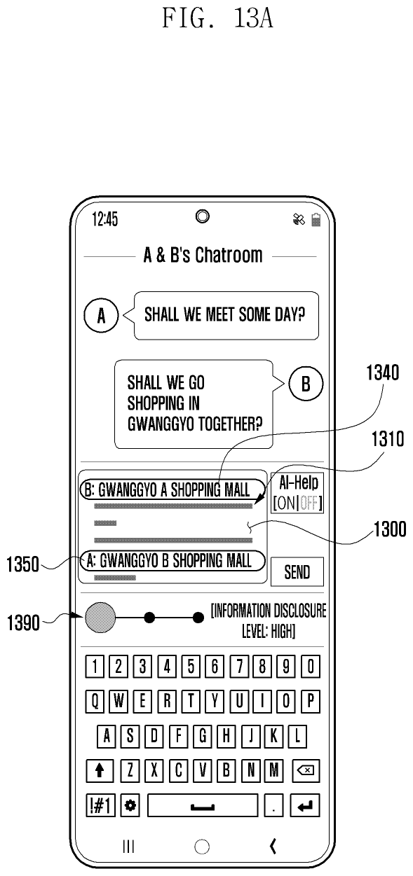

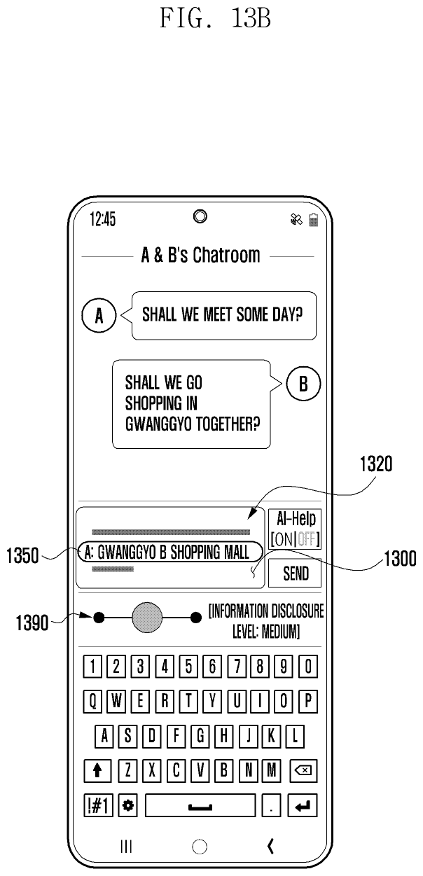

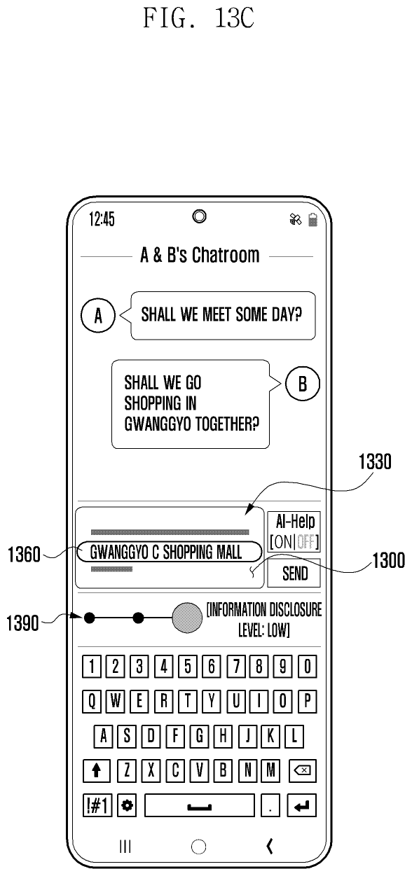

FIGS. 13A, 13B, and 13C are diagrams illustrating various examples of providing recommendation information in an electronic device according to various embodiments of the disclosure.

According to one embodiment, FIGS. 13A, 13B, and 13C may illustrate examples of conversation screens in which an interactive service is performed between a user (e.g., user B) and a counterpart user (e.g., user A). According to one embodiment, FIGS. 13A, 13B, and 13C may illustrate examples in which the amount of recommendation information provided varies based on the user's level of access to information (e.g., accessible source information).

Referring to FIGS. 13A, 13B, and 13C, the electronic device 101 may provide recommendation information by configuring the amount of information differently according to the access level to the user information based on the relationship information. In one embodiment, the user information may include sensitive information (e.g., photo information, financial information, payment information) and personal information (e.g., account information, mobile ID information, financial information, location information, health information, SNS information, conversation history information) that are associated with the feature point and directly related to the user. In one embodiment, the access level may include the degree of authority (or permission) to access the user information for configuring the recommendation information, and may be classified as, for example, high, medium, and low. In one embodiment, the classification of the access level is and is not limited thereto, and may be configured in various ways, such as in more detailed steps.

According to one embodiment, when the relationship information is ‘high’, the electronic device 101 may determine the access level to the user information as ‘high’ and may access most of the user information to collect (or extract) data for recommendation information. In one embodiment, even when the access level is ‘high’, access to user-specified excluded user information (e.g., categories of user information) may not be permitted. According to one embodiment, when the relationship information is ‘medium’, the electronic device 101 may determine the access level to the user information as ‘medium’ and may access a part of the user information (e.g., categories of specified user information) to collect (or extract) data for recommendation information. According to one embodiment, when the relationship information is ‘low’, the electronic device 101 may determine the access level to the user information as ‘low’ and may restrict (or not permit) access to the user information.

According to one embodiment, the electronic device 101 may collect at least a part of user information based on an access level (e.g., high, medium, or low). According to one embodiment, the electronic device 101 may collect general information along with the user information collected based on the access level. In one embodiment, the general information may include information that is associated with a feature point and is generally public. According to one embodiment, the electronic device 101 may acquire at least a part of user information and/or general information based on the access level, and generate recommendation information based on the acquired information.

According to one embodiment, the electronic device 101 may search and collect information related to a feature point through the memory 130 of the electronic device 101 and/or an external server (e.g., a cloud server, an Internet server). For example, the electronic device 101 may collect data related to the feature point (e.g., location data, time data, dictionary data) from various data stored in the memory 130. For example, the electronic device 101 may provide the feature point (or information related to the feature point) to an external server, request the external server to search for data related to the feature point, and receive the search data searched by the external server.

According to one embodiment, the electronic device 101 may generate (e.g., infer) recommendation information related to a feature point based on acquired information (e.g., user information and/or general information). According to one embodiment, the electronic device 101 may generate recommendation information having a linguistic context based on data collected from at least a part of the user information (e.g., first data) and/or data collected from the general information (e.g., second data) through AI (e.g., generative AI). According to one embodiment, the electronic device 101 may generate recommendation information 1310, 1320, and 1330 through linguistic context analysis from given data according to an access level. In one embodiment, the linguistic context analysis may include, for example, an analysis that takes into account the communication situation and the content of preceding and following utterances surrounding a certain utterance (e.g., feature point).

According to one embodiment, the electronic device 101 may provide recommendation information 1310, 1320, and 1330 through an input field 1300 of an interactive service. According to one embodiment, the electronic device 101 may provide information about an information disclosure level according to an access level (e.g., information about high, medium, or low) by visualizing it (e.g., adding a visual element 1390 based on text and a level (or information amount) adjustment object). For example, the visual element 1390 about the information disclosure level may be provided in association with the input field 1300 (e.g., in a lower adjacent area of the input field 1300). According to one embodiment, the electronic device 101 may adjust the amount of information in the recommendation information 1310, 1320, and 1330 based on a user input (e.g., a touch gesture such as a swipe for adjusting the level (or amount of information)) using a visual element 1390, and reconfigure and provide the recommendation information based on the adjusted amount of information. For example, the user may adjust the amount of information in the recommendation information 1310, 1320, and 1330 by adjusting the level based on the visual element 1390.

According to one embodiment, FIG. 13A may illustrate an example of providing recommendation information 1310 to an input field 1300 when the access level for user information is “high”. Referring to FIG. 13A, the electronic device 101 may access most of the user information and construct and provide recommendation information 1310 from the collected data. According to one embodiment, when the access level is “high,” a relatively large amount of information may be included. According to one embodiment, the electronic device 101 may visualize a portion corresponding to a feature point in the recommendation information 1310 and convert and provide visual elements according to the visualization (e.g., first visual information 1340 and second visual information 1350). According to one embodiment, the visual elements 1340 and 1350 may be provided differently for each user participating in the interactive service. According to one embodiment, the visual elements may not be provided in the recommendation information 1310.

According to one embodiment, the electronic device 101 may provide the user with an indication through a visual element 1390 that the information disclosure level according to the access level in association with the input field 1300 corresponds to “high”. For example, the electronic device 101 may display a level adjustment object (e.g., an emphasis point at the first point (e.g., a large circle)) and guide text (“Information disclosure level: high”) indicating that the information disclosure level is “high” as the visual element 1390. According to one embodiment, the user may adjust the amount of information of the recommendation information 1310 displayed in the input field 1300 by moving the emphasis point of the level adjustment object of the visual element 1390 (e.g., changing the information disclosure level by moving it to the right). For example, when the user moves the emphasis point to the “medium” level on the right, the amount of information of the recommendation information 1310 may be changed, such as in the recommendation information 1320 of FIG. 13B which is configured based on data corresponding to the “medium” level of access. For example, if the user moves the emphasis to the “low” level on the right, the amount of information in the recommendation information 1310 may be changed, such as in the recommendation information 1330 of FIG. 13C which is configured based on data corresponding to the “low” level of access.

According to one embodiment, FIG. 13B may illustrate an example of providing recommendation information 1320 to an input field 1300 when the access level for user information is “medium”. As illustrated in FIG. 13B, the electronic device 101 may access a part of the user information (e.g., data related to a previous conversation history with the counterpart user, excluding the user's personal information) and provide the recommendation information 1320 by configuring the collected data. According to one embodiment, when the access level is “medium,” a relatively medium amount of information may be included. According to one embodiment, the electronic device 101 may visualize a portion corresponding to a feature point in the recommendation information 1320, convert it into a visual element (e.g., second visual information 1350) according to the visualization, and provide it. According to one embodiment, the recommendation information 1320 may not provide a visual element.

According to one embodiment, the electronic device 101 may provide the user with an indication through a visual element 1390 that the information disclosure level according to the access level associated with the input field 1300 corresponds to “medium”. For example, the electronic device 101 may display a level adjustment object (e.g., an emphasis point at the second point (e.g., a large circle)) and guide text (“Information disclosure level: medium”) indicating that the information disclosure level is “medium” as the visual element 1390. According to one embodiment, the user may adjust the amount of information of the recommendation information 1320 displayed in the input field 1300 by moving the emphasis point of the level adjustment object of the visual element 1390 (e.g., changing the information disclosure level by moving it to the left or right). For example, when a user moves the emphasis point to the “high” level on the left, the amount of information in the recommendation information 1320 may change, such as in the recommendation information 1310 of FIG. 13A which is constructed based on data corresponding to the “high” level of access. For example, when a user moves the emphasis point to the “low” level on the right, the amount of information in the recommendation information 1320 may change, such as in the recommendation information 1330 of FIG. 13C which is constructed based on data corresponding to the “low” level of access.

According to one embodiment, FIG. 13C may illustrate an example of providing recommendation information 1330 to an input field 1300 when the access level for user information is “low”. As illustrated in FIG. 13C, the electronic device 101 may configure and provide recommendation information 1330 from data collected from general information, excluding user information. According to one embodiment, when the access level is “low,” a relatively small amount of information may be included. According to one embodiment, the electronic device 101 may visualize a portion corresponding to a feature point in the recommendation information 1330, and convert and provide a visual element (e.g., third visual information 1360) according to the visualization. According to one embodiment, the third visual element 1360 may be distinguished from a visual element related to user information (e.g., first visual information 1340 and/or second visual information 1350), and may provide to the user that the third visual element 1360 is based on general information. For example, the electronic device 101 may provide visual elements 1340 and 1350 based on user information and visual elements 1360 based on general information differently (e.g., shape distinction, color distinction, and/or highlighting distinction). In one embodiment, visual elements may not be provided in the recommendation information 1330.

According to one embodiment, the electronic device 101 may provide the user with an indication through a visual element 1390 that the information disclosure level according to the access level in association with the input field 1300 corresponds to “low”. For example, the electronic device 101 may display a level adjustment object (e.g., an emphasis point at the third point (e.g., a large circle)) and guide text (“Information disclosure level: low”) indicating that the information disclosure level is “low” as the visual element 1390. According to one embodiment, the user may adjust the amount of information of the recommendation information 1330 displayed in the input field 1300 by moving the emphasis point of the level adjustment object of the visual element 1390 (e.g., changing the information disclosure level by moving it to the left). For example, when the user moves the emphasis point to the “medium” level on the left, the amount of information of the recommendation information 1330 may be changed, such as in the recommendation information 1320 of FIG. 13B which is configured based on data corresponding to the “medium” level of access. For example, when a user moves the emphasis to the “high” level on the left, the amount of information in the recommendation information 1330 may be changed, such as in the recommendation information 1310 of FIG. 13A which is configured based on data corresponding to the “high” level of access.

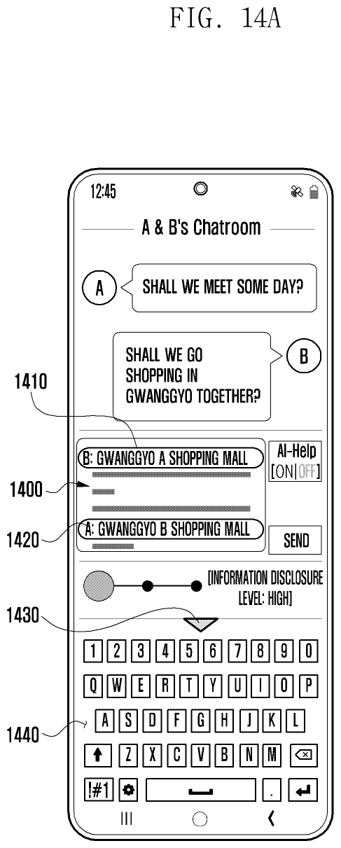

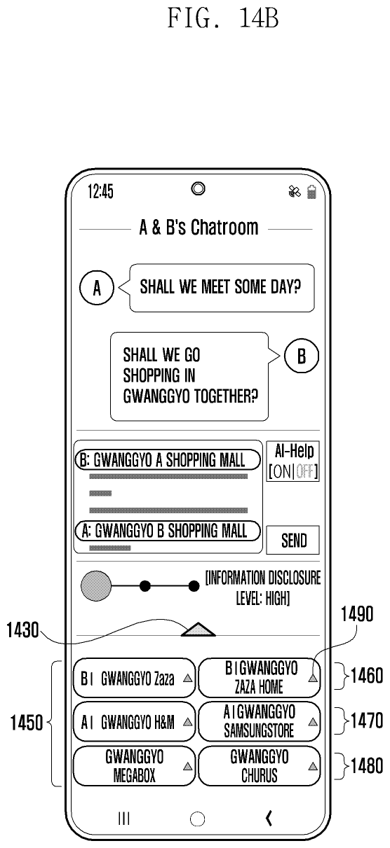

FIGS. 14A and 14B are diagrams illustrating various examples of providing recommendation information in an electronic device according to various embodiments of the disclosure.

According to one embodiment, FIGS. 14A and 14B illustrate examples of providing visual elements (e.g., bubbles) based on feature words in recommendation information, and providing candidate information that may replace information (e.g., feature word portions) highlighted by the visual elements based on user input regarding the visual elements. For example, the electronic device 101 may support a user to select candidate information and quickly and easily modify feature word-based information associated with the visual element with other information.

According to one embodiment, FIG. 14A may illustrate an example of a conversation screen displaying recommendation information 1400 based on an input field. According to one embodiment, the recommendation information 1400 may include a first visual element 1410 and a second visual element 1420 visualized in association with a feature word, as exemplified above. According to one embodiment, the first visual element 1410 and the second visual element 1420 may be implemented in the form of a bubble containing information (or content) related to the feature word.

According to one embodiment, the electronic device 101 may provide other information that is not included in the recommendation information 1400 but may be used as content of the recommendation information 1400 based on a user input specified in the recommendation information 1400. For example, the electronic device 101 may provide candidate information that is related to information (e.g., a portion related to the feature word) of a visual element (e.g., a first visual element 1410, a second visual element 1420) associated with a feature word and that may replace the information of the visual elements 1410 and 1420.

Referring to FIG. 14A, a user may perform a user input (e.g., a touch gesture such as a long press) specified for one of the visual elements 1410 and 1420. According to one embodiment, the electronic device 101 may provide a transition object 1430 that may call up and display a list (e.g., a candidate list) containing candidate information in response to the specified user input. For example, the transition object 1430 may be provided in association with an input field or a keyboard 1440. According to one embodiment, FIG. 14A illustrates an example in which the transition object 1430 is provided as an object of a specified shape (e.g., a triangle icon) through a portion of an upper edge of the keyboard 1440 in association with the keyboard 1440.

Referring to FIGS. 14A and 14B, the transition object 1430 may include an object having a directionality that indicates a direction based on a switching target (e.g., a keyboard 1440 or a list 1450). For example, if the switching target is switching from a keyboard 1440 to a list 1450, the transition object 1430 may be provided as an inverted triangle icon to indicate to the user (e.g., a swipe downward) that the area of the keyboard 1440 may be switched to an area of the list 1450 (e.g., an information change area). For example, if the switching target is switching from a list 1450 to a keyboard 1440, the transition object 1430 may be provided as a triangle icon to indicate to the user (e.g., a swipe upward) that the area of the list 1450 may be switched to an area of the keyboard 1440. According to one embodiment, the transition object 1430 may be provided as a specified polygonal shape object (e.g., a circular icon, a square icon, a pentagonal icon, or a star icon) that does not have a direction. According to one embodiment, the transition object 1430 may support switching between the keyboard 1440 and the list 1450 by a touch gesture, such as a swipe moving in a specified direction. According to one embodiment, the transition object 1430 may also support switching between the keyboard 1440 and the list 1450 by a touch gesture, such as a touch.

According to one embodiment, a user may perform a specified user input (e.g., a touch gesture such as a swipe or touch) based on a transition object 1430. According to one embodiment, when the electronic device 101 detects the specified user input through the transition object 1430, the electronic device 101 may switch the keyboard 1440 to a list 1450 including at least one piece of candidate information and provide it. According to one embodiment, the transition object 1430 may change from a first icon (e.g., an inverted triangle icon) indicating a first direction of FIG. 14A to a second icon (e.g., a triangle icon) indicating a second direction opposite to the first direction in response to the switching between the keyboard 1440 and the list 1450. According to one embodiment, an area of the list 1450 may be provided to replace an area of the keyboard 1440, or may be provided through an area between an input field and the keyboard 1440.

According to one embodiment, the electronic device 101 may generate candidate information that may replace information of the visual elements 1410 and 1420 by using source information (e.g., user information and/or general information) associated with the feature word based on a specified user input based on the transition object 1430.

Referring to FIG. 14B, the list 1450 may include various candidate information (e.g., first candidate information 1460, second candidate information 1470, third candidate information 1480) that correspond to information of visual elements 1410 and 1420 associated with feature words (e.g., feature word-related portions), and may replace the information of the visual elements 1410 and 1420. In one embodiment, the candidate information 1460, 1470, and 1480 of the list 1450 may all be displayed in correspondence with users participating in the interactive service (e.g., user “A” and user “B”) and/or the visual elements 1410 and 1420. For example, the first candidate information 1460 may include items that may be utilized by replacing the information of the first visual element 1410. For example, the second candidate information 1470 may include items that may be used to replace the information of the second visual element 1420. For example, the third candidate information 1480 may include items related to general information that may be used to replace the information of the first visual element 1410 and/or the second visual element 1420.

According to one embodiment, candidate information 1460, 1470, and 1480 may include an execution object 1490 that may input a command for replacing information, as illustrated in execution object 1490. For example, a user may select an execution object 1490 of candidate information to be replaced among candidate information 1460, 1470, and 1480 to modify the corresponding information in the recommendation information 1400 by replacing it with the candidate information. According to one embodiment, the electronic device 101 may replace information of corresponding visual elements 1410 and 1420 in the recommendation information 1400 according to the candidate information for which the execution object 1490 is selected. For example, in response to a user input based on the execution object 1490 of the first candidate information 1460, information of the first visual element 1410 may be replaced with the corresponding candidate information. For example, in response to a user input based on an execution object 1490 of the second candidate information 1470, information of the second visual element 1420 may be replaced with the corresponding candidate information. According to one embodiment, when a part of the recommendation information 1400 is replaced with candidate information 1460, 1470, and 1480, the phrase of the recommendation information 1400 may be automatically and naturally corrected based on the content and context of the candidate information.

According to one embodiment, although not illustrated in FIG. 14B, the list may also provide guidance information regarding the source (e.g., target user and/or source information) associated with each candidate information 1460, 1470, and 1480. For example, guidance information regarding the information source associated with each candidate information 1460, 1470, and 1480 may be provided in the lower area of each candidate information. For example, the electronic device 101 may provide guidance regarding the first candidate information 1460 by indicating that the first candidate information 1460 is recommended based on “User B's payment history”. For example, the electronic device 101 may provide guidance regarding the second candidate information 1470 by indicating that the second candidate information 1470 is recommended based on “User A's conversation history”. For example, the electronic device 101 may, in association with the third candidate information 1480, inform that the third candidate information 1480 is recommended based on “general information related to the feature word (e.g., movie ranking, genre of interest, real-time trend)”.

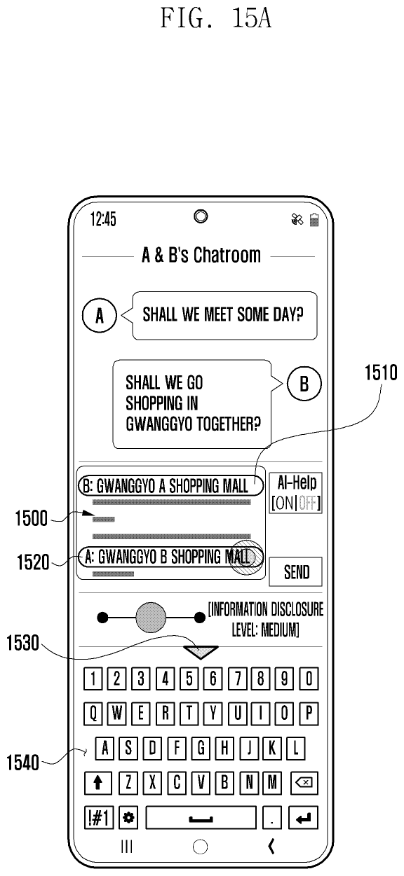

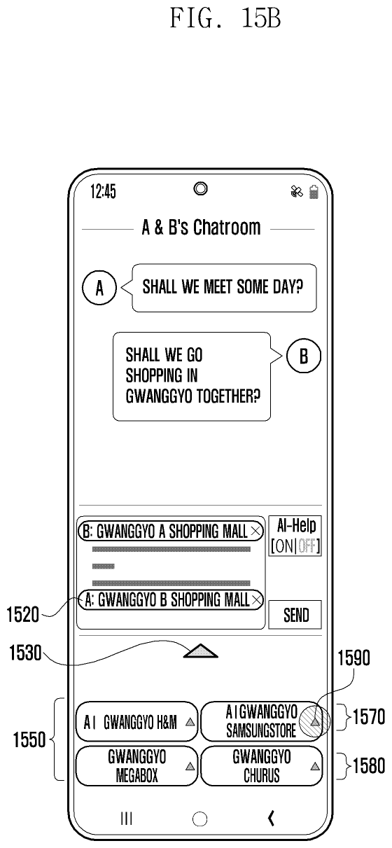

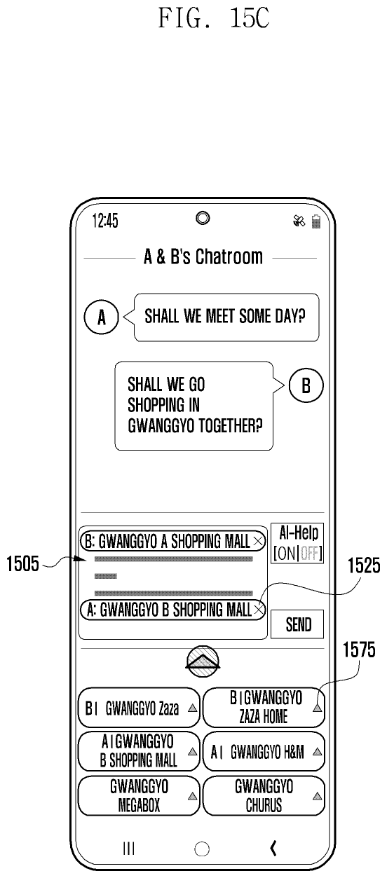

FIGS. 15A, 15B, and 15C are diagrams illustrating various examples of providing recommendation information in an electronic device according to various embodiments of the disclosure.

According to one embodiment, FIGS. 15A, 15B, and 15C illustrate examples of providing visual elements (e.g., bubbles) based on feature words in recommendation information, and providing candidate information that may replace information (e.g., feature word portions) highlighted by the visual elements based on user input regarding the visual elements. For example, the electronic device 101 may support a user to select candidate information and easily and quickly modify feature word-based information associated with the visual element with other information.

According to one embodiment, FIG. 15A may illustrate an example of a conversation screen displaying recommendation information 1500 based on an input field. According to one embodiment, the recommendation information 1500 may include a first visual element 1510 and a second visual element 1520 visualized in association with a feature word, as exemplified above. According to one embodiment, the first visual element 1510 and the second visual element 1520 may be implemented in the form of a bubble containing information (or content) related to the feature word.

According to one embodiment, the electronic device 101 may provide other information that is not included in the recommendation information 1500 but may be used as content of the recommendation information 1500 based on a user input specified in the recommendation information 1500. For example, the electronic device 101 may provide candidate information that is related to information (e.g., a portion related to the feature word) of a visual element (e.g., a first visual element 1510, a second visual element 1520) associated with a feature word and that may replace the information of the visual elements 1510 and 1520.

Referring to FIG. 15A, a user may perform a user input (e.g., a touch gesture such as a long press) specified for one of the visual elements 1510 and 1520 (e.g., a second visual element 1520). In one embodiment, the electronic device 101 may, in response to the specified user input, provide a list 1550 (e.g., a candidate list) including candidate information related to the second visual element 1520, as illustrated in FIG. 15B. In one embodiment, the electronic device 101 may, in response to the specified user input, provide a transition object 1530 associated with a keyboard 1540.

According to one embodiment, when the electronic device 101 detects a specified user input, the electronic device 101 may provide a list 1550 including at least one candidate information by switching the keyboard 1540. According to one embodiment, an area of the list 1550 (e.g., an information change area) may be provided to replace an area of the keyboard 1540 or may be provided through an area between the input field and the keyboard 1540. According to one embodiment, the electronic device 101 may generate candidate information that may replace information of the second visual element 1520 based on a specified user input based on the second visual element 1520.

Referring to FIG. 15B, the list 1550 may include various candidate information (e.g., first candidate information 1570, second candidate information 1580) that correspond to information of the second visual element 1520 (e.g., a feature word-related portion) and may replace the information of the second visual element 1520. In one embodiment, the candidate information 1570 and 1580 of the list 1550 may display candidate information related to the second visual element 1520 (or a user associated with the second visual element 1520) selected according to a specified user input. For example, the first candidate information 1570 may include items that may be utilized by replacing the information of the second visual element 1520. For example, the second candidate information 1580 may include items related to general information that may be utilized by replacing the information of the second visual element 1520.

According to one embodiment, the candidate information 1570 and 1580 may include an execution object 1590 that may input a command for replacing information, as illustrated in execution object 1590. For example, a user may select an execution object 1590 of candidate information to be replaced among candidate information 1570 and 1580 to modify the corresponding information in the recommendation information 1500 by replacing it with the candidate information. According to one embodiment, the electronic device 101 may replace the information of the corresponding second visual element 1520 in the recommendation information 1500 according to the candidate information for which the execution object 1590 is selected. For example, in response to a user input based on the execution object 1590 of the first candidate information 1570, the information (or content) of the second visual element 1520 may be replaced with the corresponding candidate information. According to one embodiment, when a part of the recommendation information 1500 (e.g., information of the second visual element 1520) is replaced with candidate information 1570 and 1580, the phrase of the recommendation information 1500 may be naturally and automatically corrected based on the content and context of the candidate information. For example, assuming that the information of the second visual element 1520 is “Gwanggyo b shopping mall” and the recommendation information 1500 including it is “I heard that the newly opened Gwanggyo b shopping mall is good because there are a lot of good restaurants”, it may be assumed that the candidate information is “Gwanggyo Samsung Store”. In this case, the electronic device 101 may correct the content of the recommendation information 1500 (e.g., the content of the second visual element 1520 and the preceding and following utterances) through AI to something like “Let's stop by the Gwanggyo Samsung Store to check out the new cell phone”.

Referring to FIG. 15C, the second visual element 1520 of the recommendation information 1500 may be replaced with a third visual element 1525 including the selected candidate information, and the context before and after the third visual element 1525 may be modified and provided as corrected recommendation information 1505 based on the candidate information. According to one embodiment, the electronic device 101 may also provide other candidate information 1575 that may be replaced in the corresponding portion, excluding the candidate information selected from the list 1550.

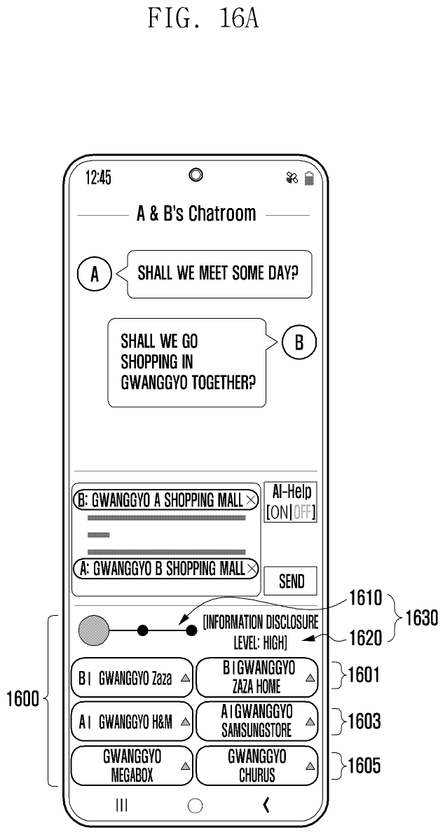

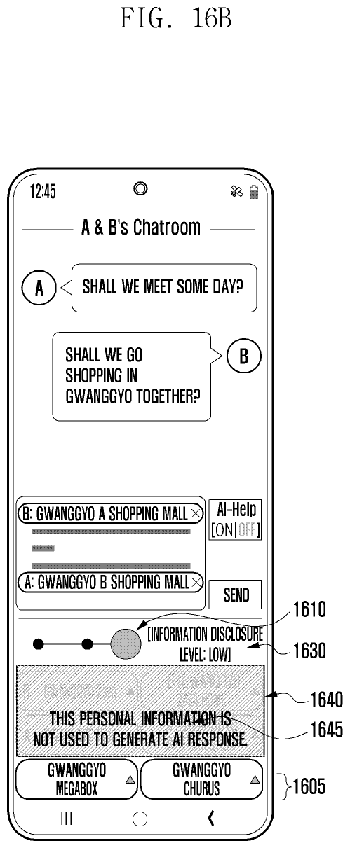

FIGS. 16A and 16B are diagrams illustrating various examples of providing recommendation information in an electronic device according to various embodiments of the disclosure.

According to one embodiment, FIGS. 16A and 16B may illustrate examples of providing candidate information differently based on an information disclosure level for user information.

Referring to FIGS. 16A and 16B, a list 1600 may be provided including a visual element 1630 including an adjustment object 1610 and guide text 1620 for adjusting an information disclosure level together with at least one candidate information 1601, 1603, and 1605. For example, the visual element 1630 may be provided through an area specified in association with the candidate information 1601, 1603, and 1605 within an area of the list 1600 (e.g., a top area of the candidate information 1601, 1603, and 1605). According to one embodiment, the electronic device 101 may support a user to adjust an information disclosure level (e.g., high, medium, or low) related to the candidate information 1601, 1603, and 1605 based on the visual element 1630.

According to one embodiment, the electronic device 101 may determine the disclosure level of candidate information 1601, 1603, and 1605 in the list 1600 based on a user input (e.g., a touch gesture such as a swipe for adjusting the level) using a visual element 1630 (e.g., an adjustment object 1610), and may adjust and provide display information (e.g., the amount of information) of the candidate information 1601, 1603, and 1605 based on the determined disclosure level. For example, the electronic device 101 may hide (e.g., dim) some of the candidate information 1601, 1603, and 1605 through level adjustment according to a user input based on the visual element 1630, thereby visually indicating that the hidden candidate information corresponds to the user information.

According to one embodiment, FIG. 16A may illustrate an example of providing (e.g., displaying) all candidate information 1601, 1603, and 1605 in a list 1600 when the information disclosure level is “high”. As illustrated in FIG. 16A, the electronic device 101 may display all candidate information 1601, 1603, and 1605 in the list 1600 without hiding them.

According to one embodiment, FIG. 16B may illustrate an example of providing candidate information 1601, 1603, and 1605 from a list 1600 when the information disclosure level is “low”. As illustrated in FIG. 16B, the electronic device 101 may visually obscure some candidate information 1601 and 1603 (e.g., candidate information related to user information) among the candidate information 1601, 1603, and 1605 from the list 1600 through a visualization (e.g., hiding processing), thereby making some candidate information 1601 and 1603 invisible to the user. According to one embodiment, the electronic device 101 may provide an effect of hiding some areas of candidate information 1601 and 1603 related to user information by overlapping a shading filter 1640 (or layer) based on the “low” level of information disclosure. According to one embodiment, the electronic device 101 may also provide a related guide 1645 (e.g., a message such as “This personal information will not be used to generate AI answers”) together with the effect of hiding some of the candidate information 1601 and 1603 based on the shading filter 1640.

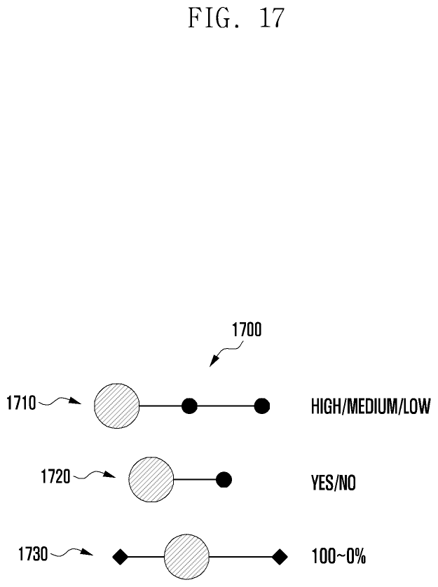

FIG. 17 is a diagram illustrating an example of an adjustment object that supports adjustment of an information disclosure level in an electronic device according to an embodiment of the disclosure.

According to one embodiment, FIG. 17 illustrates various implementation examples of an adjustment object 1700 for supporting adjustment of an information disclosure level in an electronic device 101 and various examples of utilizing the adjustment object 1700. According to one embodiment, the adjustment object 1700 may be used to adjust the disclosure level of display information (e.g., information amount) related to recommendation information and/or candidate information.

Referring to FIG. 17, the adjustment object 1700 for supporting adjustment of the information disclosure level may be implemented in various ways, such as a first object 1710 divided into three levels such as ‘high/medium/low’ (or ‘upper/middle/low’), a second object 1720 divided into two levels such as ‘yes/no’, or a third object 1730 divided into a ratio (or percentage). In one embodiment, the illustrated form of the adjustment object 1700 is and is not limited thereto, and may be configured in various ways, such as an object that distinguishes more levels (e.g., very high, high, medium, low, very low).

According to one embodiment, the information that may be adjusted based on the adjustment object 1700 may vary. For example, the adjustment object 1700 may be designed to specify the degree of AI intervention to implement configurations and/or restrictions related to information, such as the extent of information disclosure, the format of the information, or whether the information may be used. For example, the adjustment object 1700 may be adaptively configured and provided to configure and/or restrict various pieces of information depending on the type and/or context of the information provided by the AI. For example, the adjustment object 1700 may be implemented in various ways depending on the type and/or context of the information provided, such as a first form for adjusting the information disclosure level (e.g., high/medium/low or upper/middle/low), a second form (e.g., a two-level adjustment object) for configuring whether to use user information, a third form for adjusting tone and/or type of speech based on relationship information and/or intimacy, a fourth form for configuring whether to use honorifics, a fifth form for configuring whether to add conditions (or considerations) for recommendation information (e.g., whether to consider schedules) and/or the level of disclosure, and/or a sixth form that allows for more detailed adjustments based on ratios (or percentages) when multiple conditions are complexly combined.

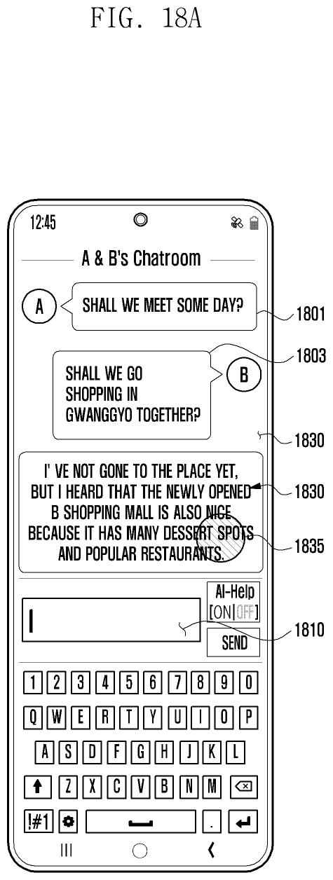

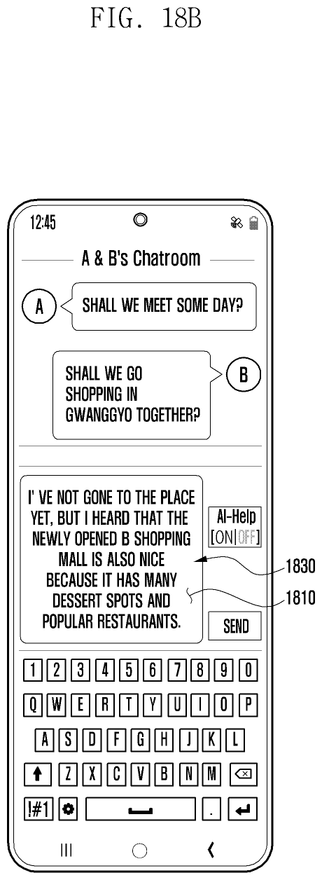

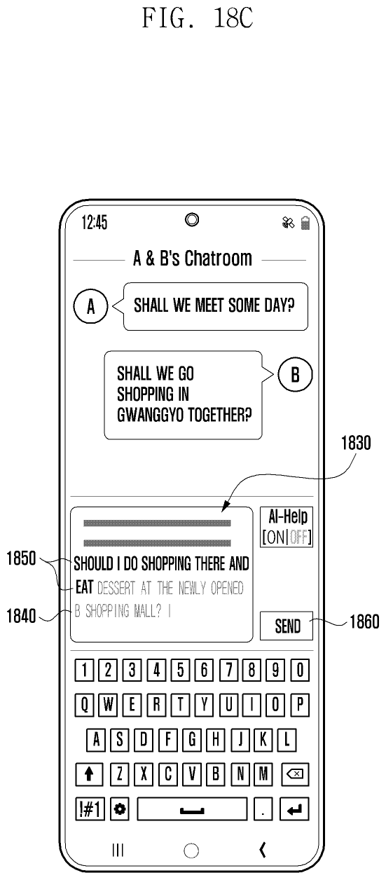

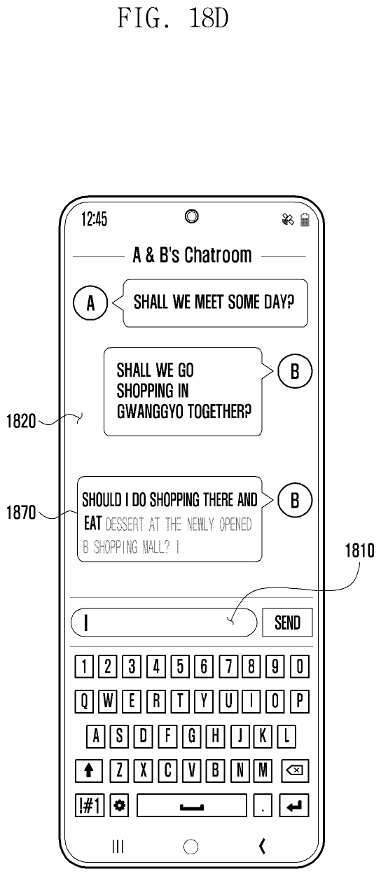

FIGS. 18A, 18B, 18C, and 18D are diagrams illustrating examples of providing recommendation information in an electronic device according to various embodiments of the disclosure.

According to one embodiment, FIGS. 18A, 18B, 18C and 18D may illustrate an example of providing AI-based recommendation information (e.g., recommended answers) through a conversation screen while an interactive service is performed between a user of an electronic device 101 (e.g., user B) and a counterpart user of another electronic device (e.g., user A).

Referring to FIG. 18A, FIG. 18A may illustrate an example of providing an answer (e.g., recommendation information 1830) generated by AI through a conversation field 1820 of an execution screen (e.g., user interface) of an interactive service. According to one embodiment, FIG. 18A may display first content 1801 (e.g., text in a conversation bubble) shared by a counterpart user (e.g., user A) and second content 1803 (e.g., text in a conversation bubble) shared by a user (e.g., user B) through the conversation field 1820. According to one embodiment, the electronic device 101 may generate recommendation information 1830 through AI based on a context according to previous utterances (e.g., content 1801 and 1803) between users of the conversation field 1820. According to one embodiment, the electronic device 101 may provide recommendation information 1830 generated through AI in a pop-up format through a pop-up window on a conversation field 1820. For example, the electronic device 101 may provide a pop-up window containing recommendation information 1830 through a portion of a conversation screen.

According to one embodiment, the electronic device 101 may detect features from the second content 1803 through AI. In one embodiment, the features in FIG. 18A may include features (e.g., meaningful words and/or user-defined words of interest) analyzed based on word or context analysis within the second content 1803. For example, in FIG. 18A, the features may be “Gwanggyo” indicating a location and “shopping” indicating an activity. In one embodiment, if the second content 603 includes words indicating a date and/or time, the features may further include the date and/or time.

According to one embodiment, the electronic device 101 may detect feature words (e.g., ‘Gwanggyo’ and ‘shopping’) based on linguistic context analysis from content (e.g., ‘Shall we go shopping in Gwanggyo together?’) in the conversation field 1820 upon activation of the input field 1810 while performing an interactive service. According to one embodiment, the electronic device 101 may generate (e.g., infer) recommendation information 1830 related to the feature words (e.g., ‘Gwanggyo’ and ‘shopping’) through AI. According to one embodiment, the electronic device 101 may generate recommendation information 1830 having a linguistic context related to the feature words. For example, the electronic device 101 may generate recommendation information 1830 having a linguistic context related to the feature words. For example, the electronic device 101 may generate recommendation information 1830 with linguistic context by constructing preceding and following utterances surrounding feature words (e.g., ‘Gwanggyo’ and ‘shopping’), such as ‘I recently went to Gwanggyo A Shopping Mall, and it was good for shopping because there were many clothing stores. I heard that the newly opened B shopping mall in Gwanggyo is also good because it has a lot of desserts and good restaurants.’

According to one embodiment, the electronic device 101 may provide (e.g., display) recommendation information 1830 generated by AI through a conversation field 1820. According to one embodiment, the user may perform a specified first user input 1835 (e.g., a touch gesture such as tapping the recommendation information 1830) to use the recommendation information 1830 provided through the conversation field 1820. According to one embodiment, the user may edit (or process) the recommendation information 1830 recommended by AI through the user input or share it with a counterpart user participating in an interactive service.

Referring to FIG. 18B, FIG. 18B may illustrate an example of providing a screen in a state of waiting for a user input (e.g., user input related to transmission or editing) for using recommendation information 1830 recommended by AI. According to one embodiment, the electronic device 101 may provide recommendation information 1830 by inputting (e.g., moving) it into an input field 1810 based on a specified first user input for using recommendation information 1830 provided through a conversation field 1820.

According to one embodiment, the electronic device 101 may detect receipt of a specified second user input for editing the recommendation information 1830 based on the input field 1810. According to one embodiment, the user may edit the recommendation information 1830 through a user input (e.g., a specified touch gesture such as a touch) that selects a portion (or text) to be edited (e.g., designates a position of an input cursor) in the recommendation information 1830 provided through the input field 1810. According to one embodiment, the electronic device 101 may determine, based on the specified second user input, that the second user input is a trigger for editing the recommendation information 1830.

Referring to FIG. 18C, FIG. 18C may illustrate an example of providing a screen in which some content of the recommendation information 1830 has been edited by the user. For example, the user may edit the recommendation information 1830 of the example described above, such as “... I heard that the newly opened B shopping mall in Gwanggyo is also good because it has a lot of desserts and good restaurants.” to “. . . Should I do shopping there and eat dessert at the newly opened B shopping mall?” According to one embodiment, when the recommendation information 1830 generated based on AI is edited by a user input, the electronic device 101 may differently provide (e.g., display) the first content (e.g., an answer generated by AI) with help from the AI and the second content (e.g., directly input and edited by the user) in the recommendation information 1830. According to one embodiment, the electronic device 101 may provide the first content and the second content by distinguishing them at least based on the text color, background color, text type, and/or font size of the first content and the second content. For example, as illustrated in FIG. 18C, it may be assumed that the content of element 1840 is first content assisted by AI, and the content of element 1850 is second content edited by a user (e.g., directly input and modified by the user). According to one embodiment, the electronic device 101 may display the first content 1840 in letters of a first specified color (e.g., black), and display the second content 1850 in letters of a second specified color (e.g., green).

According to one embodiment, a user may edit (or process) recommendation information 1830 provided through an input field 1810 through user input, and then share the recommendation information 1830 (e.g., edited recommendation information) with a counterpart user through user input based on a send button 1860. According to one embodiment, the electronic device 101 may transmit the recommendation information 1830 (e.g., edited recommendation information) entered in the input field 1810 to the counterpart user's electronic device based on a user input based on the send button 1860. According to one embodiment, the transmitted (or shared) recommendation information 1830 may be provided (e.g., displayed) through a conversation field 1820.

Referring to FIG. 18D, FIG. 18D may illustrate an example of providing (e.g., displaying) recommendation information 1870 through a conversation field 1820 of an interactive service. According to one embodiment, as illustrated in FIG. 18C, when recommendation information 1830 is edited by a user and transmission of the edited recommendation information 1830 is requested by the user (e.g., by selecting a send button 1860), the electronic device 101 may transmit the recommendation information 1830 to an external device (e.g., an electronic device of the counterpart user) through a specified communication.

According to one embodiment, the electronic device 101 may provide the transmitted recommendation information 1830 as content 1870 inputted by the user through the conversation field 1820. According to one embodiment, the electronic device 101 may, based on transmitting the recommendation information 1830 of the input field 1810, remove (or not display) the recommendation information 1830 of the input field 1810 and display the content 1870 corresponding to the transmitted recommendation information 1830 through the conversation field 1820. According to one embodiment, when the electronic device 101 removes the recommendation information 1830 from the input field 1810 according to the transmission of the recommendation information 1830, the electronic device 101 may change the size of the input field 1810 to a default size and display it, and remove and not display a notification object provided in association with the input field 1810.

According to one embodiment, the electronic device 101 may input content 1870 corresponding to the recommendation information 1830 into the conversation field 1820 based on the transmission of the recommendation information 1830. According to one embodiment, when the recommendation information 1830 generated based on AI is edited and transmitted based on a user input, the electronic device 101 may provide (e.g., display) the content 1870 by distinguishing between first content 1840 (e.g., an answer generated by AI) assisted by AI and second content 1850 edited by the user (e.g., directly input and modified by the user) in the recommendation information 1830. According to one embodiment, the electronic device 101 may provide the first content 1840 and the second content 1850 by distinguishing them at least based on the text color, background color, text type, and/or font size of the first content 1840 and the second content 1850 in the content 1870. For example, as illustrated in FIG. 18D, in the content 1870, the first content 1840 and the second content 1850 may be displayed in text of a first specified color (e.g., black), and the second content 1850 may be displayed in text of a second specified color (e.g., green), as in the edited recommendation information 1830 illustrated in FIG. 18C.

According to one embodiment, the content 1870 transmitted (e.g., shared) from an electronic device 101 may be displayed on the electronic device of the counterpart user as the first content 1840 and the second content 1850 in a differentiated manner, as displayed on the electronic device 101. For example, when the electronic device of the counterpart user receives recommendation information 1830 transmitted by the electronic device 101 and displays content 1870 corresponding to the received recommendation information 1830, the electronic device may provide the content 1870 by distinguishing the font colors of the first content 1840 and the second content 1850, as illustrated in FIG. 18D.

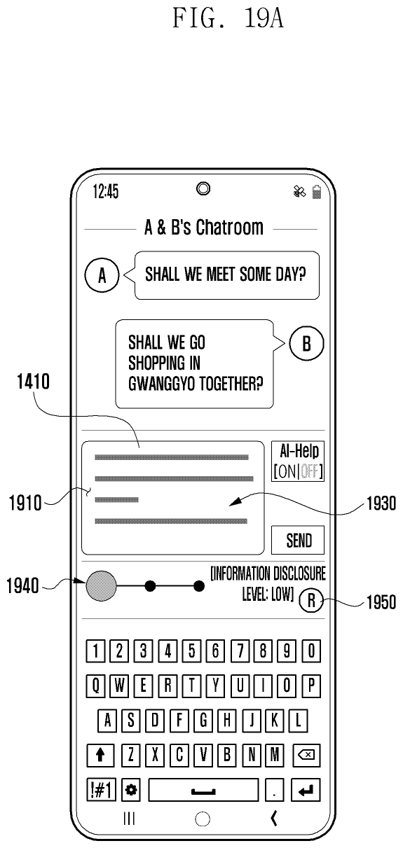

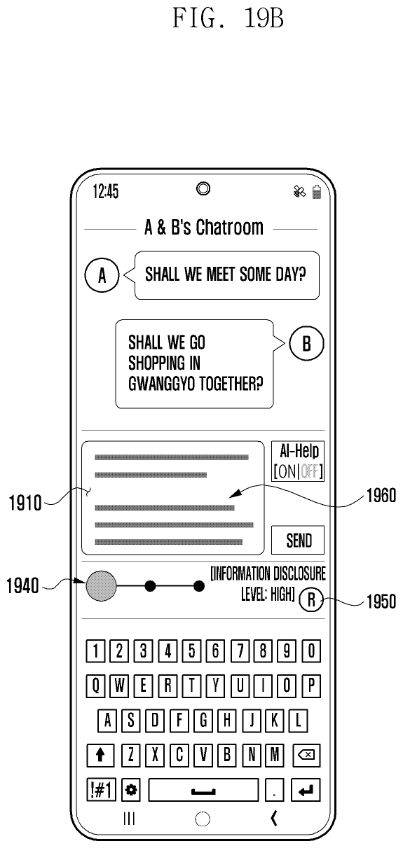

FIGS. 19A and 19B are diagrams illustrating examples of providing recommendation information in an electronic device according to various embodiments of the disclosure.

According to one embodiment, FIGS. 19A and 19B may illustrate an example in which a user refreshes (or changes, processes, or regenerates) first recommendation information (e.g., a recommended answer) recommended (or generated) from AI with different second recommendation information (e.g., a different recommended answer).

Referring to FIG. 19A, the electronic device 101 may provide first recommendation information 1930 generated based on AI based on content (e.g., conversation contents of a user and/or a counterpart user) provided through a conversation field 1920 of the interactive service through an input field 1910 of the interactive service. According to one embodiment, the electronic device 101 may provide a refresh object 1950 (e.g., an “R” button) related to a change request (or refresh request) of the recommendation information, either together with an adjustment object 1940 (or a visual element) related to adjusting an information disclosure level, or independently, by associating it with the input field 1910 (e.g., an adjacent area at the bottom of the input field 1910). According to one embodiment, the refresh object 1950 may be provided independently of the adjustment object 1940 and in association with the recommendation information within the input field 1910 through a specified area (e.g., the right area adjacent to the last letter of the recommendation information content, or the lower right area of the input field 1910).

According to one embodiment, a user may perform a user input (e.g., a touch gesture such as tapping (or touching) the refresh object 1950) on the refresh object 1950 to receive a recommendation for the first recommendation information 1930 provided through the input field 1910 as another second recommendation information 1960. According to one embodiment, based on the selection of the refresh object 1950, the user may receive the first recommendation information 1930 recommended by the AI as another recommendation information (e.g., the second recommendation information 1960).

Referring to FIG. 19B, the electronic device 101 may, based on detecting a user input through a refresh object 1950, process the recommendation content based on the first recommendation information 1930 through AI to generate and provide new recommendation information (e.g., second recommendation information 1960). For example, the electronic device 101 may change the first recommendation information 1930 such as “I recently went to Gwanggyo A Shopping Mall, and it was good for shopping because there were a lot of clothing stores. I heard that the newly opened B Shopping Mall in Gwanggyo is also good because there are a lot of desserts and good restaurants.” to second recommendation information 1960 such as “The shopping mall I recently visited in Gwanggyo is Gwanggyo A Shopping Mall, and it is your favorite shopping mall because you like clothes. The newly opened B Shopping Mall in Gwanggyo is also a shopping mall with a lot of the latest brands, so it is a good place for clothes shopping.” and provide the changed information in the input field 1910. According to one embodiment, the electronic device 101 may regenerate and provide second recommendation information 1960 to the user based on the context of previous utterances between users in the conversation field 1920 and the feature words (e.g., ‘Gwanggyo’ and ‘shopping’) through AI.

According to one embodiment, when a user requests a refresh of recommendation information using a refresh object 1950 (e.g., when the user wants a different answer), the user may request automatic generation by selecting (e.g., tapping) the refresh object 1950, or may request the user to input a desired request (e.g., input a voice command) while pressing the refresh object 1950. According to one embodiment, the electronic device 101 may receive and detect a voice command according to a user utterance while a user input is detected in the refresh object 1950, and may generate and provide second recommendation information 1960 corresponding to the user's request according to the voice command.

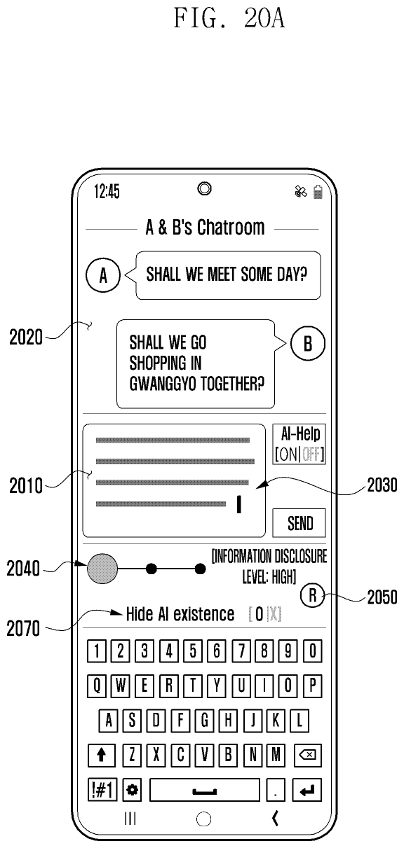

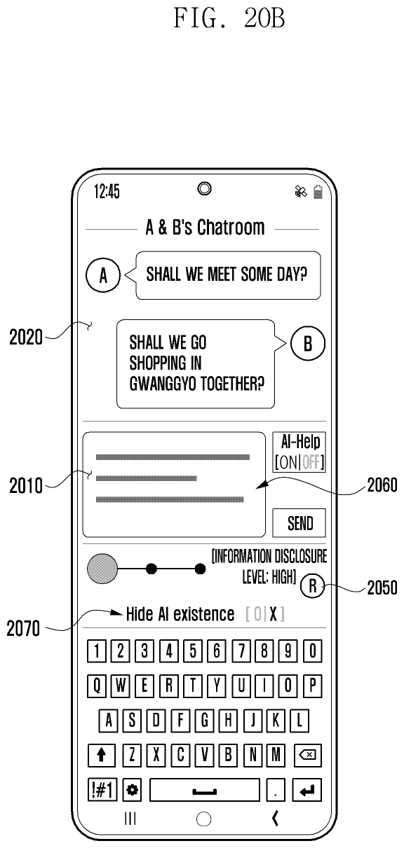

FIGS. 20A and 20B are diagrams illustrating examples of providing recommendation information in an electronic device according to various embodiments of the disclosure.

According to one embodiment, FIGS. 20A and 20B may illustrate an example in which a user refreshes (or changes, processes, or regenerates) first recommendation information (e.g., a recommended answer) recommended (or generated) from AI with different second recommendation information (e.g., a different recommended answer).

Referring to FIG. 20A, the electronic device 101 may provide first recommendation information 2030 generated based on AI based on content (e.g., conversation contents of a user and/or a counterpart user) provided through a conversation field 2020 of the conversation service through an input field 2010 of the conversation service. According to one embodiment, the electronic device 101 may provide an adjustment object 2040 (or a visual element) related to adjusting an information disclosure level, a refresh object 2050 (e.g., an “R” button) related to a request for changing recommendation information (or a refresh request), and/or an existence object 2070 for changing a conversational style by associating it with the input field 2010 (e.g., an adjacent area at the bottom of the input field 2010). According to one embodiment, the existence 2070 may be provided together with the adjustment object 2040 and the refresh object 2050, or may be provided independently without the adjustment object 2040 and the refresh object 2050.

According to one embodiment, the existence object 2070 may represent an object for toggling the function of changing (or processing) the conversational style of an AI-recommended answer (e.g., the first recommendation information 2030) into a conversational style (e.g., conversational style such as similar words, similar phrases, similar tones, and/or similar types that the user uses in conversations with the counterpart user) based on the user context (e.g., conversational patterns between the user and the counterpart user). For example, based on the activation (e.g., “O” object ON/“X” object OFF) or deactivation (e.g., “O” object OFF/“X” object ON) of the existence object 2070, the user may share the first recommendation information 2030, which is an AI-recommended answer, or may hide the assistance provided by the AI and share the second recommendation information 2060, which is an answer changed to resemble something entered directly by the user.

According to one embodiment, a user may perform a user input (e.g., a touch gesture such as tapping (or touching) the existence object 2070) on the “O” object or the “X” object of the existence object 2070 to receive a recommendation for the first recommendation information 2030 provided through the input field 1910 as another second recommendation information 2060. According to one embodiment, based on an activation selection (e.g., selecting the “O” object) of the existence object 2070, the user may receive the first recommendation information 2030 recommended by the AI as second recommendation information 2060 changed into a user context-based conversational style.

Referring to FIG. 20B, the electronic device 101 may process the recommended content based on the first recommendation information 2030 and the user context through AI based on detecting a user input through the existence object 2070, change it into second recommendation information 2060, and provide (e.g., display) the processed content. For example, the electronic device 101 may change the first recommendation information 2030 such as “I recently went to Gwanggyo A Shopping Mall and it was good for shopping because there were a lot of clothing stores. I heard that the newly opened B Shopping Mall in Gwanggyo is also good because there are a lot of desserts and good restaurants.” into second recommendation information 2060 such as “I went to Gwanggyo to play last time and bought a new item at A Shopping Mall. How about doing some shopping at A Shopping Mall and having lunch at B Shopping Mall?” and provide it in the input field 2010. For example, the electronic device 101 may change the first recommendation information 2030 of the honorific conversational style to the second recommendation information 2060 of the user conversational style used between the user and the counterpart user based on the user context. According to one embodiment, the electronic device 101 may regenerate the second recommendation information 2060 and provide it to the user based on the context of the previous utterances between the users in the conversation field 20220 and the feature words (e.g., ‘Gwanggyo’and ‘shopping’) through AI.

According to one embodiment, when a user requests regeneration of recommendation information using an existence object 2070 (e.g., when the user wants a response in the same user conversation style as the user has written), the user may request automatic generation by selecting (e.g., tapping) the existence object 2070, or may request the user to input a desired request (e.g., input a voice command) while pressing the existence object 2070. According to one embodiment, the electronic device 101 may receive and detect a voice command according to a user utterance while a user input is detected in the existence object 2070, and may generate and provide second recommendation information 2060 corresponding to the user request according to the voice command.

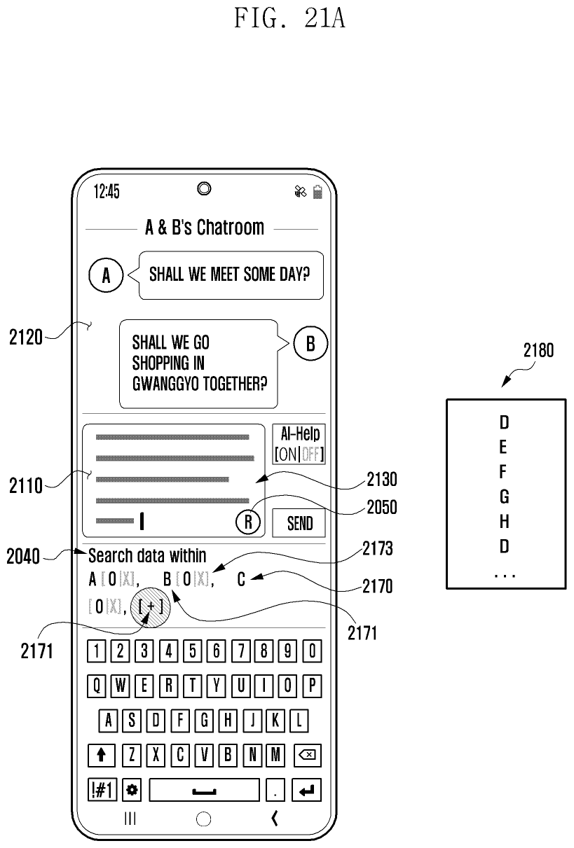

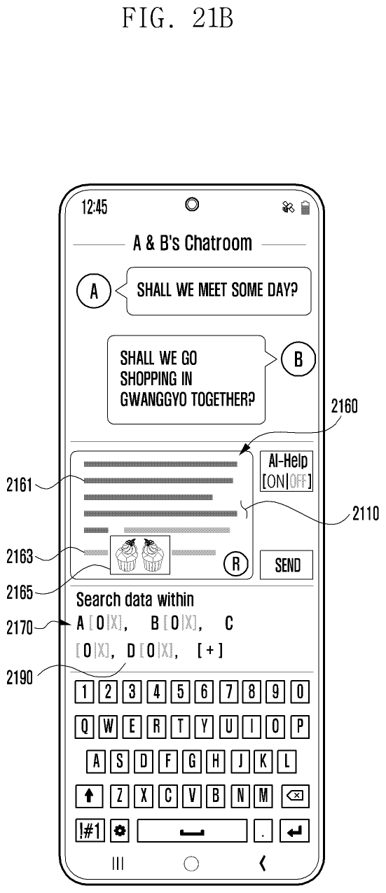

FIGS. 21A and 21B are diagrams illustrating examples of providing recommendation information in an electronic device according to various embodiments of the disclosure.

According to one embodiment, FIGS. 21A and 21B may illustrate an example in which a user adds a search range of data (e.g., source data) for the AI to search (or retrieve) when the user receives recommendation information from the AI. According to one embodiment, when searching for data for recommendation information through the AI, the electronic device 101 may search within a first specified range, perform a search within a second specified range different from the first specified range based on data specified by the user, and generate (or regenerate or process) recommendation information based on the searched data.

Referring to FIG. 21A, the electronic device 101 may provide first recommendation information 2130 generated based on AI based on content (e.g., conversation contents of a user and/or a counterpart user) provided through a conversation field 2120 of the interactive service, through an input field 2110 of the interactive service. According to one embodiment, the electronic device 101 may provide a refresh object 2150 (e.g., an “R” button) related to a request for change (or refresh) of the recommendation information through a specified area within the input field 2110. According to one embodiment, the electronic device 101 may provide a range configuration object 2170 that allows the AI to add or remove data to be searched for the recommendation information, by associating it with the input field 2110 (e.g., an area adjacent to the bottom of the input field 2110). In one embodiment, the range configuration object 2170 may include functionality that allows the AI to adjust the search range for data (e.g., source data) to refer (or access) when generating a recommended answer.

According to one embodiment, the range configuration object 2170 may include at least one indicator 2171 that provides information about related data so that a user may adjust the search range. In one embodiment, the indicator 2171 may be provided at least based on an identifier (e.g., a text, an icon, an image, and/or a symbol) that may represent (or that may be identifiable by a user) an application, a function, and/or a service. For example, the indicator 2171 may be represented by a representative name, a representative icon, a representative image, and/or a representative symbol indicating an application, a function, or a service. In one embodiment, FIGS. 21A and 21B illustrate an example of providing an indicator 2171 using a representative name as an identifier based on text. For example, in FIG. 21A, the indicator 2171 may illustrate an example of providing a text-based identifier that represents the representative names of applications, such as “A,” “B,” and “C”. According to one embodiment, the electronic device 101 may extract data related to feature words from source data related to application “A,” application “B,” and application “C” through AI, and provide first recommendation information 2130.

According to one embodiment, the range configuration object 2170 may include a selection object 2173 for toggling activation or deactivation of the indicator 2171. The selection object 2173 may be provided for each indicator 2171. For example, the user may activate (e.g., “O” object ON/“X” object OFF) data corresponding to the indicator 2171 to be included in the recommendation information, or deactivate (e.g., “O” object OFF/“X” object ON) data corresponding to the indicator 2171 to be excluded from the recommendation information. According to one embodiment, the electronic device 101 may determine a search range of data to be searched by the AI for the first recommendation information 2130 based on the activation/deactivation configuration of the selection object 2173 for each indicator 2171. According to one embodiment, the electronic device 101 may provide first recommendation information 2130 related to a feature word based on data corresponding to a search range through AI.

According to one embodiment, a user may perform a user input (e.g., a touch gesture such as tapping (or touching) a selection object 2173) on an “O” object or an “X” object of a range configuration object 2170. According to one embodiment, the electronic device 101 may generate (or process) an answer by including data (e.g., information generated based on the corresponding data) related to an application (or function or service) corresponding to the indicator in the first recommendation information 2130 recommended by the AI based on an activation selection (e.g., selection of the “O” object) of the selection object 2173. According to one embodiment, the electronic device 101 may generate (or process) an answer by excluding data (e.g., information generated based on the corresponding data) related to an application corresponding to the indicator from the first recommendation information 2130 recommended by the AI based on an inactivation selection (e.g., selection of the “X” object) of the selection object 2173.

According to one embodiment, the range configuration object 2170 may include an add object 2175 (e.g., a “+” button) that allows a user to add a search range. For example, the electronic device 101 may support the user to add an application, a function, or a service for the AI to search for based on the add object 2175. In one embodiment, the user may add a target application, function, or service for the AI to search for recommendation information through a user input (e.g., a touch gesture such as a touch or tap) based on the add object 2175.

According to one embodiment, when the electronic device 101 detects (or receives) a user input through the add object 2175, the AI may provide a list 2180 related to additionally searchable applications, functions, and/or services. According to one embodiment, the list 2180 may be provided as a pop-up window on a conversation screen. For example, the electronic device 101 may provide the list 2180 in a pop-up format on a conversation field 2120. According to one embodiment, the list 2180 may be provided at least based on an identifier (i.e., indicator) (e.g., a text, an icon, an image, and/or a symbol) that may represent (or that may be identifiable by a user) an application, a function, and/or a service. For example, in FIG. 21A, the list 2180 may represent an example of providing identifiers based on text that represents representative names of applications, such as “D”, “E”, “F”, “G”, and “H”. According to one embodiment, the list 2180 may include a list (e.g., a list of apps) of applications, functions, and/or services from which the AI may acquire (or collect) data for recommendation information.

According to one embodiment, a user may select at least one identifier corresponding to an application, a function, or a service to be further searched by AI from the list 2180 and add it as a new indicator to the range configuration object 2170. For example, the user may adjust (e.g., change) a search range to be searched by AI by adding it as an indicator to the range configuration object 2170. According to one embodiment, when an object (e.g., a “D” object) to be added from the list 2180 to the range configuration object 2170 is selected (e.g., an add command for the selected object is completed), the electronic device 101 may add and display a new indicator related to the selected object (e.g., the “D” object) based on the area of the range configuration object 2170. An example of this is illustrated in FIG. 21B.

Referring to FIG. 21B, the electronic device 101 may determine an application, a function, and/or a service corresponding to an object (e.g., a “D” object) selected by the user input based on detecting the user input through the list 2180. According to one embodiment, based on the result of the determination, the electronic device 101 may add and provide a corresponding indicator 2190 as a range configuration object 2170.

According to one embodiment, the electronic device 101 may generate (or process) an answer by including data (e.g., information generated based on the data) related to an application (or a function or a service) corresponding to the indicator 2190 in the first recommendation information 2130 recommended by AI based on the addition of the indicator 2190. For example, the electronic device 101 may collect data related to feature words and user content from an application (or a function or a service) corresponding to the indicator 2190 through the AI. According to one embodiment, the electronic device 101 may process the recommendation content of the first recommendation information 2130 based on the related data through the AI and provide (e.g., display) the second recommendation information 2160 by changing it.

According to one embodiment, when the indicator 2190 relates to a “gallery,” the electronic device 101 may search for data related to a feature word (e.g., visual images such as icons, photos, videos, and/or animated objects) from the gallery, and provide second recommendation information 2160 including at least one searched data (e.g., visual images 2165) and related recommendation content 2163. For example, the electronic device 101 may change the first recommendation content 2161 of the first recommendation information 2130 to second recommendation information 2160 that further includes second recommendation content 2163 based on at least one data, and provide the second recommendation information 2160 to the input field 2110. In one embodiment, according to the example of FIG. 21B, the second recommendation content 2163 may further include a visual element 2165.

According to one embodiment, the electronic device 101 may support the user to directly adjust the range of target data to be searched by the AI using the range configuration object 2170. For example, the user may adjust the range of target data for recommendation information by adding or excluding desired applications, functions, and/or services using the range configuration object 2170. According to one embodiment, the electronic device 101 may generate (e.g., change) and provide second recommendation information 2160 corresponding to the user's request from the first recommendation information 2130 based on an indicator specified by the user in the range configuration object 2170.

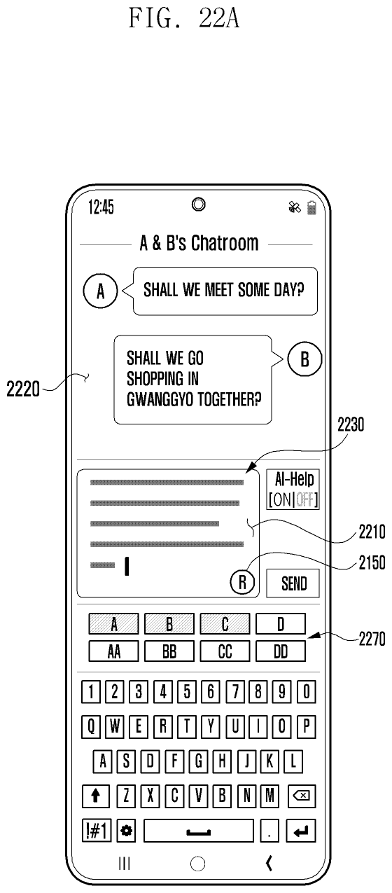

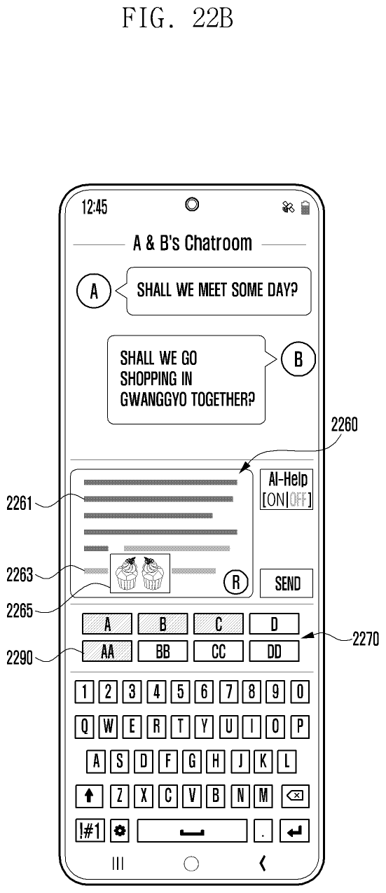

FIGS. 22A and 22B are diagrams illustrating examples of providing recommendation information in an electronic device according to various embodiments of the disclosure.

According to one embodiment, FIGS. 22A and 22B may illustrate an example in which a user adds a search range of data (e.g., source data) for the AI to search (or retrieve) when the user receives recommendation information from the AI. According to one embodiment, when searching for data for recommendation information through the AI, the electronic device 101 may search within a first specified range, perform a search within a second specified range different from the first specified range based on data specified by the user, and generate (or regenerate or process) recommendation information based on the searched data.

Referring to FIG. 22A, the electronic device 101 may provide first recommendation information 2230 generated based on AI based on content (e.g., conversation contents of a user and/or a counterpart user) provided through a conversation field 2220 of the interactive service, through an input field 2210 of the interactive service. According to one embodiment, the electronic device 101 may provide a refresh object 2150 (e.g., an “R” button) related to a request for change (or refresh) of the recommendation information, through a specified area within the input field 2210. According to one embodiment, the electronic device 101 may provide a range configuration object 2270 that allows the AI to add or remove data to be searched for the recommendation information, by associating it with the input field 2210 (e.g., an area adjacent to the bottom of the input field 2210). According to one embodiment, the range configuration object 2270 may include functionality that allows the AI to adjust the search range for data (e.g., source data) to refer (or access) when generating a recommended answer.

According to one embodiment, the range configuration object 2270 may include at least one indicator that provides information about related data so that a user may adjust the search range. In one embodiment, the indicator may be provided at least based on an identifier (e.g., a text, an icon, an image, and/or a symbol) that may represent (or that may be identifiable by a user) an application, a function, and/or a service. For example, the indicator may be represented by a representative name, a representative icon, a representative image, and/or a representative symbol that indicates an application, a function, or a service. In one embodiment, FIGS. 22A and 22B illustrate an example of providing an indicator in the form of a bubble using a representative name as an identifier based on text. For example, in FIG. 22A, the indicator 2171 may be provided based on a bubble that includes text representing the representative names of applications, such as “A”, “B”, “C”, “D”, “AA”, “BB”, “CC”, and “DD”. According to one embodiment, the electronic device 101 may extract data related to a feature word from source data related to an application (e.g., application “A,” application “B,” and application “C”) related to an activated indicator through AI, and provide first recommendation information 2230.

According to one embodiment, each indicator of the range configuration object 2270 may be toggled to be activated or deactivated based on a user input (e.g., a touch gesture such as a touch (or tap)). For example, the user may activate (e.g., turn indicator ON) data corresponding to the indicator of the range configuration object 2270 to include data corresponding to the indicator in the recommendation information, or deactivate (e.g., turn indicator OFF) data corresponding to the indicator to exclude data corresponding to the indicator from the recommendation information. According to one embodiment, the electronic device 101 may determine a search range of data to be searched by the AI for the first recommendation information 2230 based on the activation/deactivation configuration for each indicator 2171. According to one embodiment, the electronic device 101 may provide first recommendation information 2230 related to a feature word based on data corresponding to the search range through the AI.

According to one embodiment, a user may perform a user input (e.g., a touch gesture such as tapping (or touching) an indicator) on each indicator of a range configuration object 2270. According to one embodiment, the electronic device 101 may generate (or process) an answer by including data (e.g., information generated based on the data) related to an application (or a function or a service) corresponding to the indicator in the first recommendation information 2230 recommended by AI based on an activation selection of the indicator. According to one embodiment, the electronic device 101 may generate (or process) an answer by excluding data (e.g., information generated based on the data) related to an application corresponding to the indicator from the first recommendation information 2230 recommended by AI based on an inactivation selection of the indicator.

According to one embodiment, a user may add or exclude target applications, features, or services for the AI to explore for recommendation information through user input (e.g., a touch gesture such as a touch or tap) to activate an indicator.

According to one embodiment, the electronic device 101 may adjust (e.g., change) the search range to be searched by the AI when a user input activating the corresponding indicator is detected (or received) through the indicator. According to one embodiment, the electronic device 101 may select any one of the indicators (e.g., the “AA” object) that is deactivated in the range configuration object 2270, activate the selected indicator (e.g., the “AA” object) in the range configuration object 2270, and provide recommendation information including related data. An example of this is illustrated in FIG. 22B.

Referring to FIG. 22B, the electronic device 101 may determine an application, a function, and/or a service corresponding to an object (e.g., an “AA” object) selected by the user input based on detecting a user input through an indicator 2290 of a range configuration object 2270 (e.g., an “AA” object). According to one embodiment, the electronic device 101 may activate and provide a corresponding indicator 2290 in the range configuration object 2270 based on the determination result.

According to one embodiment, the electronic device 101 may generate (or process) an answer by including data (e.g., information generated based on the data) related to an application (or a function or a service) corresponding to the indicator 2290 in the first recommendation information 2230 recommended by AI based on the additional activation of the indicator 2290. For example, the electronic device 101 may collect data related to feature words and user content from an application (or function or service) corresponding to the indicator 2290 through AI. According to one embodiment, the electronic device 101 may process the recommendation content of the first recommendation information 2230 based on the related data through AI and provide (e.g., display) the second recommendation information 2260 by changing it.

According to one embodiment, when the indicator 2290 relates to a “gallery,” the electronic device 101 may search for data related to a feature word (e.g., visual images such as icons, photos, videos, and/or animated objects) from the gallery, and provide second recommendation information 2260 including at least one searched data (e.g., visual images 2265) and related recommendation content 2263. For example, the electronic device 101 may change the first recommendation content 2261 of the first recommendation information 2230 to second recommendation information 2260 that further includes second recommendation content 2263 based on at least one data, and provide the second recommendation information 2260 to the input field 2110. In one embodiment, according to the example of FIG. 22B, the second recommendation content 2263 may further include a visual element 2265.

According to one embodiment, the electronic device 101 may support the user to directly adjust the range of target data to be searched by the AI using the range configuration object 2270. For example, the user may adjust the range of target data for recommendation information by adding or excluding desired applications, functions, and/or services using the range configuration object 2270. According to one embodiment, the electronic device 101 may generate (e.g., change) and provide second recommendation information 2260 corresponding to the user's request from the first recommendation information 2230 based on an indicator specified by the user in the range configuration object 2270.

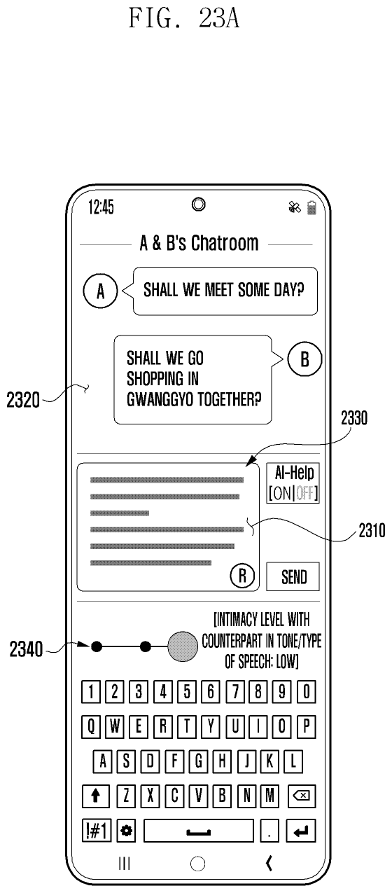

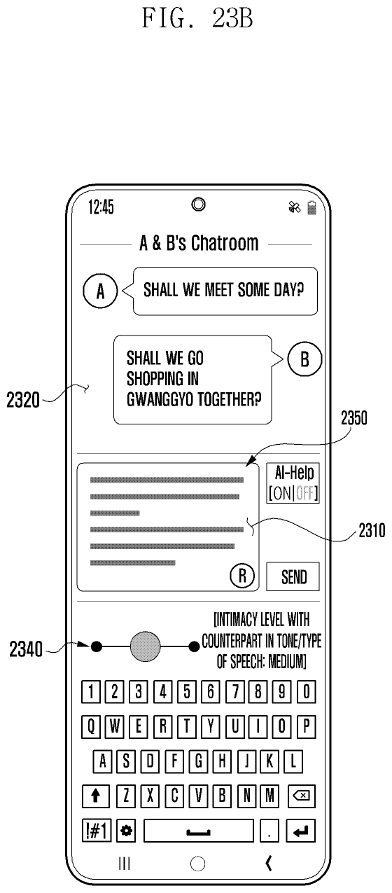

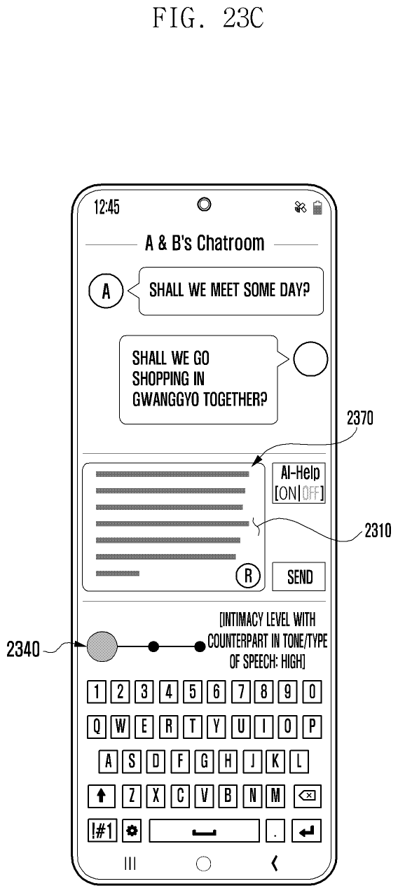

FIGS. 23A, 23B, and 23C are diagrams illustrating examples of providing recommendation information in an electronic device according to various embodiments of the disclosure.

According to one embodiment, FIGS. 21A, 23Bb, and 23C illustrate examples of assisting a user in processing recommendation information (e.g., recommended answers) recommended (or generated) by AI. For example, FIGS. 21A, 23B, and 23C illustrate examples of adjusting the tone of speech with a counterpart user when composing a conversation with assistance from AI.

Referring to FIG. 23A, the electronic device 101 may provide first recommendation information 2330 generated based on AI based on content (e.g., conversation contents of a user and/or a counterpart user) provided through a conversation field 2320 of the interactive service, through an input field 2310 of the interactive service. According to one embodiment, the electronic device 101 may provide an adjustment object 2340 (or a visual element) related to the adjustment of tone (and/or type) of speech by associating it with the input field 2310 (e.g., an area adjacent to the bottom of the input field 2310). In one embodiment, as illustrated in FIGS. 23A, 23B, and 23C, the adjustment object 2340 may represent an example in which an object is provided in a form in which tone and/or type of speech may be adjusted in three levels based on relationship information and/or intimacy.

According to one embodiment, the user may perform a user input (e.g., an input for level adjustment, such as a touch gesture like swiping by touching the adjustment object 2340) on the adjustment object 2340 in order to stepwise receive recommendations from the first tone/type of speech (e.g., intimacy level in tone/type of speech: low) corresponding to the first recommendation information 2330 provided through the input field 2310 to the second tone/type of speech (e.g., intimacy level in tone/type of speech: medium) or the third tone/type of speech (e.g., intimacy level in tone/type of speech: high). According to one embodiment, the user may receive recommendation information (e.g., the second recommendation information 2350 or the third recommendation information 2370) having a different tone/type of speech by adjusting the tone/type of speech of the recommendation information (e.g., the first recommendation information 2330) recommended by the AI through stepwise adjustment using the adjustment object 2340. According to one embodiment, the first recommendation information 2330, the second recommendation information 2350, and the third recommendation information 2370 may generally contain the same content (or meaning or interpretation), and may have different tones/types of speech depending on the adjustment level (e.g., low, medium, or high) of the adjustment object 2340.

Referring to FIG. 23B, the electronic device 101 may, based on detecting a user input through an adjustment object 2340, process the recommendation content based on the first recommendation information 2330 and the user context through AI and provide (e.g., display) the second recommendation information 2350. For example, the electronic device 101 may change the first recommendation information 2330 based on the first tone/type of speech according to the first level (e.g., intimacy level in tone/type of speech: low) of the adjustment object 2340, such as “The shopping mall I recently visited in Gwanggyo is A Shopping Mall, and it has many clothing stores, so it's a good place to shop for clothes. And the newly opened and recently popular shopping mall is B Shopping Mall, and it has many desserts and foods, so it's a good place to eat delicious food.” into the second recommendation information 2350 based on the second tone/speech according to the second level (e.g., intimacy level in tone/type of speech: medium) of the adjustment object 2340, such as “I recently went to A Shopping Mall in Gwanggyo, and it's a good place to shop for clothes, so it's a good place to shop for clothes! And the newly opened and recently popular shopping mall is B Shopping Mall, and it has many desserts and foods, so it would be nice to eat delicious food with you!”, and provide the information to the input field 2310. For example, the electronic device 101 may change the first recommendation information 2330 of the honorific conversational style based on the user context into the second recommendation information 2350 in a more intimate expression depending on the user conversational style (e.g., tone/type of speech) used between the user and the counterpart user. According to one embodiment, the electronic device 101 may regenerate the second recommendation information 2350 through AI based on the context according to the feature words (e.g., ‘Gwanggyo’ and ‘shopping’) and previous utterances between the users in the conversation field 2320 and provide it to the user.

Referring to FIG. 23C, the electronic device 101 may, based on detecting a user input through an adjustment object 2340, process the recommendation content based on the second recommendation information 2350 and the user context through AI and provide (e.g., display) the third recommendation information 2370. For example, the electronic device 101 may change the second recommendation information 2350 based on the second tone/type of speech according to the second level (e.g., intimacy level in tone/type of speech: medium) of the adjustment object 2340, such as “I recently went to A Shopping Mall in Gwanggyo. It has a lot of clothing stores, so it's a good place to shop for clothes! Also, a newly opened and recently popular shopping mall is B Shopping Mall. It has a lot of desserts and food, so it would be nice to eat something delicious with you!” into the third recommendation information 2370 based on the third tone/speech according to the third level (e.g., intimacy level in tone/type of speech:
high) of the adjustment object 2340, such as “I went to A Shopping Mall in Gwanggyo last week. It had a lot of hip clothing stores. I want to go shopping for clothes with you! Also, I heard that a newly opened and recently popular B Shopping Mall is famous for its dessert stores. I want to eat something delicious with you there!”, and provide the information to the input field 2310. For example, the electronic device 101 may change the second recommendation information 2350 of the medium-intimacy conversational style based on the user context into the third recommendation information 2370 of a more intimate expression based on the user conversational style (e.g., tone/type of speech) used between the user and the counterpart user. According to one embodiment, the electronic device 101 may regenerate the third recommendation information 2370 and provide it to the user based on the context according to the feature words (e.g., ‘Gwanggyo’ and ‘shopping’) and previous utterances between the users in the conversation field 2320 through AI.

An operation method performed in an electronic device 101 according to one embodiment of the disclosure may include an operation of displaying an execution screen of an interactive service. According to one embodiment, the operation method may include an operation of detecting a feature point from content inputted while performing the interactive service. According to one embodiment, the operation method may include an operation of determining relationship information with at least one counterpart user participating in the interactive service. According to one embodiment, the operation method may include an operation of determining an access level for user information based on the relationship information. According to one embodiment, the operation method may include an operation of acquiring at least a part of the user information and/or general information based on the access level. According to one embodiment, the operation method may include an operation of generating recommendation information related to the feature point based on the acquired information. According to one embodiment, the operation method may include an operation of providing the recommendation information.

According to one embodiment, the method may include an operation of displaying the content in a conversation field while performing the interactive service. According to one embodiment, the method may include an operation of detecting a feature point from the content displayed in the conversation field. According to one embodiment, the method may include an operation of executing an artificial intelligence-based answer function based on the detection of the feature point. According to one embodiment, the method may include an operation of generating the recommendation information at least based on the user information and the general information in the artificial intelligence-based answer function.

According to one embodiment, the executing operation may include an operation of providing a notification object related to the artificial intelligence-based answer function in association with an input field of the interactive service based on executing the artificial intelligence-based answer function.

According to one embodiment, the notification object may indicate a status of whether the artificial intelligence-based answer function is in operation and include an object that supports a toggle for activating or deactivating the artificial intelligence-based answer function.

According to one embodiment, the method may include providing the recommendation information to an input field of the interactive service. According to one embodiment, the method may include editing or transmitting the recommendation information based on a user input while the recommendation information is provided through the input field.

According to one embodiment, the interactive service may be provided including an adjustment object for information adjustment.

According to one embodiment, the operating method may include an operation of changing and providing the recommendation information according to a step corresponding to the adjustment object based on a user input using the adjustment object.

According to one embodiment, the method of operation may include a service that supports communication between users through an application for conversation between two or more remote parties (e.g., a messaging service, a chat service, an SNS, an e-mail service).

According to one embodiment, the content may include text or images provided through a conversation field of the interactive service.

According to one embodiment, the feature points may include meaningful words and/or meaningful image objects that may be extracted from the content.

A non-transitory computer-readable recording medium storing instructions, which, when executed by a processor 120 of an electronic device 101 according to one embodiment of the disclosure, cause the processor 120 to perform operations, may include instructions, which, when executed by the processor, cause the electronic device to perform an operation of displaying an execution screen of an interactive service, an operation of detecting a feature point from content inputted while performing the interactive service, an operation of determining relationship information with at least one counterpart user participating in the interactive service, an operation of determining an access level for user information based on the relationship information, an operation of acquiring at least a part of the user information and/or general information based on the access level, an operation of generating recommendation information related to the feature point based on the acquired information, and an operation of providing the recommendation information.

It will be appreciated that the above-described embodiments and their technical features may be combined with each other in any and all combinations, as long as there is no potential conflict between the two embodiments or features. For example, any and all combinations of two or more of the above-described embodiments may be envisioned and incorporated within the disclosure. One or more features from any embodiment may be incorporated into any other embodiment, providing a corresponding advantage or advantages.

Electronic devices according to the various embodiments disclosed in this document may take various forms. Electronic devices may include, for example, portable communication devices (e.g., smartphones), computer devices, portable multimedia devices, portable medical devices, cameras, wearable devices, or home appliances. Electronic devices according to the embodiments of this document are not limited to the aforementioned devices.

The various embodiments of this document and the terminology used therein are not intended to limit the technical features described in this document to specific embodiments, but should be understood to include various modifications, equivalents, or substitutes of the embodiments. In connection with the description of the drawings, similar reference numerals may be used for similar or related components. The singular form of a noun corresponding to an item may include one or more of the items, unless the context clearly indicates otherwise. In this document, each of the phrases “A or B”, “at least one of A and B”, “at least one of A or B”, “A, B, or C”, “at least one of A, B, and C”, and “at least one of A, B, or C” may include any one of the items listed together in the corresponding phrase among those phrases, or all possible combinations thereof. Terms such as “the first,” “the second,” or “first” or “second” may be used merely to distinguish one component from another, and do not limit the components in any other respect (e.g., importance or order). When a component (e.g., a first component) is referred to as “coupled” or “connected” to another component (e.g., a second component), with or without the terms “functionally” or “communicatively,” it means that the component may be connected to the other component directly (e.g., wired), wirelessly, or through a third component.

The term “module” used in various embodiments of this document may include a unit implemented in hardware, software, or firmware, and may be used interchangeably with terms such as logic, logic block, component, or circuit. A module may be an integral component, or a minimum unit or part of such a component that performs one or more functions. For example, according to one embodiment, a module may be implemented in the form of an application-specific integrated circuit (ASIC).

Various embodiments of the present document may be implemented as software (e.g., a program 140) including one or more instructions stored in a storage medium (e.g., an internal memory 136 or an external memory 138) readable by a machine (e.g., an electronic device 101). For example, a processor (e.g., a processor 120) of the machine (e.g., an electronic device 101) may call at least one instruction among the one or more instructions stored from the storage medium and execute it. This enables the machine to operate to perform at least one function according to the at least one called instruction. The one or more instructions may include code generated by a compiler or code executable by an interpreter. The machine-readable storage medium may be provided in the form of a non-transitory storage medium. Here, ‘non-transitory’ simply means that the storage medium is a tangible device and does not contain signals (e.g., electromagnetic waves), and the term does not distinguish between cases where data is stored semi-permanently or temporarily on the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
at least one processor comprising processing circuitry and operatively connected to the display and the memory,
wherein the instructions, when executed by the at least one processor individually or collectively, cause the electronic device to:
display an execution screen of an interactive service,
detect a feature point from content inputted while performing the interactive service,
determine relationship information with at least one counterpart user participating in the interactive service,
determine an access level for user information based on the relationship information,
acquire at least a part of user information and/or general information based on the access level,
generate recommendation information related to the feature point based on the acquired information, and
provide the recommendation information.

2. The electronic device of claim 1,
wherein the content includes a text or an image provided through a conversation field of the interactive service, and
wherein the feature point includes a meaningful word and/or a meaningful image object extractable from the content.

3. The electronic device of claim 2, wherein the instructions, when executed by the at least one processor, further cause the electronic device to:
display the content in the conversation field while performing the interactive service;
detect the feature point from the content displayed in the conversation field;
execute an artificial intelligence (AI)-based answer function based on detecting the feature point; and
generate the recommendation information at least based on the user information and the general information in the AI-based answer function.

4. The electronic device of claim 3,
wherein the instructions, when executed by the at least one processor, further cause the electronic device to provide a notification object related to the AI-based answer function in association with an input field of the interactive service based on executing the AI-based answer function, and
wherein the notification object includes an object that indicates a status of whether the AI-based answer function is operating and supports a toggle for activating or deactivating the AI-based answer function.

5. The electronic device of claim 1, wherein the instructions, when executed by the at least one processor, further cause the electronic device to:
provide the recommendation information to an input field of the interactive service; and
edit or transmit the recommendation information based on user input while the recommendation information is provided through the input field.

6. The electronic device of claim 5, wherein the instructions, when executed by the at least one processor, further cause the electronic device to:
edit the recommendation information at least based on a direct input by the user, a change in an amount of information based on adjustment of an information disclosure level based on an adjustment object, or selection of sub-information from a list of sub-information capable of replacing the main information.

7. The electronic device of claim 5, wherein the instructions, when executed by the at least one processor, further cause the electronic device to:
transmit the recommendation information to the electronic device of the counterpart user based on the user input while the recommendation information is provided through the input field; and
provide the recommendation information through a conversation field of the interactive service.

8. The electronic device of claim 1,
wherein the interactive service is provided including an adjustment object for information adjustment, and
wherein the instructions, when executed by the at least one processor, cause the electronic device to:
provide the recommendation information by changing the recommendation information according to a step corresponding to the adjustment object, based on a user input using the adjustment object.

9. The electronic device of claim 1, wherein the instructions, when executed by the at least one processor, further cause the electronic device to:
distinguishably provide a part of the recommendation information that is edited by the user and a part of the recommendation information that is automatically generated by artificial intelligence.

10. The electronic device of claim 1, wherein the instructions, when executed by the at least one processor, further cause the electronic device to:
provide a list related to at least one sub-information capable of replacing the main information related to the feature point, while the recommendation information is provided through an input field;
detect a user input for selecting sub-information from the list; and
replace the main information with the selected sub-information and provide the replaced information based on the user input.

11. The electronic device of claim 10, wherein the instructions, when executed by the at least one processor, further cause the electronic device to provide the list between the input field and a keyboard area, or provide the list in place of the keyboard area.

12. A method for operating an electronic device, the method comprising:
displaying an execution screen of an interactive service;
detecting a feature point from content inputted while performing the interactive service;
determining relationship information with at least one counterpart user participating in the interactive service;
determining an access level for user information based on the relationship information;
acquiring at least a part of user information and/or general information based on the access level;
generating recommendation information related to the feature point based on the acquired information; and
providing the recommendation information.

13. The method of claim 12, further comprising:
displaying the content in a conversation field while performing the interactive service;
detecting the feature point from the content displayed in the conversation field;
executing an artificial intelligence (AI)-based answer function based on detecting the feature point; and
generating the recommendation information at least based on the user information and the general information in the AI-based answer function.

14. The method of claim 13,
wherein the executing comprises providing, based on executing the artificial intelligence-based answer function, a notification object related to the artificial intelligence-based answer function in association with an input field of the interactive service, and
wherein the notification object indicates a status of whether the AI-based answer function is in operation and includes an object that supports a toggle for activating or deactivating the AI-based answer function.

15. The method of claim 12, further comprising:
providing the recommendation information to the input field of the interactive service; and
editing or transmitting the recommendation information based on user input while the recommendation information is provided through the input field.

16. The method of claim 15, further comprising:
editing the recommendation information at least based on a direct input by the user, a change in an amount of information based on adjustment of an information disclosure level based on an adjustment object, or selection of sub-information from a list of sub-information capable of replacing the main information.

17. The method of claim 15, further comprising:
transmitting the recommendation information to the electronic device of the counterpart user based on the user input while the recommendation information is provided through the input field; and
providing the recommendation information through a conversation field of the interactive service.

18. The method of claim 12,
wherein the interactive service is provided including an adjustment object for information adjustment, and
wherein the method further includes providing the recommendation information by changing the recommendation information according to a step corresponding to the adjustment object, based on a user input using the adjustment object.

19. The method of claim 12, further comprising:
providing a list related to at least one sub-information capable of replacing the main information related to the feature point, while the recommendation information is provided through an input field;
detecting a user input for selecting sub-information from the list; and
replacing the main information with the selected sub-information and providing the replaced information based on the user input.

20. One or more non-transitory computer-readable storage media storing one or more computer programs including computer-executable instructions that, when executed by at least one processor of an electronic device, individually or collectively, cause the electronic device to perform operations, the operations comprising:
displaying an execution screen of an interactive service;
detecting a feature point from content inputted while performing the interactive service;
determining relationship information with at least one counterpart user participating in the interactive service;
determining an access level for user information based on the relationship information;
acquiring at least a part of user information and/or general information based on the access level;
generating recommendation information related to the feature point based on the acquired information; and
providing the recommendation information.
